(19) United States
(12) Patent Application Publication
(10) Pub. No.: US 2024/0163905 A1
(43) Pub. Date: May 16, 2024

(54) Channel Access Priority Class for Sidelink Feedback Transmission with Conflict Information

(71) Applicant: Ofinno, LLC, Reston, VA (US)

(72) Inventors: Nazanin Rastegardoost, McLean, VA (US); Hyoungsuk Jeon, Centreville, VA (US); Esmael Hejazi Dinan, McLean, VA (US); Bing Hui, Nanjing (CN)

(73) Assignee: Ofinno, LLC, Reston, VA (US)

(21) Appl. No.: 18/510,159

(22) Filed: Nov. 15, 2023

Related U.S. Application Data
(60) Provisional application No. 63/425,754, filed on Nov. 16, 2022.

(51) Int. Cl. H04W 72/25; H04W 72/542; H04W 72/563

(52) U.S. Cl. CPC H04W 72/25; H04W 72/542; H04W 72/563

(57) ABSTRACT

A first wireless device determines a resource conflict based on a first sidelink control information (SCI) and a second SCI. The first wireless device determines a channel access priority class (CAPC) value, for a transmission of a conflict information indicating the resource conflict, based on one of the first SCI and the second SCI. The first wireless device transmits the conflict information, via a feedback channel, using the CAPC value.

### BRIEF DESCRIPTION OF THE DRAWINGS

This application claims the benefit of U.S. Provisional Application No. 63/425,754, filed Nov. 16, 2022, which is hereby incorporated by reference in its entirety.

### BRIEF DESCRIPTION OF THE DRAWINGS

Examples of several of the various embodiments of the present disclosure are described herein with reference to the drawings.

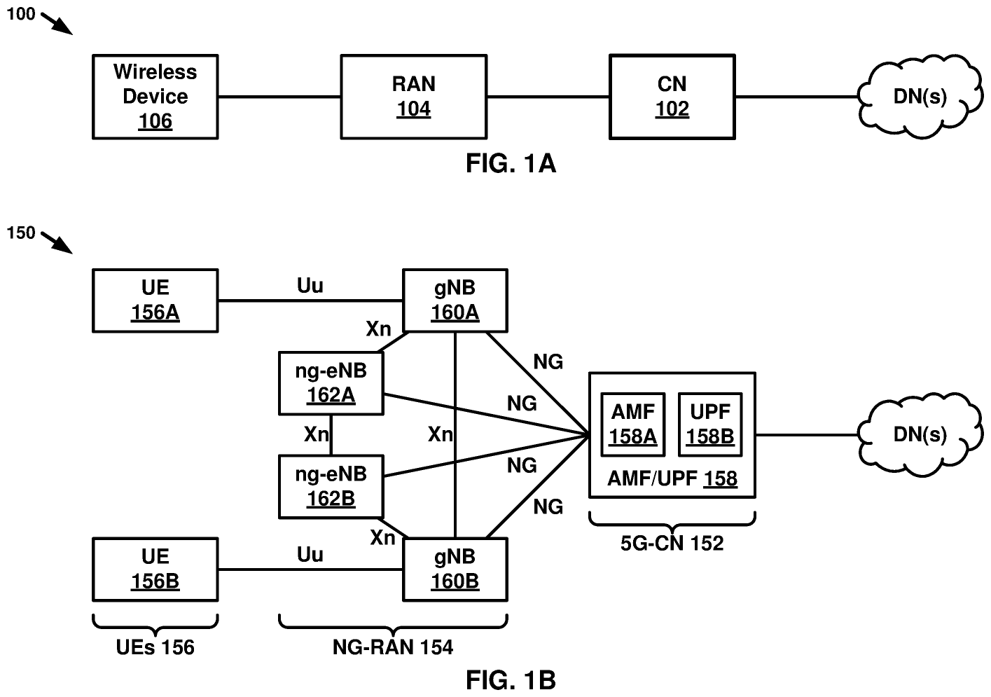

FIG. 1A and FIG. 1B illustrate example mobile communication networks in which embodiments of the present disclosure may be implemented.

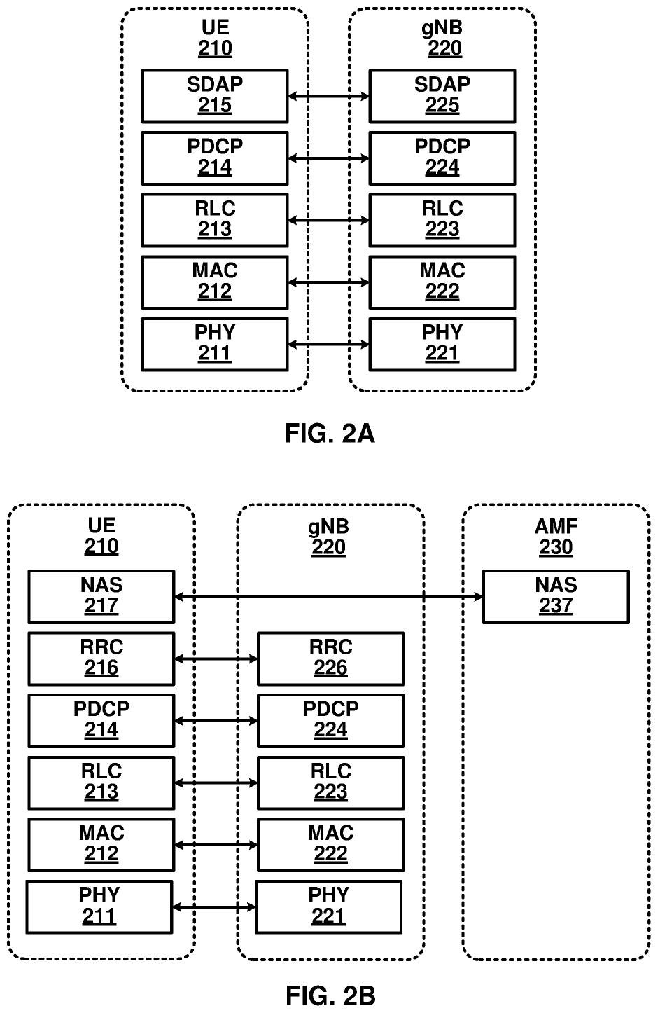

FIG. 2A and FIG. 2B respectively illustrate a New Radio (NR) user plane and control plane protocol stack.

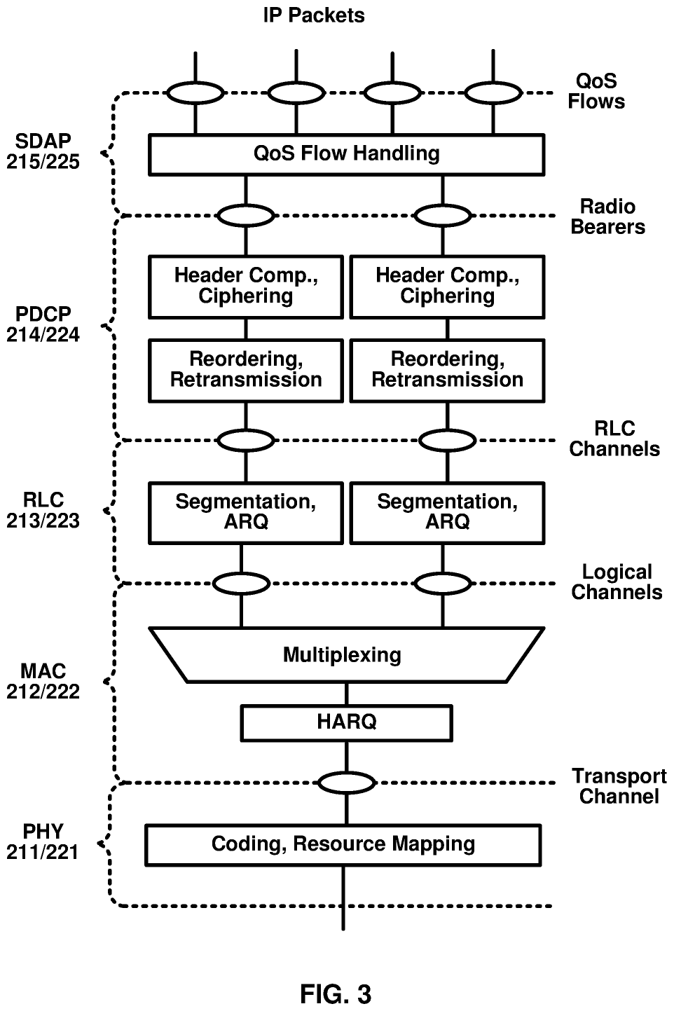

FIG. 3 illustrates an example of services provided between protocol layers of the NR user plane protocol stack of FIG. 2A.

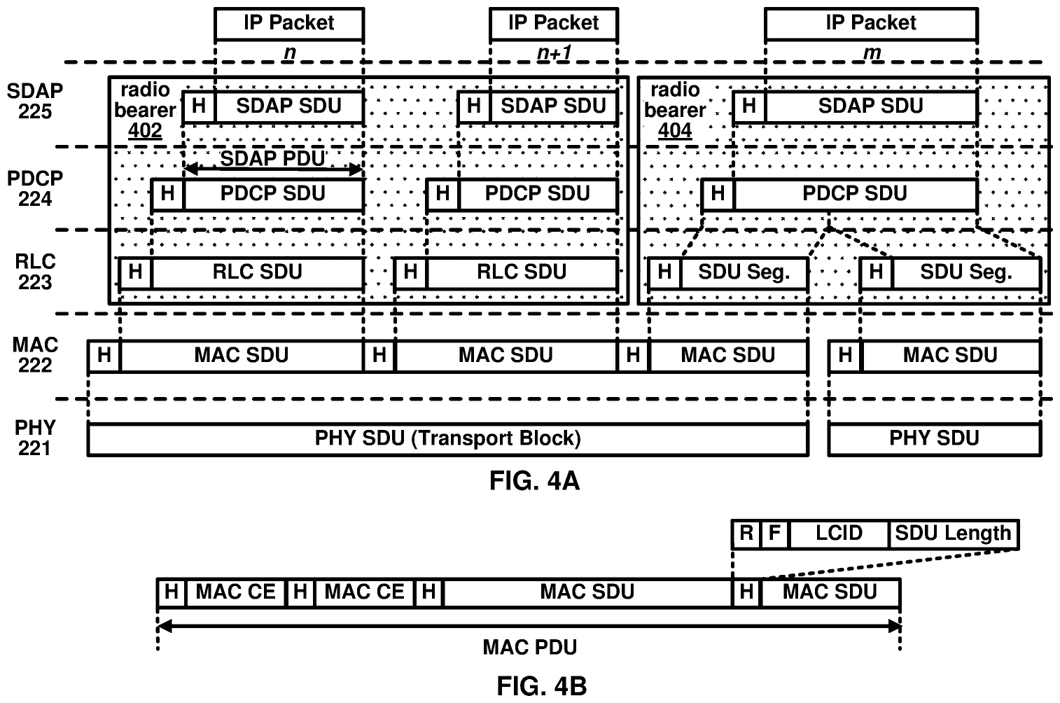

FIG. 4A illustrates an example downlink data flow through the NR user plane protocol stack of FIG. 2A.

FIG. 4B illustrates an example format of a MAC subheader in a MAC PDU.

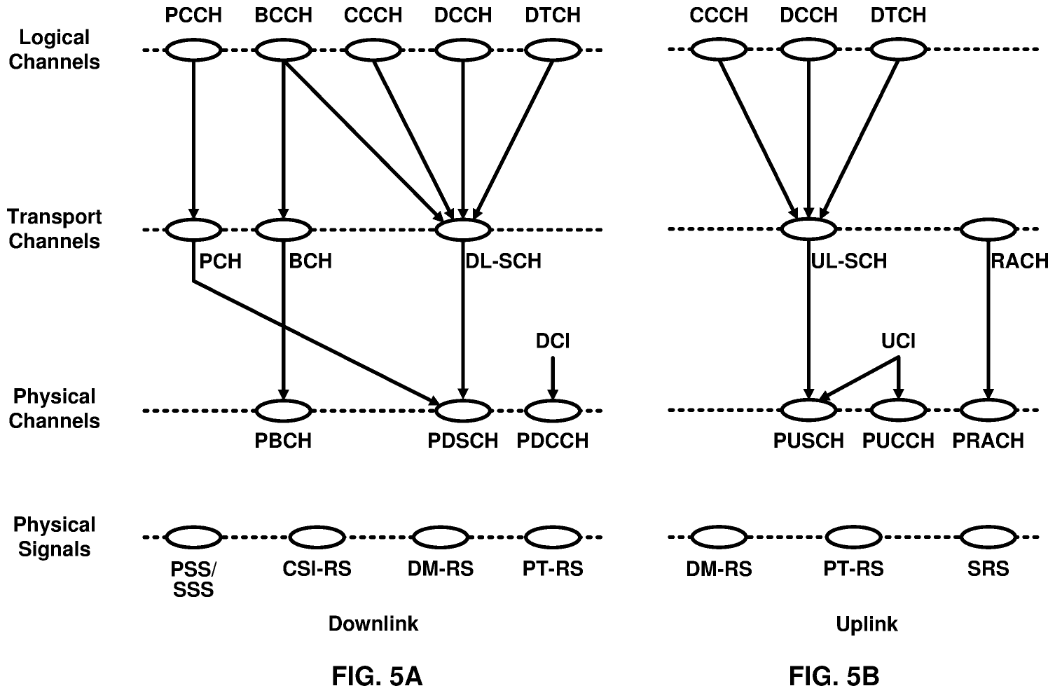

FIG. 5A and FIG. 5B respectively illustrate a mapping between logical channels, transport channels, and physical channels for the downlink and uplink.

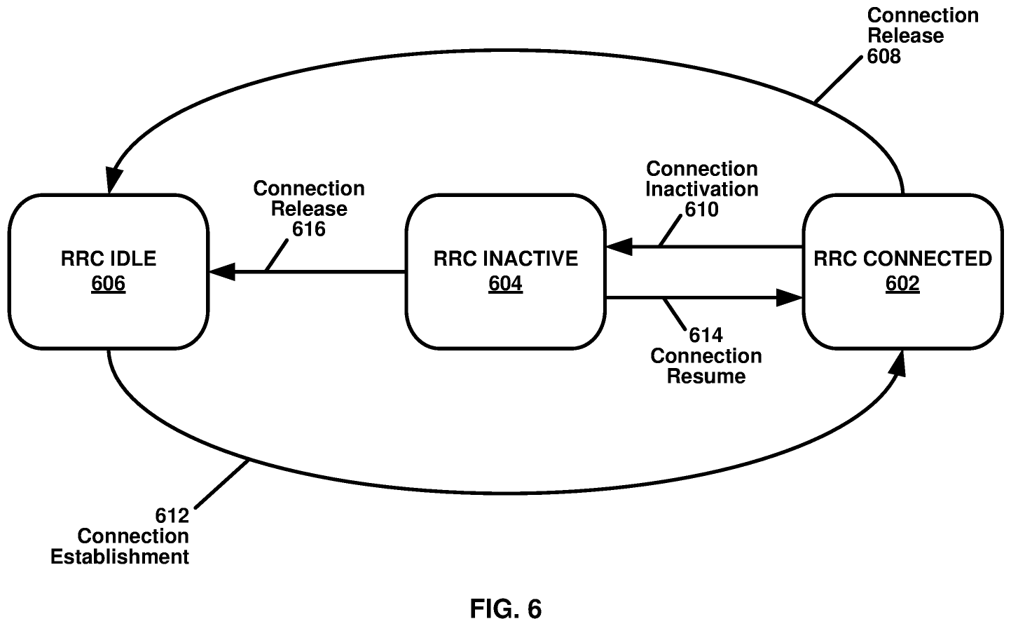

FIG. 6 is an example diagram showing RRC state transitions of a UE.

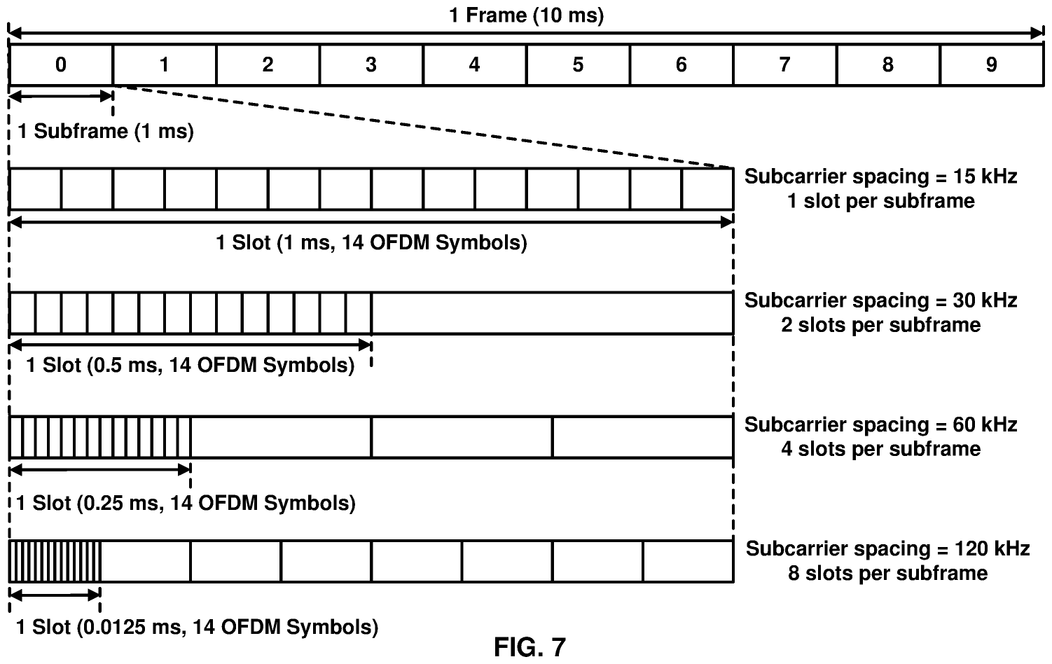

FIG. 7 illustrates an example configuration of an NR frame into which OFDM symbols are grouped.

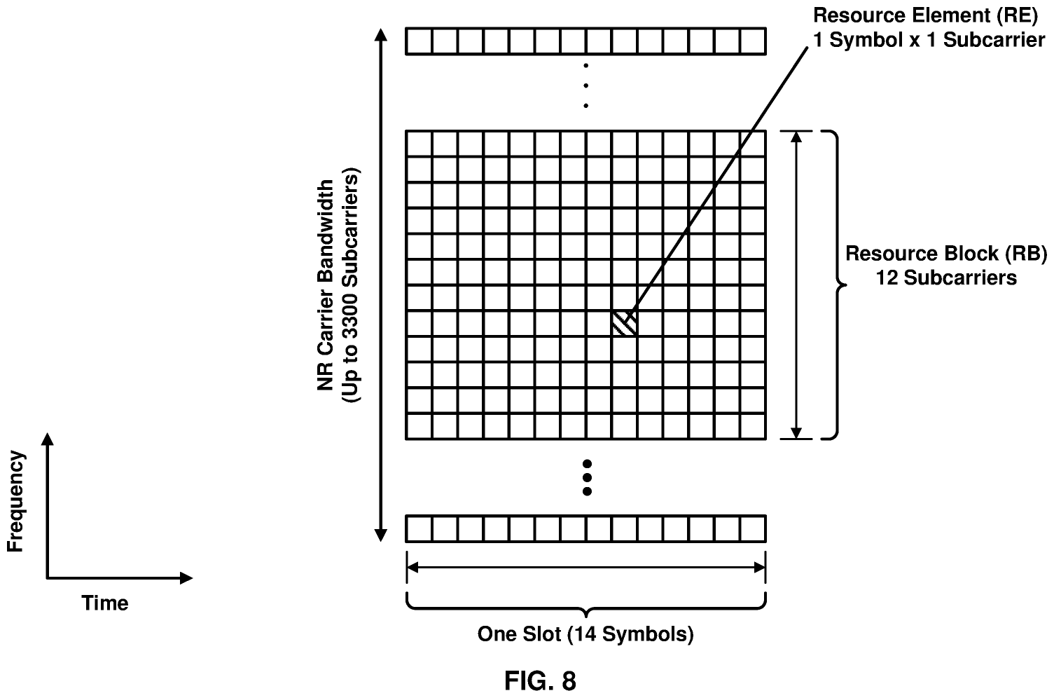

FIG. 8 illustrates an example configuration of a slot in the time and frequency domain for an NR carrier.

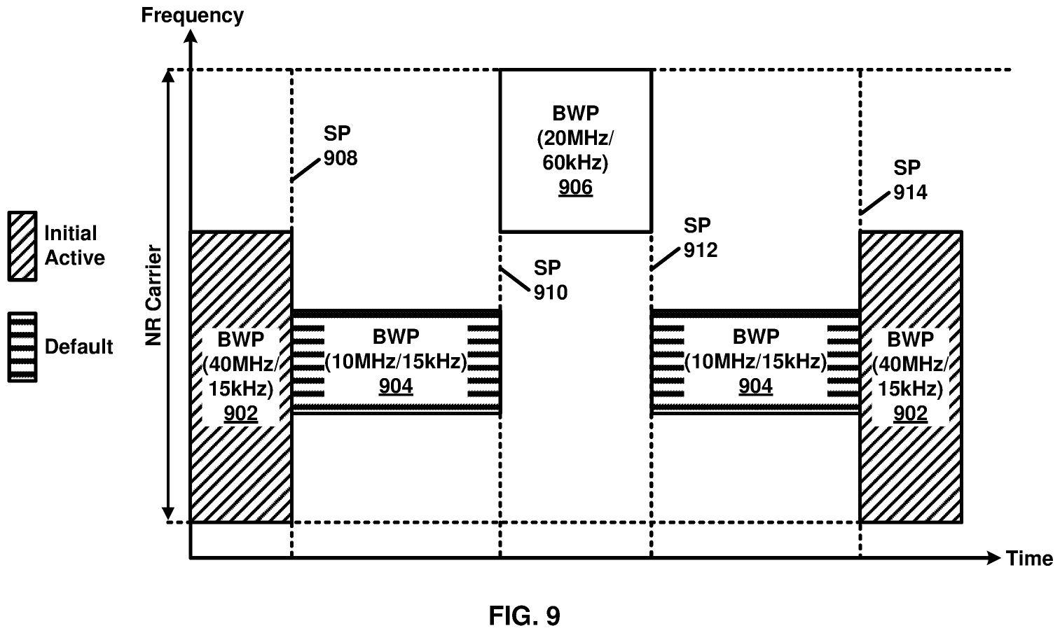

FIG. 9 illustrates an example of bandwidth adaptation using three configured BWPs for an NR carrier.

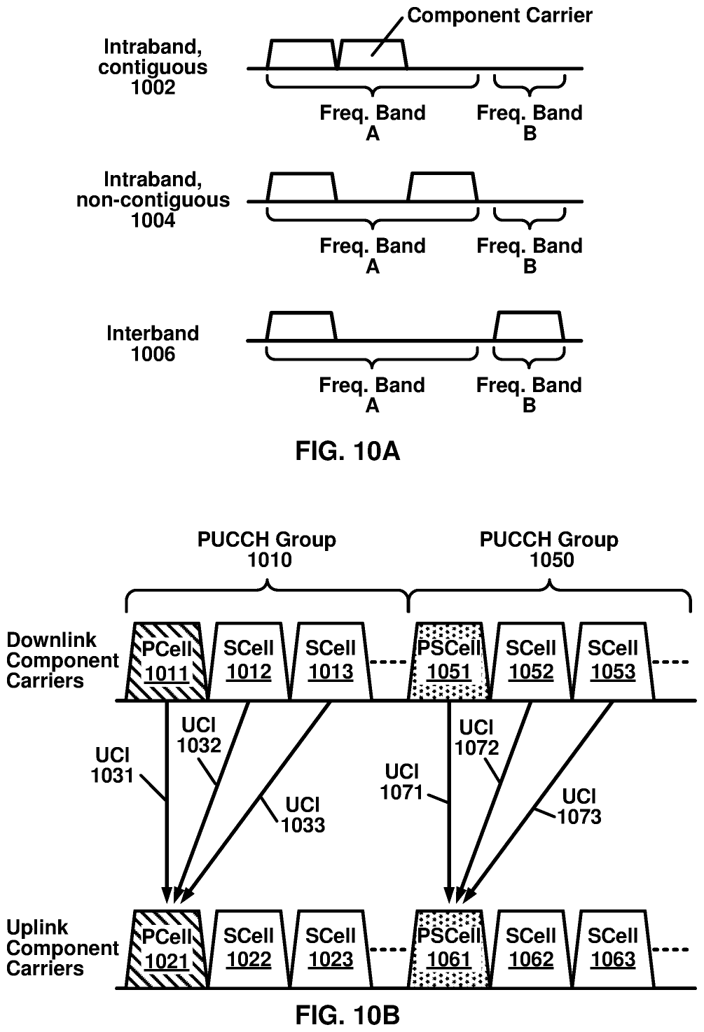

FIG. 10A illustrates three carrier aggregation configurations with two component carriers.

FIG. 10B illustrates an example of how aggregated cells may be configured into one or more PUCCH groups.

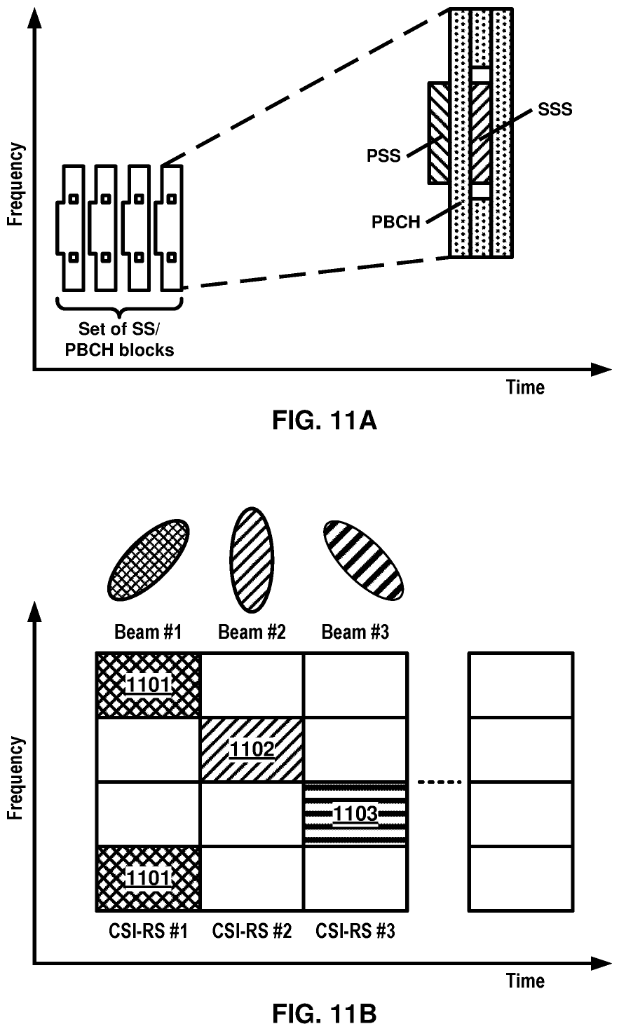

FIG. 11A illustrates an example of an SS/PBCH block structure and location.

FIG. 11B illustrates an example of CSI-RSs that are mapped in the time and frequency domains.

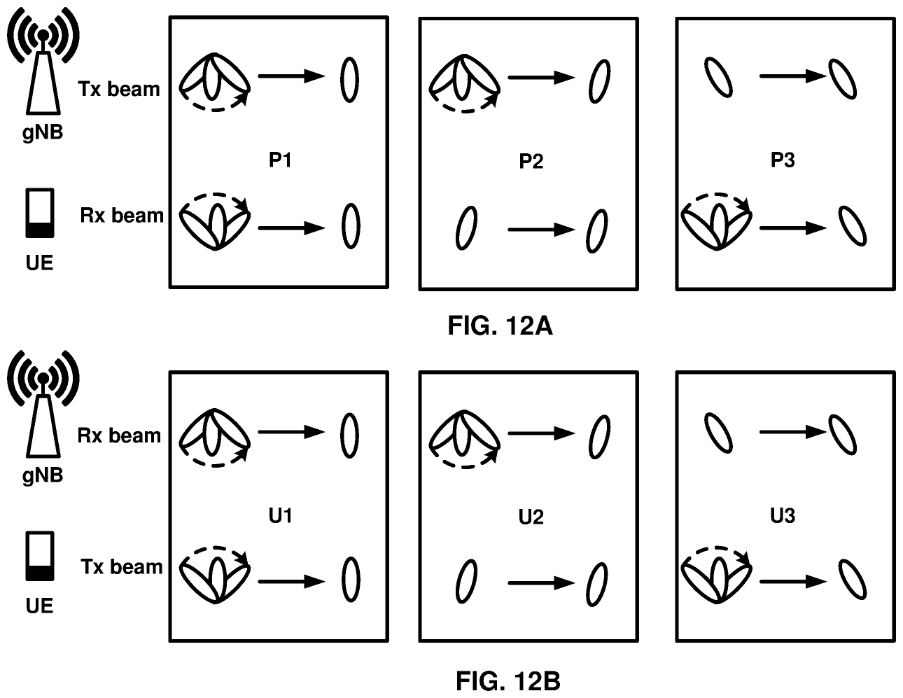

FIG. 12A and FIG. 12B respectively illustrate examples of three downlink and uplink beam management procedures.

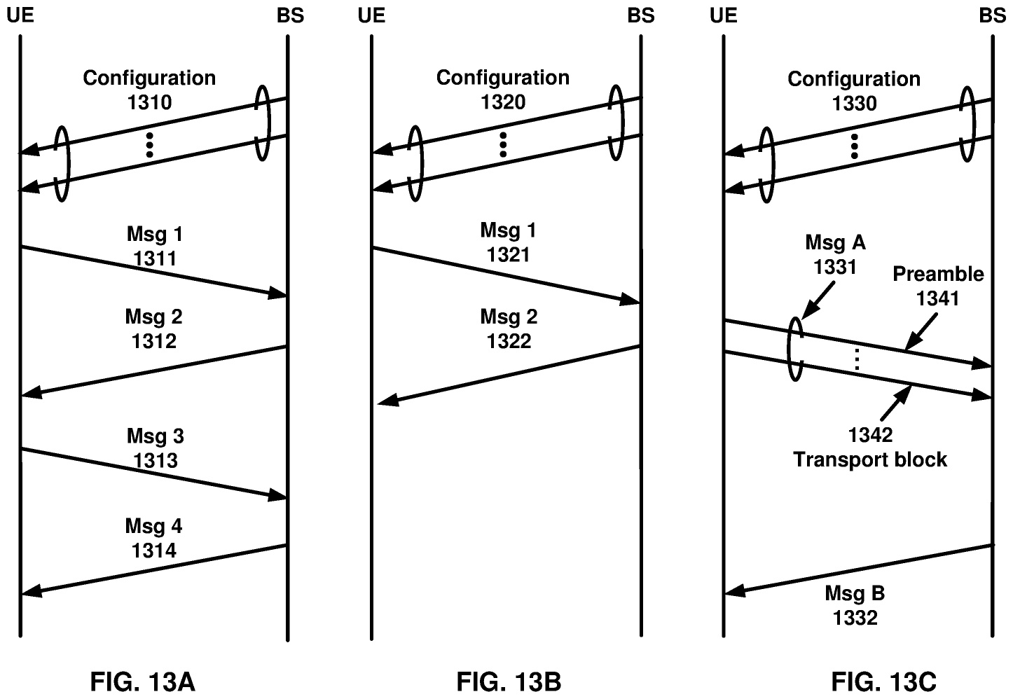

FIG. 13A, FIG. 13B, and FIG. 13C respectively illustrate a four-step contention-based random access procedure, a two-step contention-free random access procedure, and another two-step random access procedure.

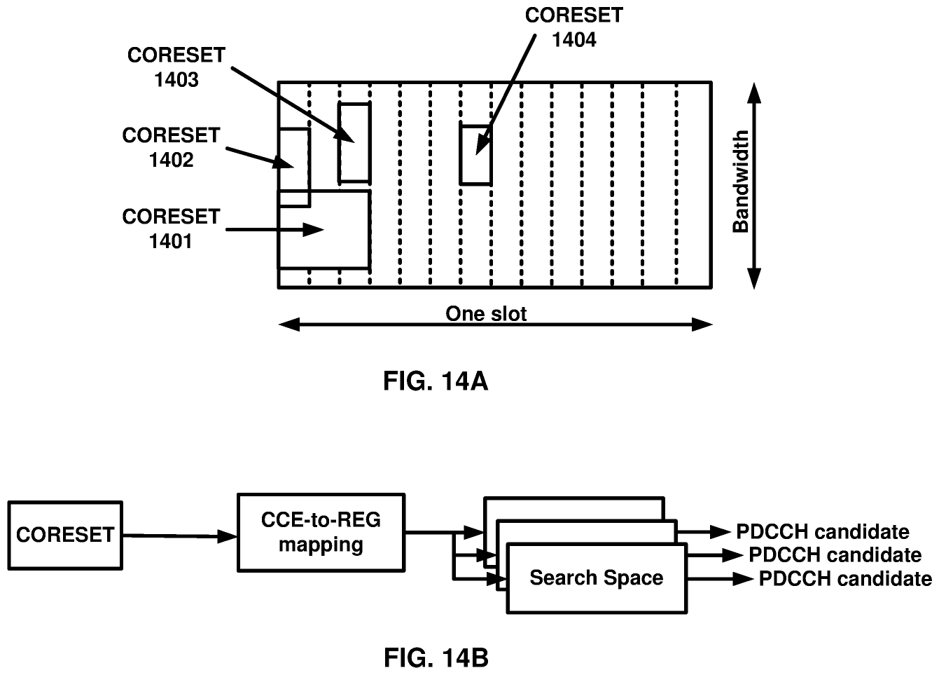

FIG. 14A illustrates an example of CORESET configurations for a bandwidth part.

FIG. 14B illustrates an example of a CCE-to-REG mapping for DCI transmission on a CORESET and PDCCH processing.

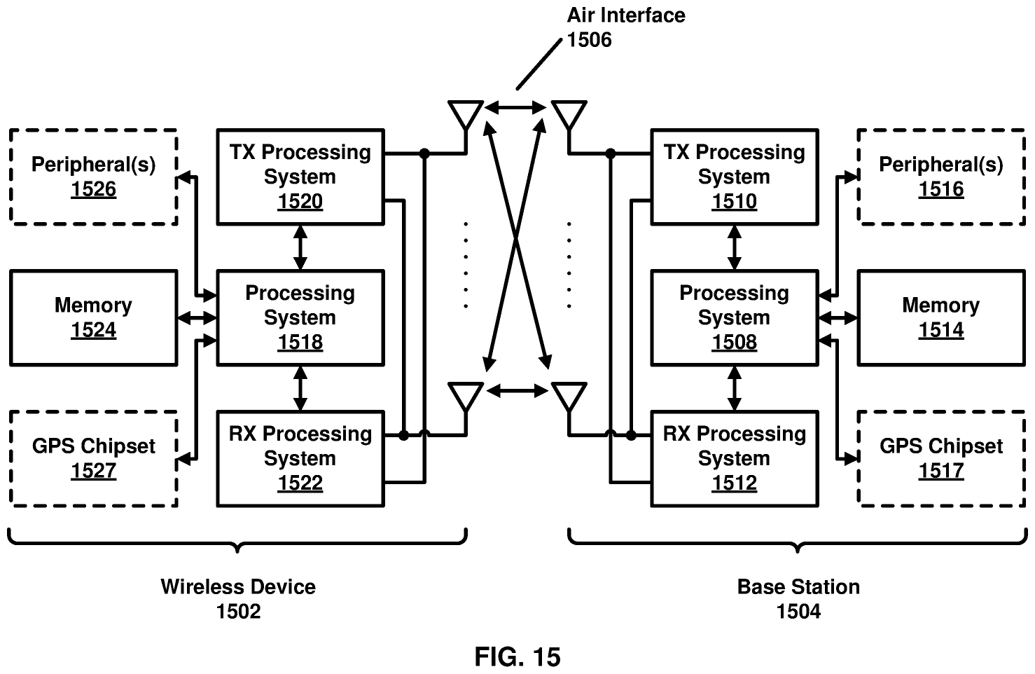

FIG. 15 illustrates an example of a wireless device in communication with a base station.

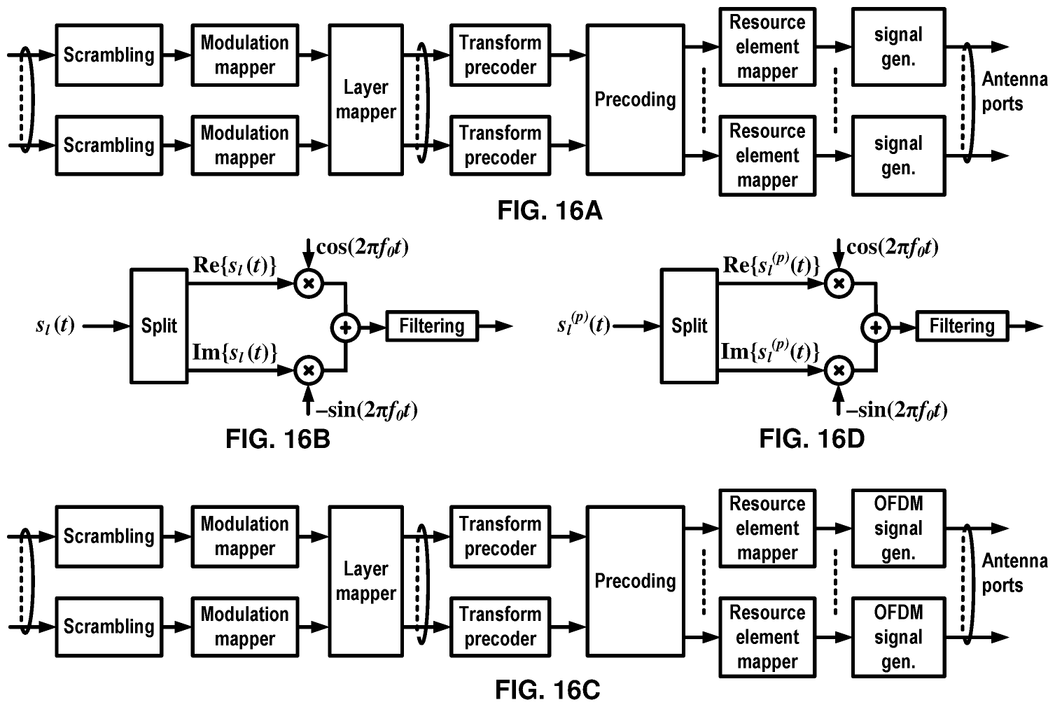

FIG. 16A, FIG. 16B, FIG. 16C, and FIG. 16D illustrate example structures for uplink and downlink transmission.

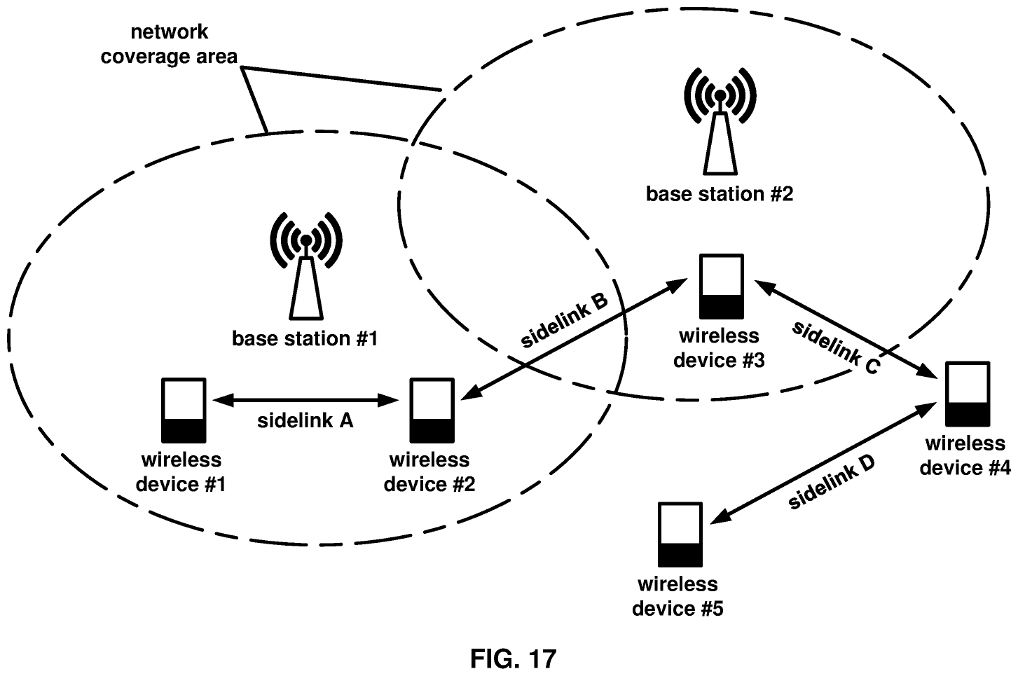

FIG. 17 illustrates examples of device-to-device (D2D) communication as per an aspect of an example embodiment of the present disclosure.

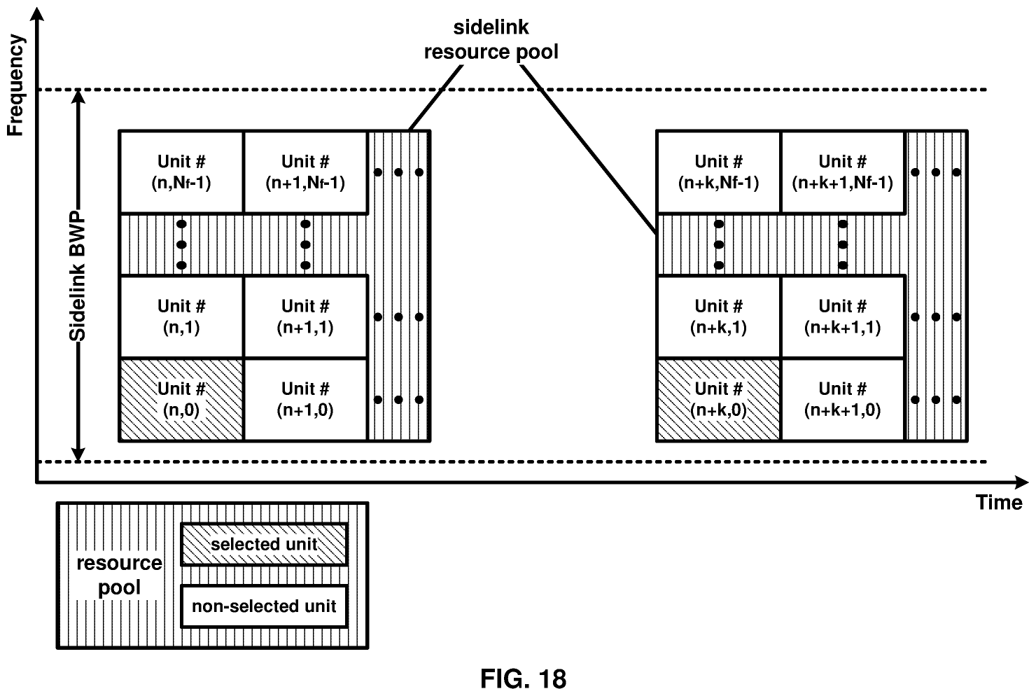

FIG. 18 illustrates an example of a resource pool for sidelink operations as per an aspect of an example embodiment of the present disclosure.

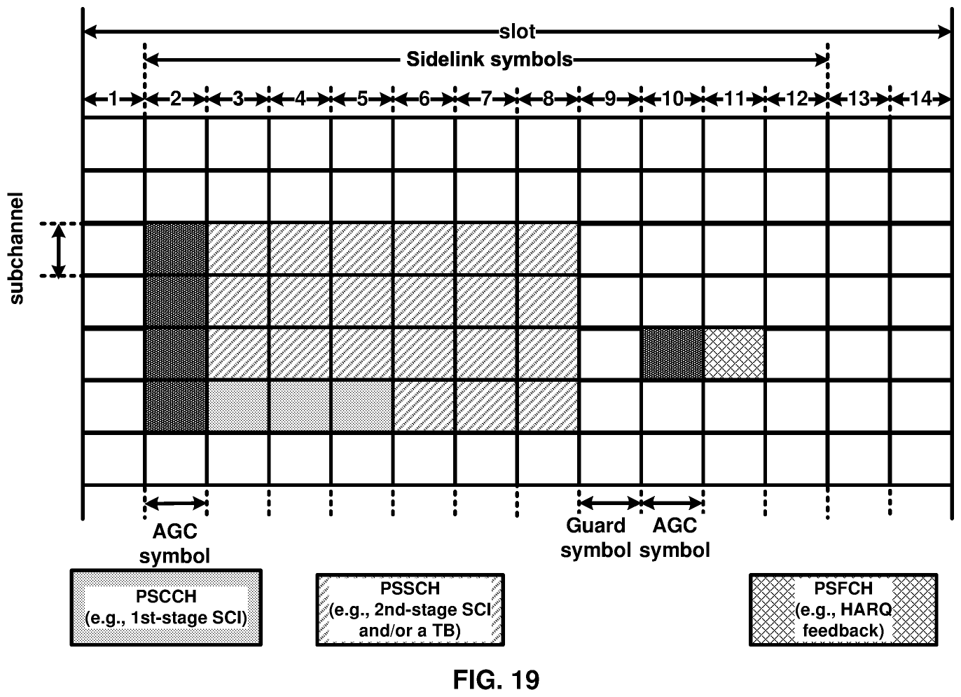

FIG. 19 illustrates an example of sidelink symbols in a slot as per an aspect of an example embodiment of the present disclosure.

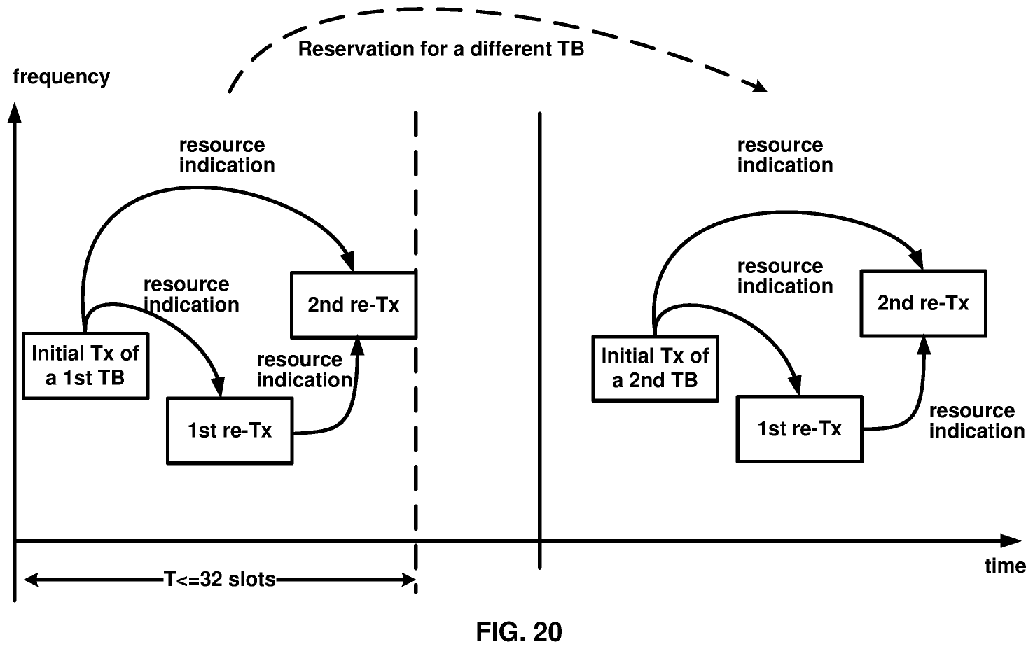

FIG. 20 illustrates an example of resource indication for a first TB (e.g, a first data packet) and resource reservation for a second TB (e.g., a second data packet) as per an aspect of an example embodiment of the present disclosure.

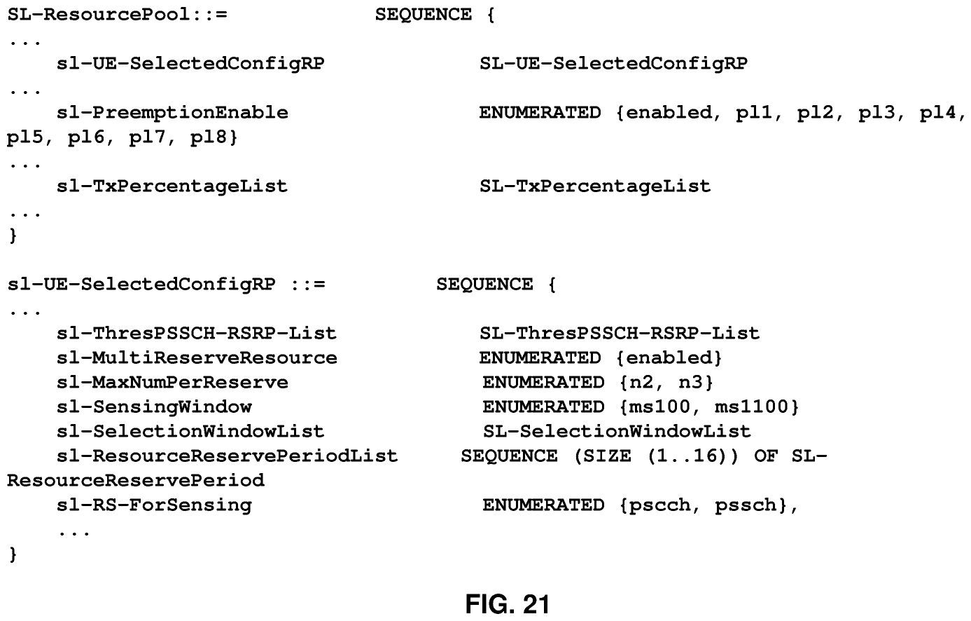

FIG. 21 illustrates an example of configuration information for sidelink communication as per an aspect of an example embodiment of the present disclosure.

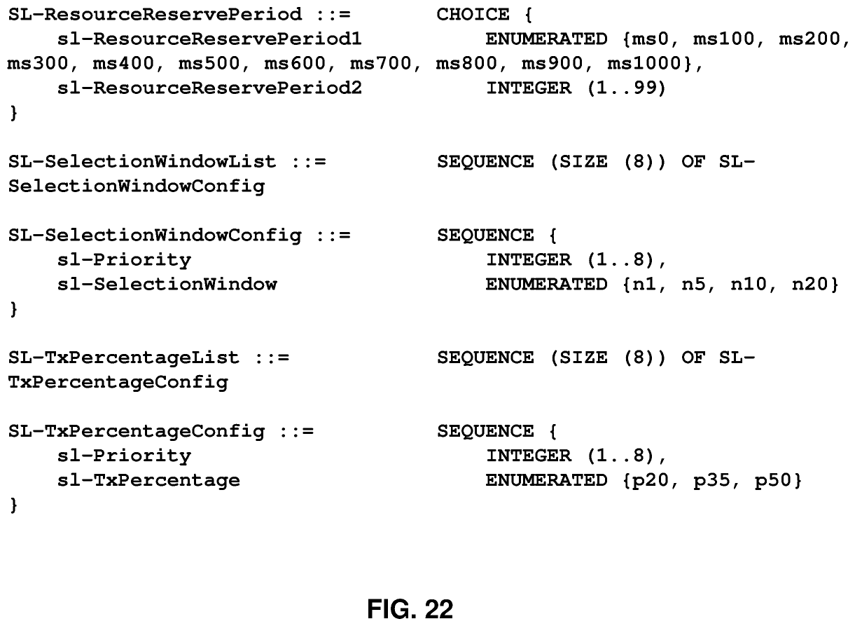

FIG. 22 illustrates an example of configuration information for sidelink communication as per an aspect of an example embodiment of the present disclosure.

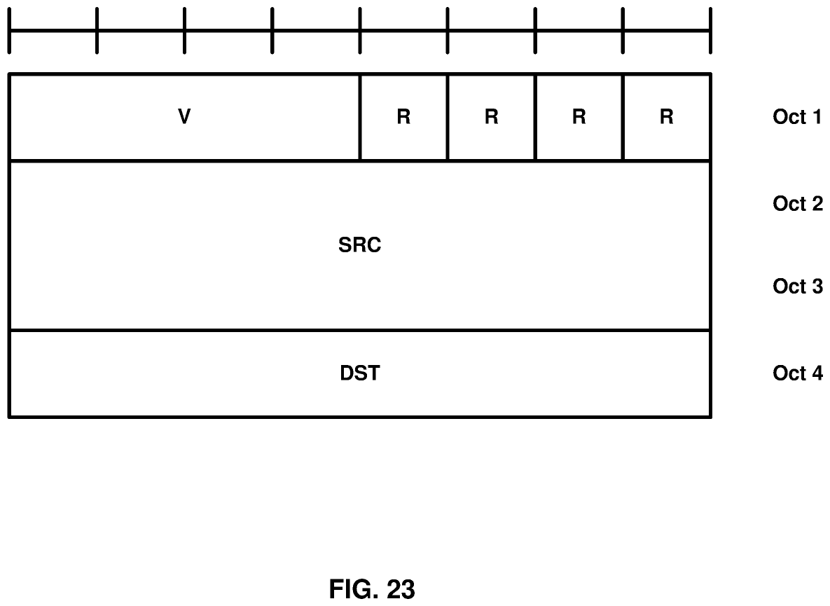

FIG. 23 illustrates an example format of a MAC subheader for sidelink shared channel (SL-SCH) an aspect of an example embodiment of the present disclosure.

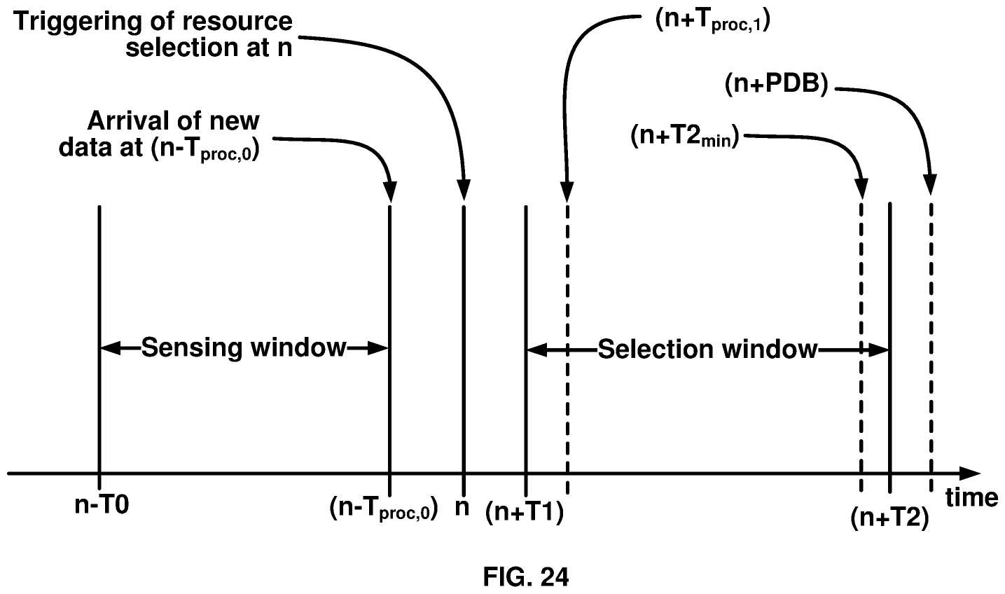

FIG. 24 illustrates an example time of a resource selection procedure as per an aspect of an example embodiment of the present disclosure.

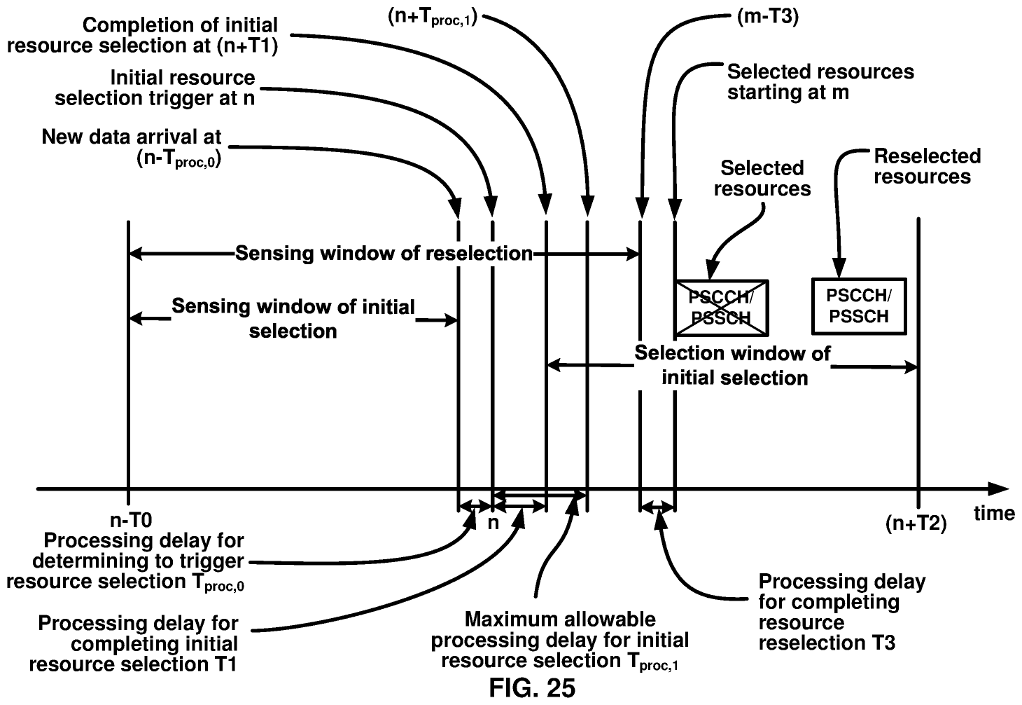

FIG. 25 illustrates an example timing of a resource selection procedure as per an aspect of an example embodiment of the present disclosure.

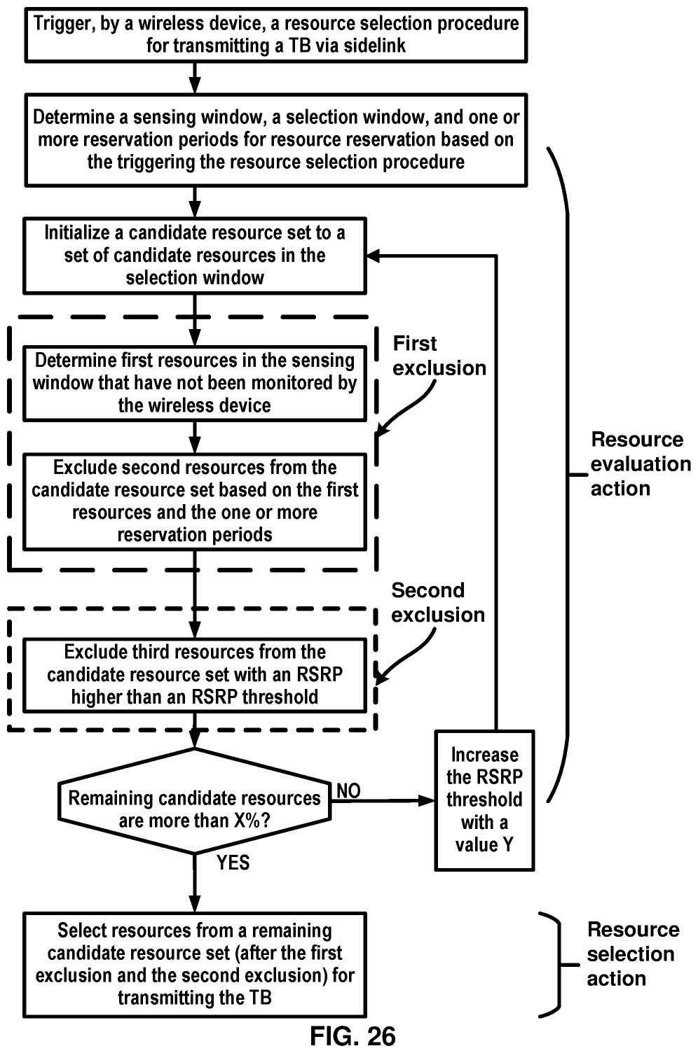

FIG. 26 illustrates an example flowchart of a resource selection procedure by a wireless device for transmitting a TB via sidelink as per an aspect of an example embodiment of the present disclosure.

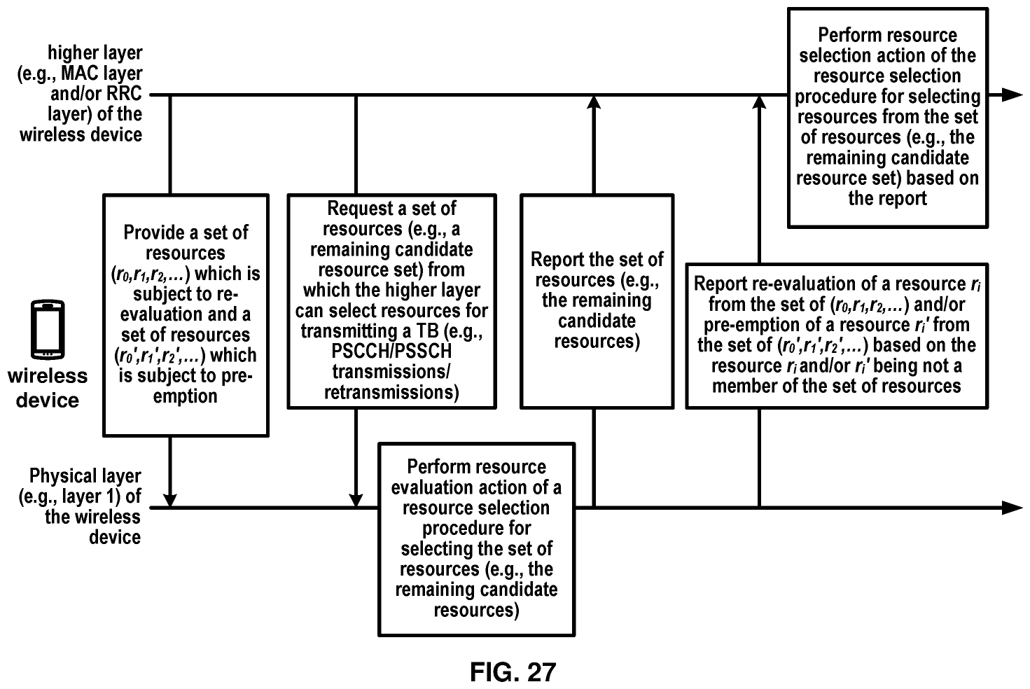

FIG. 27 illustrates an example diagram of the resource selection procedure among layers of the wireless device as per an aspect of an example embodiment of the present disclosure.

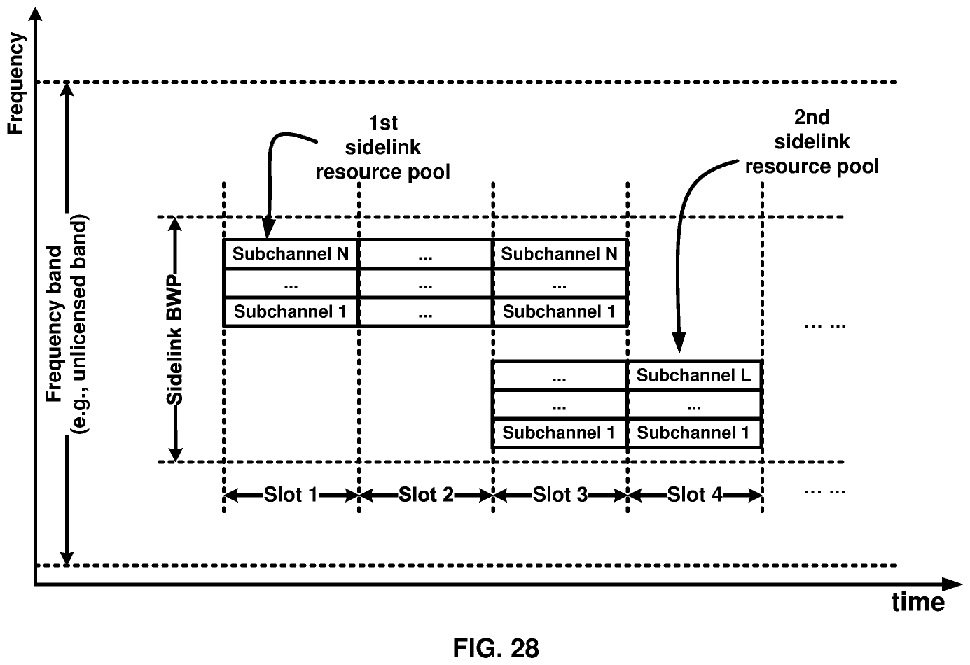

FIG. 28 illustrates an example configuration of a sidelink resource pool in a frequency band as per an aspect of an example embodiment of the present disclosure.

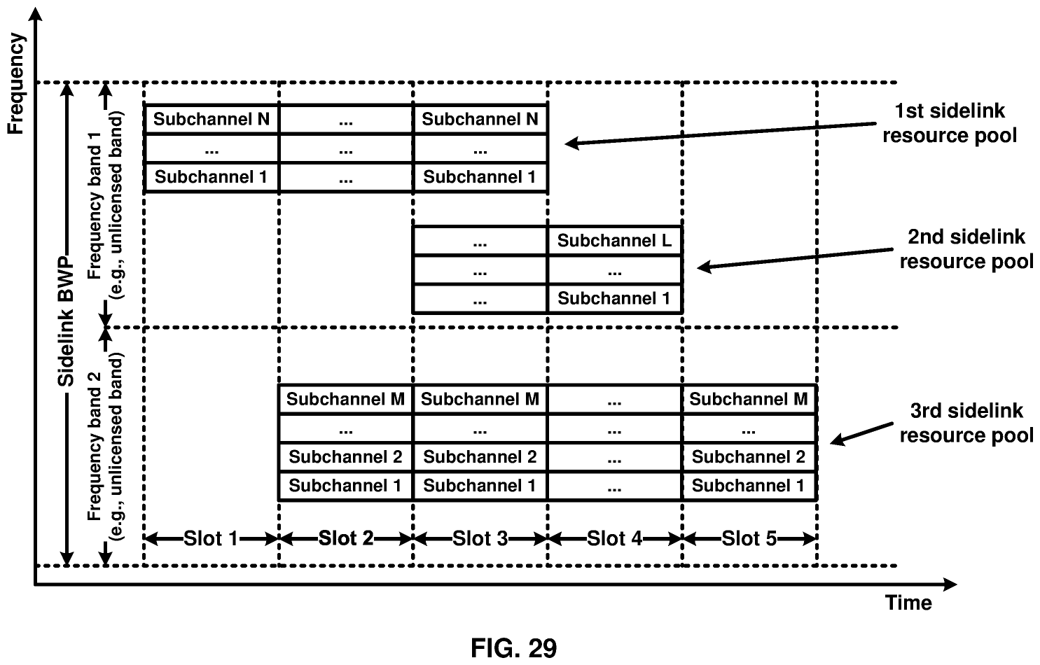

FIG. 29 illustrates an example configuration of a sidelink resource pool in a frequency band as per an aspect of an example embodiment of the present disclosure.

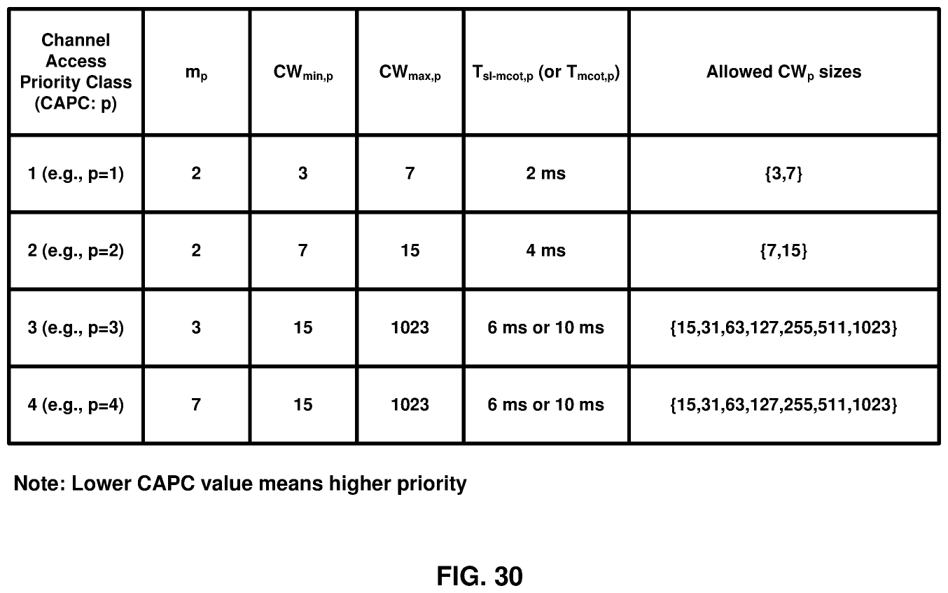

FIG. 30 shows a table of example parameters for sidelink channel access procedure.

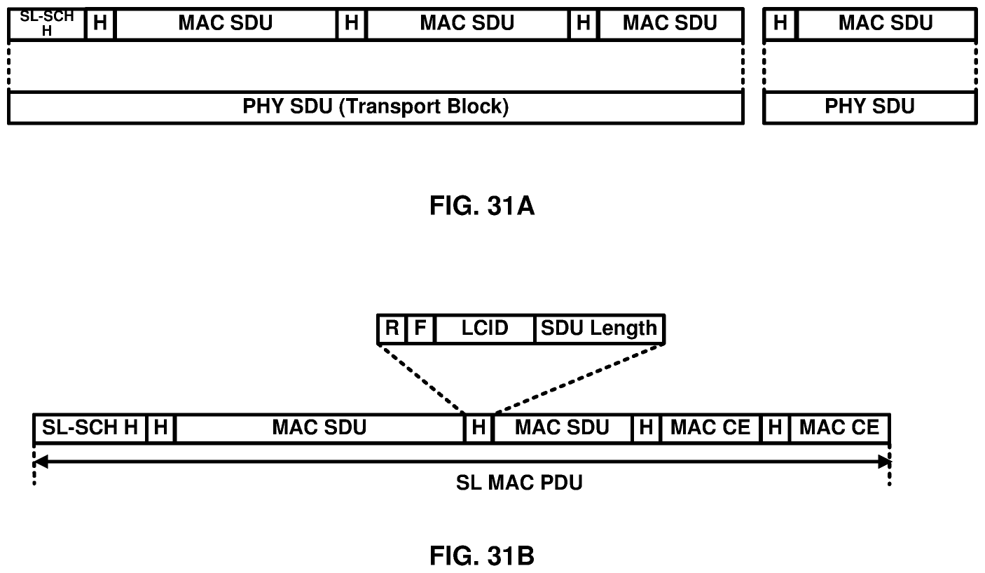

FIG. 31A and FIG. 31B illustrate examples of TB generation for sidelink.

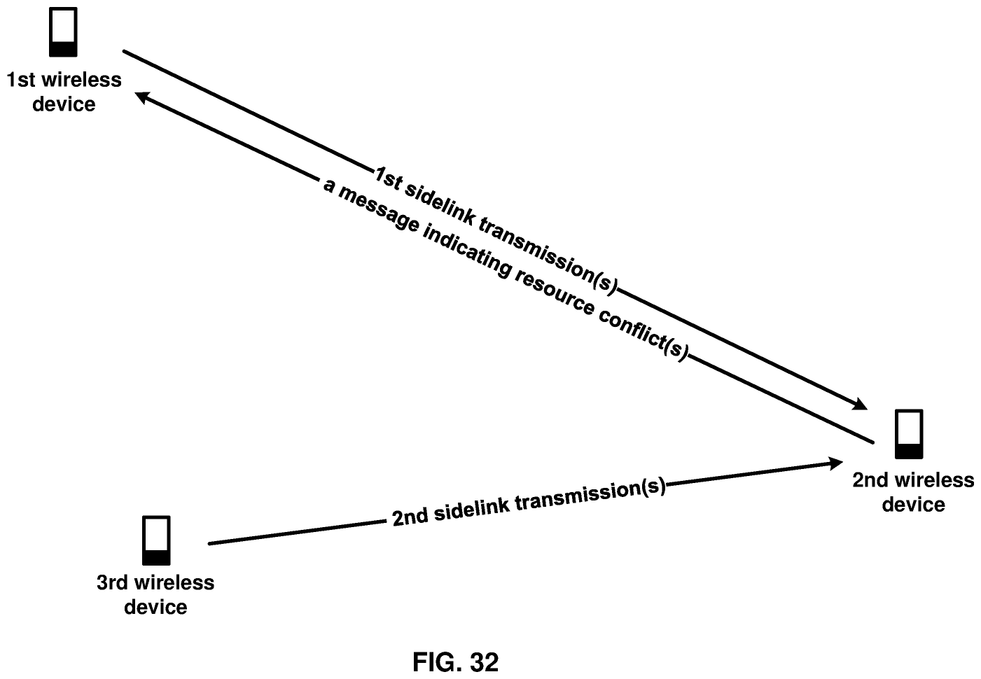

FIG. 32 illustrates an example of a sidelink inter-UE coordination (e.g., an inter-UE coordination scheme 2).

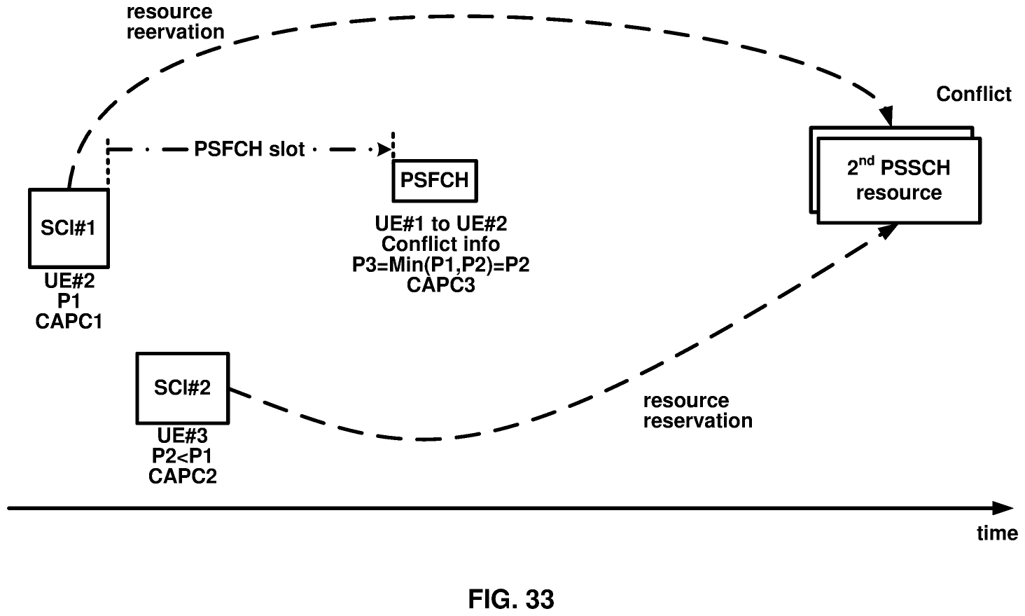

FIG. 33 shows an example of resource conflict on two reserved resources in a resource pool.

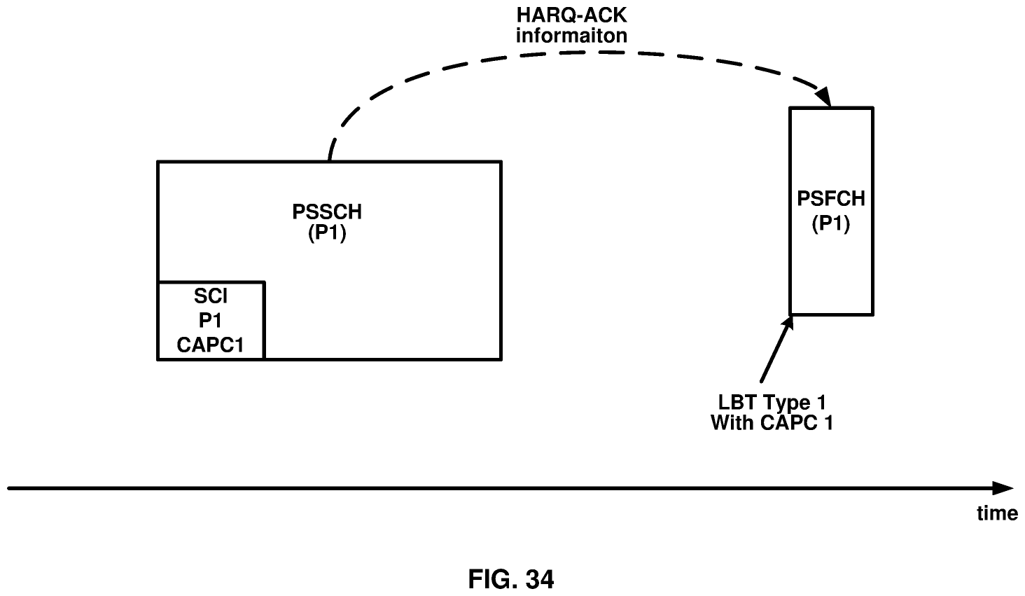

FIG. 34 shows an example of PSFCH transmission with HARQ-ACK information.

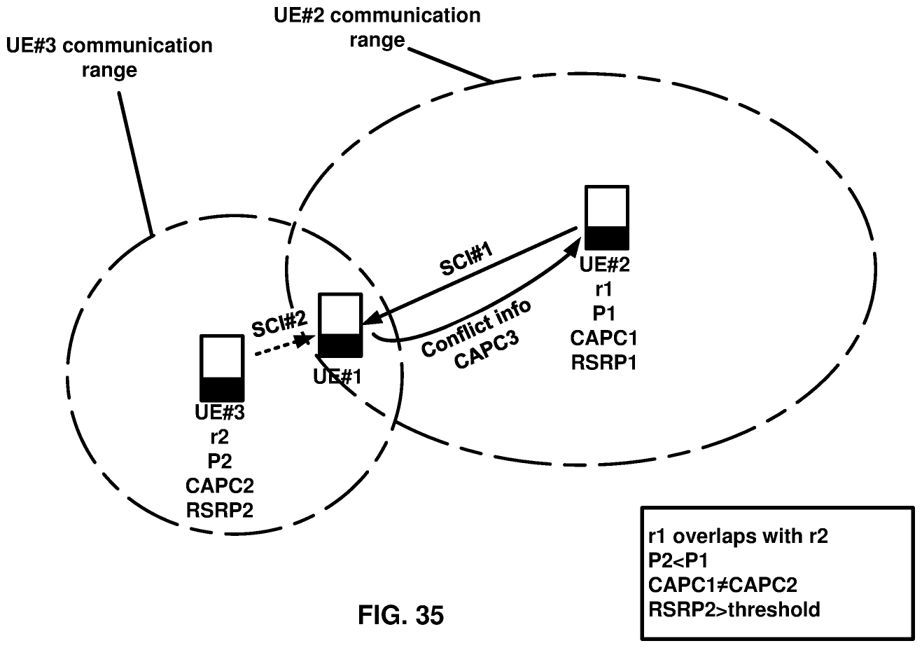

FIG. 35 shows an example of transmitting conflict information.

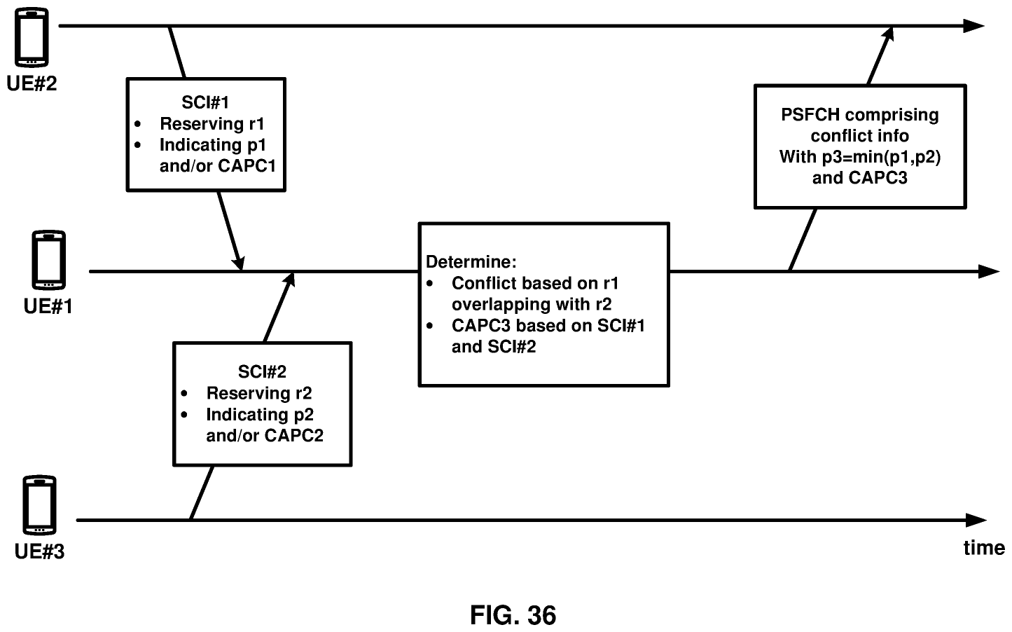

FIG. 36 shows an example of CAPC determination for a PSFCH with conflict information.

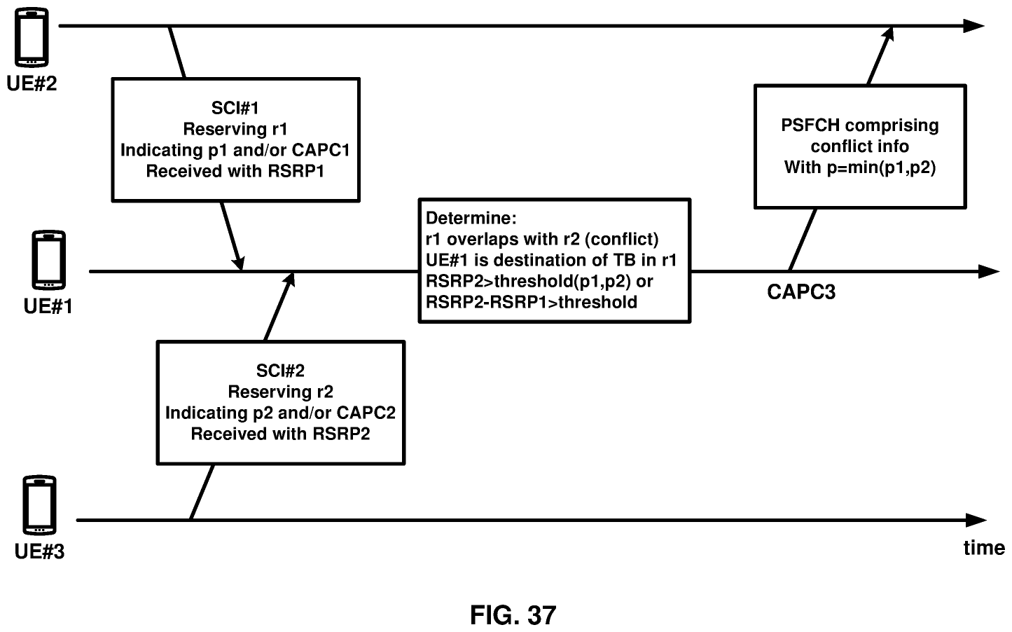

FIG. 37 shows an example of CAPC determination for a PSFCH with conflict information.

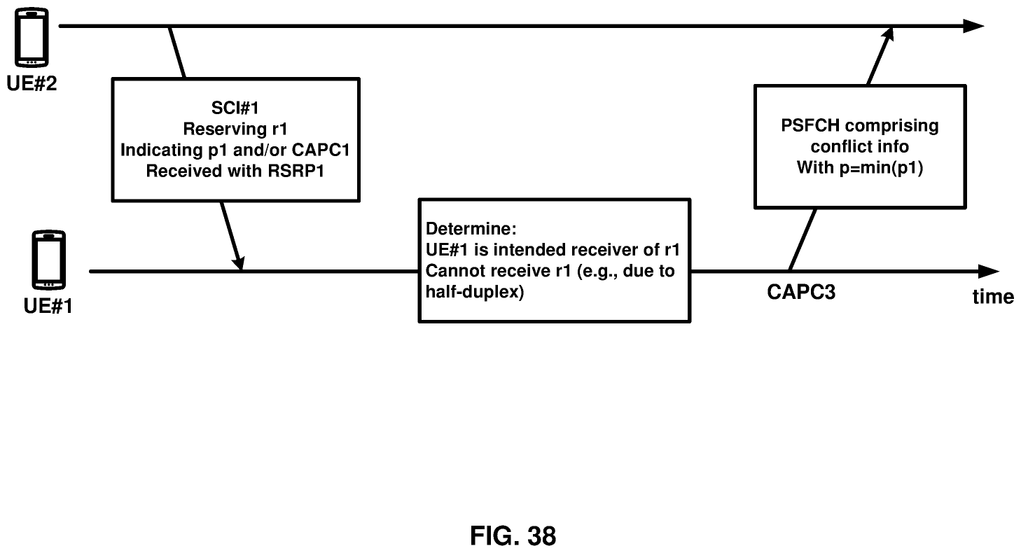

FIG. 38 shows an example of CAPC determination for a PSFCH with conflict information.

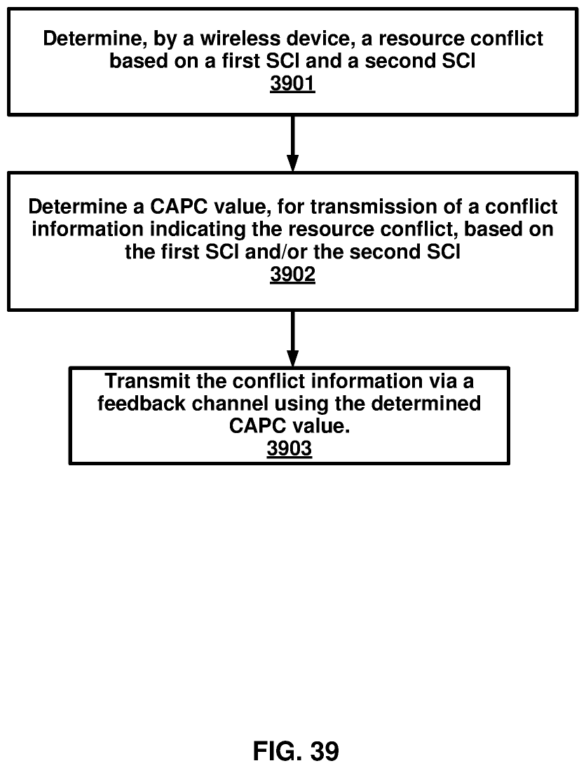

FIG. 39 shows an example call flow for CAPC determination associated with conflict information.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNs), such as public DNs (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, WiFi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNs (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNs, quality of service (QoS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYs 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA)), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 212 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR include, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split in two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 s. For example, NR defines numerologies with the following subcarrier spacing/cyclic prefix duration combinations: 15 kHz/4.7 s; 30 kHz/2.3 s; 60 kHz/1.2 s; 120 kHz/0.59 s; and 240 kHz/0.29 s.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 kHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 kHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 kHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response receiving a DCI indicating BWP 906 as the active BWP. The UE may switch at a switching point 912 from active BWP 906 to BWP 904 in response to an expiry of a BWP inactivity timer and/or in response receiving a DCI indicating BWP 904 as the active BWP. The UE may switch at a switching point 914 from active BWP 904 to BWP 902 in response receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary Scell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g. a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g. maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM)) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS)), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in a SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS)) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counter-clockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counter-clockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counter-clockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preambleTransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL-SCH and indicated on a PDCCH using a random access RNTI (RA-RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-ResponseWindow) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:

RA-RNTI=1+s_id+14×t_id+14×80×f_id+14×80×8×ul_carrier_id, where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC-RNTI included in the Msg 2 1312, and/or any other suitable identifier).

The Msg 4 1314 may be received after or in response to the transmitting of the Msg 3 1313. If a C-RNTI was included in the Msg 3 1313, the base station will address the UE on the PDCCH using the C-RNTI. If the UE's unique C-RNTI is detected on the PDCCH, the random access procedure is determined to be successfully completed. If a TC-RNTI is included in the Msg 3 1313 (e.g., if the UE is in an RRC_IDLE state or not otherwise connected to the base station), Msg 4 1314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 3 1313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 2 1322. The Msg 1 1321 and the Msg 2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 3 1313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-ResponseWindow) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 3 1313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI)). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 00 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI)) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, an CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g. RRC messages) comprising configuration parameters of a plurality of cells (e.g. primary cell, secondary cell). The wireless device may communicate with at least one base station (e.g. two or more base stations in dual-connectivity) via the plurality of cells. The one or more messages (e.g. as a part of the configuration parameters) may comprise parameters of physical, MAC, RLC, PCDP, SDAP, RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g. the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry of a random access response window timer, the time difference between two time stamps may be used. When a timer is restarted, a process for measurement of time window may be restarted. Other example implementations may be provided to restart a measurement of a time window.

FIG. 17 illustrates examples of device-to-device (D2D) communication, in which there is a direct communication between wireless devices. In an example, D2D communication may be performed via a sidelink (SL). The wireless devices may exchange sidelink communications via a sidelink interface (e.g., a PC5 interface). Sidelink differs from uplink (in which a wireless device communicates to a base station) and downlink (in which a base station communicates to a wireless device). A wireless device and a base station may exchange uplink and/or downlink communications via a user plane interface (e.g., a Uu interface).

As shown in the FIG. 17, wireless device #1 and wireless device #2 may be in a coverage area of base station #1. For example, both wireless device #1 and wireless device #2 may communicate with the base station #1 via a Uu interface. Wireless device #3 may be in a coverage area of base station #2. Base station #1 and base station #2 may share a network and may jointly provide a network coverage area. Wireless device #4 and wireless device #5 may be outside of the network coverage area.

In-coverage D2D communication may be performed when two wireless devices share a network coverage area. Wireless device #1 and wireless device #2 are both in the coverage area of base station #1. Accordingly, they may perform an in-coverage intra-cell D2D communication, labeled as sidelink A. Wireless device #2 and wireless device #3 are in the coverage areas of different base stations, but share the same network coverage area. Accordingly, they may perform an in-coverage inter-cell D2D communication, labeled as sidelink B. Partial-coverage D2D communications may be performed when one wireless device is within the network coverage area and the other wireless device is outside the network coverage area. Wireless device #3 and wireless device #4 may perform a partial-coverage D2D communication, labeled as sidelink C. Out-of-coverage D2D communications may be performed when both wireless devices are outside of the network coverage area. Wireless device #4 and wireless device #5 may perform an out-of-coverage D2D communication, labeled as sidelink D.

Sidelink communications may be configured using physical channels, for example, a physical sidelink broadcast channel (PSBCH), a physical sidelink feedback channel (PSFCH), a physical sidelink discovery channel (PSDCH), a physical sidelink control channel (PSCCH), and/or a physical sidelink shared channel (PSSCH). PSBCH may be used by a first wireless device to send broadcast information to a second wireless device. PSBCH may be similar in some respects to PBCH. The broadcast information may comprise, for example, a slot format indication, resource pool information, a sidelink system frame number, or any other suitable broadcast information. PSFCH may be used by a first wireless device to send feedback information to a second wireless device. The feedback information may comprise, for example, HARQ feedback information. PSDCH may be used by a first wireless device to send discovery information to a second wireless device. The discovery information may be used by a wireless device to signal its presence and/or the availability of services to other wireless devices in the area. PSCCH may be used by a first wireless device to send sidelink control information (SCI) to a second wireless device. PSCCH may be similar in some respects to PDCCH and/or PUCCH. The control information may comprise, for example, time/frequency resource allocation information (RB size, a number of retransmissions, etc.), demodulation related information (DMRS, MCS, RV, etc.), identifying information for a transmitting wireless device and/or a receiving wireless device, a process identifier (HARQ, etc.), or any other suitable control information. The PSCCH may be used to allocate, prioritize, and/or reserve sidelink resources for sidelink transmissions. PSSCH may be used by a first wireless device to send and/or relay data and/or network information to a second wireless device. PSSCH may be similar in some respects to PDSCH and/or PUSCH. Each of the sidelink channels may be associated with one or more demodulation reference signals. Sidelink operations may utilize sidelink synchronization signals to establish a timing of sidelink operations. Wireless devices configured for sidelink operations may send sidelink synchronization signals, for example, with the PSBCH. The sidelink synchronization signals may include primary sidelink synchronization signals (PSSS) and secondary sidelink synchronization signals (SSSS).

Sidelink resources may be configured to a wireless device in any suitable manner. A wireless device may be pre-configured for sidelink, for example, pre-configured with sidelink resource information. Additionally or alternatively, a network may broadcast system information relating to a resource pool for sidelink. Additionally or alternatively, a network may configure a particular wireless device with a dedicated sidelink configuration. The configuration may identify sidelink resources to be used for sidelink operation (e.g., configure a sidelink band combination).

The wireless device may operate in different modes, for example, an assisted mode (which may be referred to as mode 1) or an autonomous mode (which may be referred to as mode 2). Mode selection may be based on a coverage status of the wireless device, a radio resource control status of the wireless device, information and/or instructions from the network, and/or any other suitable factors. For example, if the wireless device is idle or inactive, or if the wireless device is outside of network coverage, the wireless device may select to operate in autonomous mode. For example, if the wireless device is in a connected mode (e.g., connected to a base station), the wireless device may select to operate (or be instructed by the base station to operate) in assisted mode. For example, the network (e.g., a base station) may instruct a connected wireless device to operate in a particular mode.

In an assisted mode, the wireless device may request scheduling from the network. For example, the wireless device may send a scheduling request to the network and the network may allocate sidelink resources to the wireless device. Assisted mode may be referred to as network-assisted mode, gNB-assisted mode, or base station-assisted mode. In an autonomous mode, the wireless device may select sidelink resources based on measurements within one or more resource pools (for example, pre-configure or network-assigned resource pools), sidelink resource selections made by other wireless devices, and/or sidelink resource usage of other wireless devices.

To select sidelink resources, a wireless device may observe a sensing window and a selection window. During the sensing window, the wireless device may observe SCI transmitted by other wireless devices using the sidelink resource pool. The SCIs may identify resources that may be used and/or reserved for sidelink transmissions. Based on the resources identified in the SCIs, the wireless device may select resources within the selection window (for example, resource that are different from the resources identified in the SCIs). The wireless device may transmit using the selected sidelink resources.

FIG. 18 illustrates an example of a resource pool for sidelink operations. A wireless device may operate using one or more sidelink cells. A sidelink cell may include one or more resource pools. Each resource pool may be configured to operate in accordance with a particular mode (for example, assisted or autonomous). The resource pool may be divided into resource units. In the frequency domain, each resource unit may comprise, for example, one or more resource blocks which may be referred to as a sub-channel. In the time domain, each resource unit may comprise, for example, one or more slots, one or more subframes, and/or one or more OFDM symbols. The resource pool may be continuous or non-continuous in the frequency domain and/or the time domain (for example, comprising contiguous resource units or non-contiguous resource units). The resource pool may be divided into repeating resource pool portions. The resource pool may be shared among one or more wireless devices. Each wireless device may attempt to transmit using different resource units, for example, to avoid collisions.

Sidelink resource pools may be arranged in any suitable manner. In the figure, the example resource pool is non-contiguous in the time domain and confined to a single sidelink BWP. In the example resource pool, frequency resources are divided into a Nf resource units per unit of time, numbered from zero to Nf−1. The example resource pool may comprise a plurality of portions (non-contiguous in this example) that repeat every k units of time. In the figure, time resources are numbered as n, n+1 . . . n+k, n+k+1 . . . , etc.

A wireless device may select for transmission one or more resource units from the resource pool. In the example resource pool, the wireless device selects resource unit (n,0) for sidelink transmission. The wireless device may further select periodic resource units in later portions of the resource pool, for example, resource unit (n+k,0), resource unit (n+2k,0), resource unit (n+3k,0), etc. The selection may be based on, for example, a determination that a transmission using resource unit (n,0) will not (or is not likely) to collide with a sidelink transmission of a wireless device that shares the sidelink resource pool. The determination may be based on, for example, behavior of other wireless devices that share the resource pool. For example, if no sidelink transmissions are detected in resource unit (n−k,0), then the wireless device may select resource unit (n,0), resource (n+k,0), etc. For example, if a sidelink transmission from another wireless device is detected in resource unit (n−k,1), then the wireless device may avoid selection of resource unit (n,1), resource (n+k,1), etc.

Different sidelink physical channels may use different resource pools. For example, PSCCH may use a first resource pool and PSSCH may use a second resource pool. Different resource priorities may be associated with different resource pools. For example, data associated with a first QoS, service, priority, and/or other characteristic may use a first resource pool and data associated with a second QoS, service, priority, and/or other characteristic may use a second resource pool. For example, a network (e.g., a base station) may configure a priority level for each resource pool, a service to be supported for each resource pool, etc. For example, a network (e.g., a base station) may configure a first resource pool for use by unicast UEs, a second resource pool for use by groupcast UEs, etc. For example, a network (e.g., a base station) may configure a first resource pool for transmission of sidelink data, a second resource pool for transmission of discovery messages, etc.

In an example of vehicle-to-everything (V2X) communications via a Uu interface and/or a PC5 interface, the V2X communications may be vehicle-to-vehicle (V2V) communications. A wireless device in the V2V communications may be a vehicle. In an example, the V2X communications may be vehicle-to-pedestrian (V2P) communications. A wireless device in the V2P communications may be a pedestrian equipped with a mobile phone/handset. In an example, the V2X communications may be vehicle-to-infrastructure (V2I) communications. The infrastructure in the V2I communications may be a base station/access point/node/road side unit. A wireless device in the V2X communications may be a transmitting wireless device performing one or more sidelink transmissions to a receiving wireless device. The wireless device in the V2X communications may be a receiving wireless device receiving one or more sidelink transmissions from a transmitting wireless device.

FIG. 19 illustrates an example of sidelink symbols in a slot. In an example, a sidelink transmission may be transmitted in a slot in the time domain. In an example, a wireless device may have data to transmit via sidelink. The wireless device may segment the data into one or more transport blocks (TBs). The one or more TBs may comprise different pieces of the data. A TB of the one or more TBs may be a data packet of the data. The wireless device may transmit a TB of the one or more TBs (e.g., a data packet) via one or more sidelink transmissions (e.g., via PSCCH/PSSCH in one or more slots). In an example, a sidelink transmission (e.g., in a slot) may comprise SC. The sidelink transmission may further comprise a TB. The SCI may comprise a 1^{st}-stage SCI and a 2^{nd}-stage SC. A PSCCH of the sidelink transmission may comprise the 1^{st}-stage SCI for scheduling a PSSCH (e.g., the TB). The PSSCH of the sidelink transmission may comprise the 2^{nd}-stage SC. The PSSCH of the sidelink transmission may further comprise the TB. In an example, sidelink symbols in a slot may or may not start from the first symbol of the slot. The sidelink symbols in the slot may or may not end at the last symbol of the slot. In an example of FIG. 19, sidelink symbols in a slot start from the second symbol of the slot. In an example of FIG. 19, the sidelink symbols in the slot end at the twelfth symbol of the slot. A first sidelink transmission may comprise a first automatic gain control (AGC) symbol (e.g., the second symbol in the slot), a PSCCH (e.g., in the third, fourth and the fifth symbols in a sub-channel in the slot), a PSSCH (e.g., from the third symbol to the eighth symbol in the slot), and/or a first guard symbol (e.g., the ninth symbol in the slot). A second sidelink transmission may comprise a second AGC symbol (e.g., the tenth symbol in the slot), a PSFCH (e.g., the eleventh symbol in the slot), and/or a second guard symbol for the second sidelink transmission (e.g., the twelfth symbol in the slot). In an example, one or more HARQ feedbacks (e.g., positive acknowledgement or ACK and/or negative acknowledgement or NACK) may be transmitted via the PSFCH. In an example, the PSCCH, the PSSCH, and the PSFCH may have different number of sub-channels (e.g., a different number of frequency resources) in the frequency domain.

The 1^{st}-stage SCI may be a SCI format 1-A. The SCI format 1-A may comprise a plurality of fields used for scheduling of the first TB on the PSSCH and the 2^{nd}-stage SCI on the PSSCH. The following information may be transmitted by means of the SCI format 1-A.
A priority of the sidelink transmission. For example, the priority may be a physical layer (e.g., layer 1) priority of the sidelink transmission. For example, the priority may be determined based on logical channel priorities of the sidelink transmission;
Frequency resource assignment of the PSSCH;
Time resource assignment of the PSSCH;
Resource reservation period/interval for a second TB;
Demodulation reference signal (DMRS) pattern;
A format of the 2^{nd}-stage S;
Beta_offset indicator;
Number of DMRS port;
Modulation and coding scheme of the PSSCH;
Additional MCS table indicator;
PSFCH overhead indication;
Reserved bits.

The 2^{nd}-stage SCI may be a SCI format 2-A. The SCI format 2-A may be used for the decoding of the PSSCH, with HARQ operation when HARQ-ACK information includes ACK or NACK, or when there is no feedback of HARQ-ACK information. The SCI format 2-A may comprise a plurality of fields indicating the following information.
HARQ process number;
New data indicator;
Redundancy version;
Source ID of a transmitter (e.g., a transmitting wireless device) of the sidelink transmission;
Destination ID of a receiver (e.g., a receiving wireless device) of the sidelink transmission;
HARQ feedback enabled/disabled indicator;
Cast type indicator indicating that the sidelink transmission is a broadcast, a groupcast and/or a unicast;
CSI request.

The 2^{nd}-stage SCI may be a SCI format 2-B. The SCI format 2-B may be used for the decoding of the PSSCH, with HARQ operation when HARQ-ACK information includes only NACK, or when there is no feedback of HARQ-ACK information. The SCI format 2-B may comprise a plurality of fields indicating the following information.
HARQ process number;
New data indicator;
Redundancy version;
Source ID of a transmitter (e.g., a transmitting wireless device) of the sidelink transmission;
Destination ID of a receiver (e.g., a receiving wireless device) of the sidelink transmission;
HARQ feedback enabled/disabled indicator;
Zone ID indicating a zone in which a transmitter (e.g., a transmitting wireless device) of the sidelink transmission is geographic located;
Communication range requirement indicating a communication range of the sidelink transmission.

FIG. 20 illustrates an example of resource indication for a first TB (e.g, a first data packet) and resource reservation for a second TB (e.g., a second data packet). SCI of an initial transmission (e.g., a first transmission) and/or retransmission of the first TB may comprise one or more first parameters (e.g., Frequency resource assignment and Time resource assignment) indicating one or more first time and frequency (T/F) resources for transmission and/or retransmission of the first TB. The SCI may further comprise one or more second parameters (e.g., Resource reservation period) indicating a reservation period/interval of one or more second T/F resources for initial transmission and/or retransmission of the second TB.

In an example, in response to triggering a resource selection procedure, a wireless device may select one or more first T/F resources for initial transmission and/or retransmission of a first TB. As shown in FIG. 20, the wireless device may select three resources for transmitting the first TB. The wireless device may transmit an initial transmission (initial Tx of a first TB in FIG. 20) of the first TB via a first resource of the three resources. The wireless device may transmit a first retransmission (1^{st} re-Tx in FIG. 20) of the first TB via a second resource of the three resources. The wireless device may transmit a second retransmission (2^{nd} re-Tx in FIG. 20) of the first TB via a third resource of the three resources. A time duration between a starting time of the initial transmission of the first TB and the second retransmission of the first TB may be smaller than or equal to 32 sidelink slots (e.g., T≤32 slots in FIG. 20). A first SCI may associate with the initial transmission of the first TB. The first SCI may indicate a first T/F resource indication for the initial transmission of the first TB, the first retransmission of the first TB and the second retransmission of the first TB. The first SCI may further indicate a reservation period/interval of resource reservation for a second TB. A second SCI may associate with the first retransmission of the first TB. The second SCI may indicate a second T/F resource indication for the first retransmission of the first TB and the second retransmission of the first TB. The second SCI may further indicate the reservation period/interval of resource reservation for the second TB. A third SCI may associate with the second retransmission of the first TB. The third SCI may indicate a third T/F resource indication for the second retransmission of the first TB. The third SCI may further indicate the reservation period/interval of resource reservation for the second TB.

FIG. 21 and FIG. 22 illustrate examples of configuration information for sidelink communication. In an example, a base station may transmit one or more radio resource control (RRC) messages to a wireless device for delivering the configuration information for the sidelink communication. The configuration information may comprise a field of sl-UE-SelectedConfigRP. A parameter sl-ThresPSSCH-RSRP-List in the field may indicate a list of 64 thresholds. In an example, a wireless device may receive first sidelink control information (SCI) indicating a first priority. The wireless device may have second SCI to be transmitted. The second SCI may indicate a second priority. The wireless device may select a threshold from the list based on the first priority in the first SCI and the second priority in the second SC. Referring to second exclusion in FIG. 26, the wireless device may exclude resources from candidate resource set based on the threshold. A parameter sl-MaxNumPerReserve in the field may indicate a maximum number of reserved PSCCH/PSSCH resources indicated in an SC. A parameter sl-MultiReserveResource in the field may indicate if it is allowed to reserve a sidelink resource for an initial transmission of a TB by an SCI associated with a different TB, based on sensing and resource selection procedure. A parameter sl-ResourceReservePeriodList may indicate a set of possible resource reservation periods/intervals (e.g., SL-ResourceReservedPeriod) allowed in a resource pool. Up to 16 values may be configured per resource pool. A parameter sl-RS-ForSensing may indicate whether DMRS of PSCCH or PSSCH is used for layer 1 (e.g., physical layer) RSRP measurement in sensing operation. A parameter sl-SensingWindow may indicate a start of a sensing window. A parameter sl-SelectionWindowList may indicate an end of a selection window in resource selection procedure for a TB with respect to priority indicated in SCI. Value n1 may correspond to 1*2μ, value n5 corresponds to 5*2μ, and so on, where μ=0, 1, 2, 3 for subcarrier spacing (SCS) of 15, 30, 60, and 120 kHz respectively. A parameter SL-SelectionWindowConfig may indicate a mapping between a sidelink priority (e.g., sl-Priority) and the end of the selection window (e.g., sl-SelectionWindow).

The configuration information may comprise a parameter sl-PreemptionEnable indicating whether sidelink pre-emption is disabled or enabled in a resource pool. For example, a priority level p_preemption may be configured if the sidelink pre-emption is enabled. For example, if the sidelink pre-emption is enabled but the p_preemption is not configured, the sidelink pre-emption may be applicable to all priority levels.

The configuration information may comprise a parameter sl-TxPercentageList indicating a portion of candidate single-slot PSSCH resources over total resources. For example, value p20 may correspond to 20%, and so on. A parameter SL-TxPercentageConfig may indicate a mapping between a sidelink priority (e.g., sl-Priority) and the portion of candidate single-slot PSSCH resources over total resources (e.g., sl-TxPercentage).

FIG. 23 illustrates an example format of a MAC subheader for sidelink shared channel (SL-SCH). The MAC subheader for SL-SCH may comprise seven header fields V/R/R/R/R/SCR/DST. The MAC subheader is octet aligned. For example, the V field may be a MAC protocol date units (PDU) format version number field indicating which version of the SL-SCH subheader is used. For example, the SRC field may carry 16 bits of a Source Layer-2 identifier (ID) field set to a first identifier provided by upper layers. For example, the DST field may carry 8 bits of the Destination Layer-2 ID set to a second identifier provided by upper layers. In an example, if the V field is set to “1”, the second identifier may be a unicast identifier. In an example, if the V field is set to “2”, the second identifier may be a groupcast identifier. In an example, if the V field is set to “3”, the second identifier may be a broadcast identifier. For example, the R field may indicate reserved bit.

FIG. 24 illustrates an example time of a resource selection procedure. A wireless device may perform the resource selection procedure to select resources for one or more sidelink transmissions. As shown in FIG. 24, a sensing window of the resource selection procedure may start at time (n−T0) (e.g., parameter sl-SensingWindow). The sensing window may end at time (n−T_{proc,0}). New data of the one or more sidelink transmissions may arrive at the wireless device at time (n−T_{proc,0}). The time period T_{proc,0} may be a processing delay of the wireless device to determine to trigger the resource selection procedure. The wireless device may determine to trigger the resource selection procedure at time n to select the resources for the new data arrived at time (n−T_{proc,0}). The wireless device may complete the resource selection procedure at time (n+T1). The wireless device may determine the parameter T1 based on a capability of the wireless device. The capability of the wireless device may be a processing delay of a processor of the wireless device. A selection window of the resource selection procedure may start at time (n+T1). The selection window may end at time (n+T2) indicating the ending of the selection window. The wireless device may determine the parameter T2 based on a parameter T2min (e.g., sl-SelectionWindow). In an example, the wireless device may determine the parameter T2 subject to T2min≤T2≤PDB, where the PDB (packet delay budget) may be the maximum allowable delay (e.g., a delay budget) for successfully transmitting the new data via the one or more sidelink transmissions. The wireless device may determine the parameter T2min to a corresponding value for a priority of the one or more sidelink transmissions (e.g., based on a parameter SL-SelectionWindowConfig indicating a mapping between a sidelink priority sl-Priority and the end of the selection window sl-SelectionWindow). In an example, the wireless device may set the parameter T2=PDB if the parameter T2min>PDB.

FIG. 25 illustrates an example timing of a resource selection procedure. A wireless device may perform the resource selection procedure for selecting resources for one or more sidelink transmissions. Referring to FIG. 24, a sensing window of initial selection may start at time (n−T0). The sensing window of initial selection may end at time (n−T_{proc,0}). New data of the one or more sidelink transmissions may arrive at the wireless device at the time (n−T_{proc,0}). The time period T_{proc,0} may be a processing delay for the wireless device to determine to trigger the initial selection of the resources. The wireless device may determine to trigger the initial selection at time n for selecting the resources for the new data arrived at the time (n−T_{proc,0}). The wireless device may complete the resource selection procedure at time (n+T1). The time (n+T_{proc,1}) may be the maximum allowable processing latency for completing the resource selection procedure being triggered at the time n, where 0<T1≤T_{proc,1}. A selection window of initial selection may start at time (n+T1). The selection window of initial selection may end at time (n+T2). The parameter T2 may be configured, preconfigured, or determined at the wireless device.

The wireless device may determine first resources (e.g., selected resources in FIG. 25) for the one or more sidelink transmissions based on the completion of the resource selection procedure at the time (n+T1). The wireless device may select the first resources from candidate resources in the selection window of initial selection based on measurements in the sensing window for initial selection. The wireless device may determine a resource collision between the first resources and other resources reserved by another wireless device. The wireless device may determine to drop the first resources for avoiding interference. The wireless device may trigger a resource reselection procedure (e.g., a second resource selection procedure) at time (m−T3) and/or before time (m−T3). The time period T3 may be a processing delay for the wireless device to complete the resource reselection procedure (e.g., a second resource selection procedure). The wireless device may determine second resources (e.g., reselected resource in FIG. 25) via the resource reselection procedure (e.g., a second resource selection procedure). The start time of the first resources may be time m (e.g., the first resources may be in slot m).

In an example, at least one of time parameters T0, T_{proc,0}, T_{proc,1}, T2, and PDB may be configured by a base station to the wireless device. In an example, the at least one of the time parameters T0, T_{proc,0}, T_{proc,1}, T2, and PDB may be preconfigured to the wireless device. The at least one of the time parameters T0, T_{proc,0}, T_{proc,1}, T2, and PDB may be stored in a memory of the wireless device. In an example, the memory may be a Subscriber Identity Module (SIM) card. In an example of FIG. 24 and FIG. 25, the time n, m, T0, T1, T_{proc,0}, T_{proc,1}, T2, T2min, T3, and PDB may be in terms of slots and/or slot index.

FIG. 26 illustrates an example flowchart of a resource selection procedure by a wireless device for transmitting a TB (e.g., a data packet) via sidelink.

FIG. 27 illustrates an example diagram of the resource selection procedure among layers of the wireless device.

Referring to FIG. 26 and FIG. 27, the wireless device may transmit one or more sidelink transmissions (e.g., a first transmission of the TB and one or more retransmissions of the TB) for the transmitting of the TB. Referring to FIG. 19, a sidelink transmission of the one or more sidelink transmission may comprise a PSCCH. The sidelink transmission may comprise a PSSCH. The sidelink transmission may comprise a PSFCH. The wireless device may trigger the resource selection procedure for the transmitting of the TB. The resource selection procedure may comprise two actions. The first action of the two actions may be a resource evaluation action. Physical layer (e.g., layer 1) of the wireless device may perform the first action. The physical layer may determine a subset of resources based on the first action and report the subset of resources to higher layer (e.g., RRC layer and/or MAC layer) of the wireless device. The second action of the two actions may be a resource selection action. The higher layer (e.g., RRC layer and/or MAC layer) of the wireless device may perform the second action based on the reported the subset of resources from the physical layer.

In an example, higher layer (e.g., RRC layer and/or MAC layer) of a wireless device may trigger a resource selection procedure for requesting the wireless device to determine a subset of resources. The higher layer may select resources from the subset of resources for PSSCH and/or PSCCH transmission. To trigger the resource selection procedure, e.g., in slot n, the higher layer may provide the following parameters for the PSSCH and/or PSCCH transmission:
a resource pool, from which the wireless device may determine the subset of resources;
layer 1 priority, prio_{Tx} (e.g., sl-Priority referring to FIG. 21 and FIG. 22), of the PSSCH/PSCCH transmission;
remaining packet delay budget (PDB) of the PSSCH and/or PSCCH transmission;
a number of sub-channels, L_{subCH}, for the PSSCH and/or PSCCH transmission in a slot;
a resource reservation period/interval, P_{rsvp_TX}, in units of millisecond (ms).

In an example, if the higher layer requests the wireless device to determine a subset of resources from which the higher layer will select the resources for the PSSCH and/or PSCCH transmission for re-evaluation and/or pre-emption, the higher layer may provide a set of resources (r₀, r₁, r₂, . . . ) which may be subject to the re-evaluation and a set of resources (r₀, r₁, r₂, . . . ) which may be subject to the pre-emption.

In an example, a base station (e.g., network) may transmit a message comprising one or more parameters to the wireless device for performing the resource selection procedure. The message may be an RRC/SIB message, a MAC CE, and/or a DCI. In an example, a second wireless device may transmit a message comprising one or more parameters to the wireless device for performing the resource selection procedure. The message may be an RRC message, a MAC CE, and/or a SCI. The one or more parameters may indicate following information.
sl-SelectionWindowList (e.g., sl-SelectionWindow referring to FIG. 21 and FIG. 22): an internal parameter T2min (e.g., T2min referring to FIG. 24) may be set to a corresponding value from the parameter sl-SelectionWindowList for a given value of prio_{TX} (e.g., based on SL-SelectionWindowConfig referring to FIG. 21 and FIG. 22).
sl-ThresPSSCH-RSRP-List (e.g., sl-ThresPSSCH-RSRP-List referring to FIG. 21 and FIG. 22): a parameter may indicate an RSRP threshold for each combination (pᵢ, pⱼ), where pᵢ is a value of a priority field in a received SCI format 1-A and pⱼ is a priority of a sidelink transmission (e.g., the PSSCH/PSCCH transmission) of the wireless device; In an example of the resource selection procedure, an invocation of pⱼ may be pⱼ=prio_{TX}.
sl-RS-ForSensing (e.g., sl-RS-ForSensing referring to FIG. 21 and FIG. 22): a parameter may indicate whether DMRS of a PSCCH or a PSSCH is used, by the wireless device, for layer 1 (e.g., physical layer) RSRP measurement in sensing operation.
sl-ResourceReservePeriodList (e.g., sl-ResourceReservePeriodList referring to FIG. 21 and FIG. 22)
sl-SensingWindow (e.g., sl-SensingWindow referring to FIG. 21 and FIG. 22): an internal parameter T₀ may be defined as a number of slots corresponding to t0_SensingWindow ms.
sl-TxPercentageList (e.g., based on SL-TxPercentageConfig referring to FIG. 21 and FIG. 22): an internal parameter X (e.g., sl-TxPercentage referring to FIG. 21 and FIG. 22) for a given prio_{Tx} (e.g., sl-Priority referring to FIG. 21 and FIG. 22) may be defined as sl-xPercentage(prio_{TX}) converted from percentage to ratio.
sl-PreemptionEnable (e.g., p_preemption referring to FIG. 21 and FIG. 22): an internal parameter prioₚᵣₑ may be set to a higher layer provided parameter sl-PreemptionEnable.

The resource reservation period/interval, P_{rsvp_TX}, if provided, may be converted from units of ms to units of logical slots, resulting in P_{rsvp_TX}.

Notation: (t₀^{SL}, t₁^{SL}, t₂^{SL}, . . . ) may denote a set of slots of a sidelink resource pool.

In the resource evaluation action (e.g., the first action in FIG. 26), the wireless device may determine a sensing window (e.g., the sensing window shown in FIG. 24 and FIG. 25 based on sl-SensingWindow) based on the triggering the resource selection procedure. The wireless device may determine a selection window (e.g., the selection window shown in FIG. 24 and FIG. 25 based on sl-SelectionWindowList) based on the triggering the resource selection procedure. The wireless device may determine one or more reservation periods/intervals (e.g., parameter sl-ResourceReservePeriodList) for resource reservation. In an example, a candidate single-slot resource for transmission R_{x,y} may be defined as a set of L_{subCH} contiguous sub-channels with sub-channel x+j in slot t_{y}^{SL} where j=0, . . . , L_{subCH}−1. The wireless device may assume that a set of L_{subCH} contiguous sub-channels in the resource pool within a time interval [n+T₁, n+T2] correspond to one candidate single-slot resource (e.g., referring to FIG. 24 and FIG. 25). A total number of candidate single-slot resources may be denoted by Mₜₒₜₐₗ. In an example, referring to FIG. 24 and FIG. 25, the sensing window may be defined by a number of slots in a time duration of [n−T₀, n−T_{proc,0}). The wireless device may monitor a first subset of the slots, of a sidelink resource pool, within the sensing window. The wireless device may not monitor a second subset of the slots than the first subset of the slots due to half duplex. The wireless device may perform the following actions based on PSCCH decoded and RSRP measured in the first subset of the slots. In an example, an internal parameter Th(pᵢ, pⱼ) may be set to the corresponding value of RSRP threshold indicated by the i-th field in sl-ThresPSSCH-RSRP-List, where i=pᵢ+(pⱼ−1)*8.

Referring to FIG. 26 and FIG. 27, in the resource evaluation action (e.g., the first action in FIG. 26), the wireless device may initialize a candidate resource set (e.g., a set S_{A}) to be a set of candidate resources. In an example, the candidate resource set may be the union of candidate resources within the selection window. In an example, a candidate resource may be a candidate single-subframe resource. In an example, a candidate resource may be a candidate single-slot resource. In an example, the set S_{A} may be initialized to a set of all candidate single-slot resources.

Referring to FIG. 26 and FIG. 27, in the resource evaluation action (e.g., the first action in FIG. 26), the wireless device may perform a first exclusion for excluding second resources from the candidate resource set based on first resources and one or more reservation periods/intervals. In an example, the wireless device may not monitor the first resources within a sensing window. In an example, the one or more reservation periods/intervals may be configured/associated with a resource pool of the second resources. In an example, the wireless device may determine the second resources within a selection window which might be reserved by a transmission transmitted via the first resources based on the one or more reservation periods/intervals. In an example, the wireless device may exclude a candidate single-slot resource R_{x,y} from the set S_{A} based on following conditions:
the wireless device has not monitored slot t 4 in the sensing window.
for any periodicity value allowed by the parameter sl-ResourceReservePeriodList and a hypothetical SCI format 1-A received in the slot t n^{L} with “Resource reservation period” field set to that periodicity value and indicating all sub-channels of the resource pool in this slot, condition c of a second exclusion would be met.

Referring to FIG. 26 and FIG. 27, in the resource evaluation action (e.g., the first action in FIG. 26), the wireless device may perform a second exclusion for excluding third resources from the candidate resource set. In an example, a SCI may indicate a resource reservation of the third resources. The SCI may further indicate a priority value (e.g., indicated by a higher layer parameter sl-Priority). The wireless device may exclude the third resources from the candidate resource set based on a reference signal received power (RSRP) of the third resources being higher than an RSRP threshold (e.g., indicated by a higher layer parameter sl-ThresPSSCH-RSRP-List). The RSRP threshold may be related to the priority value based on a mapping list of RSRP thresholds to priority values configured and/or pre-configured to the wireless device. In an example, a base station may transmit a message to the wireless device for configuring the mapping list. The message may be a radio resource control (RRC) message. In an example, the mapping list may be pre-configured to the wireless device. A memory of the wireless device may store the mapping list. In an example, a priority indicated by the priority value may be a layer 1 priority (e.g., physical layer priority). In an example, a bigger priority value may indicate a higher priority of a sidelink transmission. A smaller priority value may indicate a lower priority of the sidelink transmission. In another example, a bigger priority value may indicate a lower priority of a sidelink transmission. A smaller priority value may indicate a higher priority of the sidelink transmission. In an example, the wireless device may exclude a candidate single-slot resource R_{x,y} from the set S_{A} based on following conditions:
a) the wireless device receives an SCI format 1-A in slot tₘ^{SL}, and “Resource reservation period” field, if present, and “Priority” field in the received SCI format 1-A indicate the values P_{rsvp_RX} and prio_{RX};
b) the RSRP measurement performed, for the received SCI format 1-A, is higher than Th(prio_{RX}, prio_{TX});
c) the SCI format received in slot tₘ^{SL} or the same SCI format which, if and only if the “Resource reservation period” field is present in the received SCI format 1-A, is assumed to be received in slot(s) t_{m+q×P′}_{_{rsvp_RX}}^{SL} determines the set of resource blocks and slots which overlaps with R_{x,y+j×P′}_{_{rsvp_TX}} for q=1, 2, . . . , Q and j=0, 1, . . . , Cᵣₑₛₑₜ−1. Here, P′_{rsvp_RX} is P_{rsp_RX} converted to units of logical slots,

$$Q = ⌈ \frac{{T}_{scal}}{{P}_{rsvp \_ RX}} ⌉$$

if P_{rsvp_RX}<T_{scal} and n′−m≤P′_{rsvp_RX}, where t_{n′}^{SL}=n if slot n belongs to the set (t₀^{SL}, t₁^{SL}, . . . , t_{T}_{ₘₐₓ}^{SL}), otherwise slot t_{n′}^{SL} is the first slot after slot n belonging to the set (t₀^{SL}, t₁^{SL}, . . . , t_{T}_{ₘₐₓ}^{SL}); otherwise Q=1. T_{scal} is set to selection window size T2 converted to units of ms.

Referring to FIG. 26 and FIG. 27, in the resource evaluation action (e.g., the first action in FIG. 26), the wireless device may determine whether remaining candidate resources in the candidate resource set are sufficient for selecting resources for the one or more sidelink transmissions of the TB based on a condition, after performing the first exclusion and the second exclusion. In an example, the condition may be the total amount of the remaining candidate resources in the candidate resource set being more than X percent (e.g., indicated by a higher layer parameter sl-TxPercentageList) of the candidate resources in the candidate resource set before performing the first exclusion and the second exclusion. If the condition is not met, the wireless device may increase the RSRP threshold used to exclude the third resources with a value Y and iteratively re-perform the initialization, first exclusion, and second exclusion until the condition being met. In an example, if the number of remaining candidate single-slot resources in the set S_{A} is smaller than X·Mₜₒₜₐₗ, then Th(pᵢ, pⱼ) may be increased by 3 dB and the procedure continues with re-performing of the initialization, first exclusion, and second exclusion until the condition being met. In an example, the wireless device may report the set S_{A} (e.g., the remaining candidate resources of the candidate resource set) to the higher layer of the wireless device. In an example, the wireless device may report the set S_{A} (e.g., the remaining candidate resources of the candidate resource set when the condition is met) to the higher layer of the wireless device, based on that the number of remaining candidate single-slot resources in the set S_{A} being greater than or equal to X·Mₜₒₜₐₗ.

Referring to FIG. 26 and FIG. 27, in the resource selection action (e.g., the second action in FIG. 26), the wireless device (e.g., the higher layer of the wireless device) may select fourth resources from the remaining candidate resources of the candidate resource set (e.g., the set S_{A} reported by the physical layer) for the one or more sidelink transmissions of the TB. In an example, the wireless device may randomly select the fourth resources from the remaining candidate resources of the candidate resource set.

Referring to FIG. 26 and FIG. 27, in an example, if a resource rᵢ from the set (r₀, r₁, r₂, . . . ) is not a member of S_{A} (e.g., the remaining candidate resources of the candidate resource set when the condition is met), the wireless device may report re-evaluation of the resource rᵢ to the higher layers.

Referring to FIG. 26 and FIG. 27, in an example, if a resource r′ᵢ from the set (r₀, r₁, r₂, . . . ) meets the conditions below, then the wireless device may report pre-emption of the resource rᵢ to the higher layers.
r′ᵢ is not a member of S_{A}, and
r′ᵢ meets the conditions for the second exclusion, with Th(prio_{RX}, prio_{TX}) set to a final threshold for reaching X·Mₜₒₜₐₗ, and
the associated priority prio_{Rx}, satisfies one of the following conditions:
sl-PreemptionEnable is provided and is equal to ‘enabled’ and prio_{TX}>prio_{RX}
sl-PreemptionEnable is provided and is not equal to ‘enabled’, and prio_{RX}<prioₚᵣₑ and prio_{RX}>prio_{RX}

In an example, if the resource rᵢ is indicated for re-evaluation by the wireless device (e.g., the physical layer of the wireless device), the higher layer of the wireless device may remove the resource rᵢ from the set (r₀, r₁, r₂, . . . ). In an example, if the resource r′ᵢ is indicated for pre-emption by the wireless device (e.g., the physical layer of the wireless device), the higher layer of the wireless device may remove the resource r′ᵢ from the set (r₀, r₁, r₂, . . . ). The higher layer of the wireless device may randomly select new time and frequency resources from the remaining candidate resources of the candidate resource set (e.g., the set S_{A} reported by the physical layer) for the removed resources rᵢ and/or r′ᵢ. The higher layer of the wireless device may replace the removed resources rᵢ and/or r′ᵢ by the new time and frequency resources. For example, the wireless device may remove the resources rᵢ and/or r′ᵢ from the set (r₀, r₁, r₂, . . . ) and/or the set (r₀, r₁, r₂, . . . ) and add the new time and frequency resources to the set (r₀, r₁, r₂, . . . ) and/or the set (r₀, r₁, r₂, . . . ) based on the removing of the resources rᵢ and/or r′ᵢ.

Sidelink pre-emption may happen between a first wireless device and a second wireless device. The first wireless device may select first resources for a first sidelink transmission. The first sidelink transmission may have a first priority. The second wireless device may select second resources for a second sidelink transmission. The second sidelink transmission may have a second priority. The first resources may partially and/or fully overlap with the second resources. The first wireless device may determine a resource collision between the first resources and the second resources based on that the first resources and the second resources being partially and/or fully overlapped. The resource collision may imply fully and/or partially overlapping between the first resources and the second resources in time, frequency, code, power, and/or spatial domain. Referring to an example of FIG. 18, the first resources may comprise one or more first sidelink resource units in a sidelink resource pool. The second resources may comprise one or more second sidelink resource units in the sidelink resource pool. A partial resource collision between the first resources and the second resources may indicate that the at least one sidelink resource unit of the one or more first sidelink resource units belongs to the one or more second sidelink resource units. A full resource collision between the first resources and the second resources may indicate that the one or more first sidelink resource units may be the same as or a subset of the one or more second sidelink resource units. In an example, a bigger priority value may indicate a lower priority of a sidelink transmission. A smaller priority value may indicate a higher priority of the sidelink transmission. In an example, the first wireless device may determine the sidelink pre-emption based on the resource collision and the second priority being higher than the first priority. That is, the first wireless device may determine the sidelink pre-emption based on the resource collision and a value of the second priority being smaller than a value of the first priority. In another example, the first wireless device may determine the sidelink pre-emption based on the resource collision, the value of the second priority being smaller than a priority threshold, and the value of the second priority being smaller than the value of the first priority.

Referring to FIG. 25, a first wireless device may trigger a first resource selection procedure for selecting first resources (e.g., selected resources after resource selection with collision in FIG. 25) for a first sidelink transmission. A second wireless device may transmit an SCI indicating resource reservation of the first resource for a second sidelink transmission. The first wireless device may determine a resource collision on the first resources between the first sidelink transmission and the second sidelink transmission. The first wireless device may trigger a resource re-evaluation (e.g., a resource evaluation action of a second resource selection procedure) at and/or before time (m−T3) based on the resource collision. The first wireless device may trigger a resource reselection (e.g., a resource selection action of the second resource selection procedure) for selecting second resources (e.g., reselected resources after resource reselection in FIG. 25) based on the resource re-evaluation. The start time of the second resources may be time m.

A UE may receive one or more messages (e.g., RRC messages and/or SIB messages) comprising configuration parameters of a sidelink BWP. The configuration parameters may comprise a first parameter (e.g., sl-StartSymbol) indicating a sidelink starting symbol. The first parameter may indicate a starting symbol (e.g., symbol #0, symbol #1, symbol #2, symbol #3, symbol #4, symbol #5, symbol #6, symbol #7, etc.) used for sidelink in a slot. For example, the slot may not comprise a SL-SSB (S-SSB). In an example, the UE may be (pre-)configured with one or more values of the sidelink starting symbol per sidelink BWP. The configuration parameters may comprise a second parameter (e.g., sl-LengthSymbols) indicating number of symbols (e.g., 7 symbols, 8 symbols, 9 symbols, 10 symbols, 11 symbols, 12 symbols, 13 symbols, 14 symbols, etc.) used sidelink in a slot. For example, the slot may not comprise a SL-SSB (S-SSB). In an example, the UE may be (pre-)configured with one or more values of the sidelink number of symbols (symbol length) per sidelink BWP.

The configuration parameters of the sidelink BWP may indicate one or more sidelink (communication) resource pools of the sidelink BWP (e.g., via SL-BWP-PoolConfig and/or SL-BWP-PoolConfigCommon). A resource pool may be a sidelink receiving resource pool (e.g., indicated by sl-RxPool) on the configured sidelink BWP. For example, the receiving resource pool may be used for PSFCH transmission/reception, if configured. A resource pool may be a sidelink transmission resource pool (e.g., indicated by sl-TxPool, and/or sl-ResourcePool) on the configured sidelink BWP. For example, the transmission resource pool may comprise resources by which the UE is allowed to transmit NR sidelink communication (e.g., in exceptional conditions and/or based on network scheduling) on the configured BWP. For example, the transmission resource pool may be used for PSFCH transmission/reception, if configured.

Configuration parameters of a resource pool may indicate a size of a sub-channel of the resource pool (e.g., via sl-SubchannelSize) in unit of PRB. For example, the sub-channel size may indicate a minimum granularity in frequency domain for sensing and/or for PSSCH resource selection. Configuration parameters of a resource pool may indicate a lowest/starting RB index of a sub-channel with a lowest index in the resource pool with respect to lowest RB index RB index of the sidelink BWP (e.g., via sl-StartRB-Subchannel). Configuration parameters of a resource pool may indicate a number of sub-channels in the corresponding resource pool (e.g., via sl-NumSubchannel). For example, the sub-channels and/or the resource pool may consist of contiguous PRBs.

Configuration parameters of a resource pool may indicate configuration of one or more sidelink channels on/in the resource pool. For example, the configuration parameters may indicate that the resource pool is configured with PSSCH and/or PSCCH and/or PSFCH.

Configuration parameters of PSCCH may indicate a time resource for a PSCCH transmission in a slot. Configuration parameters of PSCCH (e.g., SL-PSCCH-Config) may indicate a number of symbols of PSCCH (e.g., 2 or 3) in the resource pool (e.g., via sl-TimeResourcePSCCH). Configuration parameters of PSCCH (e.g., SL-PSCCH-Config) may indicate a frequency resource for a PSCCH transmission in a corresponding resource pool (e.g., via sl-FreqResourcePSCCH). For example, the configuration parameters may indicate a number of PRBs for PSCCH in a resource pool, which may not be greater than a number of PRBs of a sub-channel of the resource pool (sub-channel size).

Configuration parameters of PSSCH may indicate one or more DMRS time domain patterns (e.g., PSSCH DMRS symbols in a slot) for the PSSCH that may be used in the resource pool.

A resource pool may or may not be configured with PSFCH. Configuration parameters of PSFCH may indicate a period for the PSFCH in unit/number of slots within the resource pool (e.g., via sl-PSFCH-Period). For example, a value 0 of the period may indicate that no resource for PSFCH is configured in the resource pool and/or HARQ feedback for (all) transmissions in the resource pool is disabled. For example, the period may be 1 slot or 2 slots or 4 slots, etc. Configuration parameters of PSFCH may indicate a set of PRBs that are (actually) used for PSFCH transmission and reception (e.g., via sl-PSFCH-RB-Set). For example, a bitmap may indicate the set of PRBs, wherein a leftmost bit of the bitmap may refer to a lowest RB index in the resource pool, and so on. Configuration parameters of PSFCH may indicate a minimum time gap between PSFCH and the associated PSSCH in unit of slots (e.g., via sl-MinTimeGapPSFCH). Configuration parameters of PSFCH may indicate a number of PSFCH resources available for multiplexing HARQ-ACK information in a PSFCH transmission (e.g., via sl-PSFCH-CandidateResourceType).

A UE may be configured by higher layers (e.g., by RRC configuration parameters) with one or more sidelink resource pools. A sidelink resource pool may be for transmission of PSSCH and/or for reception of PSSCH. A sidelink resource pool may be associated with sidelink resource allocation mode 1 and/or sidelink resource allocation mode 2. In the frequency domain, a sidelink resource pool consists of one or more (e.g., sl-NumSubchannel) contiguous sub-channels. A sub-channel consists of one or more (e.g., sl-SubchannelSize) contiguous PRBs. For example, higher layer parameters (e.g., RRC configuration parameters) may indicate a number of sub-channels in a sidelink resource pool (e.g., sl-NumSubchannel) and/or a number of PRBs per sub-channel (e.g., sl-SubchannelSize).

A set of slots that may belong to a sidelink resource pool. The set of slots may be denoted by (t₀^{SL}, t₁^{SL}, . . . , t_{T}_{ₘₐₓ}₋₁^{SL}) where 0≤tᵢ^{SL}<10240×2^{μ}, 0≤i<Tₘₐₓ. The slot index may be relative to slot #0 of the radio frame corresponding to SFN 0 of the serving cell or DFN 0. The set includes all the slots except N_{S_SSB} slots in which S-SS/PSBCH block (S-SSB) is configured. The set includes all the slots except N_{nonSL} slots in each of which at least one of Y-th, (Y+1)-th, . . . , (Y+X−1)-th OFDM symbols are not semi-statically configured as UL as per the higher layer parameter (e.g., tdd-UL-DL-ConfigurationCommon-r16 of the serving cell if provided and/or sl-TDD-Configuration-r16 if provided and/or sl-TDD-Config-r16 of the received PSBCH if provided). For example, a higher layer (e.g., MAC or RRC) parameter may indicate a value of Y as the sidelink starting symbol of a slot (e.g., sl-StartSymbol). For example, a higher layer (e.g., MAC or RRC) parameter may indicate a value of X as the number of sidelink symbols in a slot (e.g., sl-LengthSymbols). The set includes all the slots except one or more reserved slots. The slots in the set may be arranged in increasing order of slot index. The UE may determine the set of slot assigned to a sidelink resource pool based on a bitmap (b₀, b₁, . . . , b_{L}_{_{bitmap}}₋₁) associated with the resource pool where L_{bitmap} the length of the bitmap is configured by higher layers. A slot tₖ^{SL} (0≤k<10240×2^{μ}−N_{S}_{_{SSB}}−N_{nonSL}−N_{reserved}) may belong to the set of slots if b_{k′}=1 where k′=k mod L_{bitmap}. The slots in the set are re-indexed such that the subscripts i of the remaining slots t′ᵢ^{SL} are successive {0, 1, . . . , T′ₘₐₓ−1} where T′ₘₐₓ is the number of the slots remaining in the set.

The UE may determine the set of resource blocks assigned to a sidelink resource pool, wherein the resource pool consists of N_{PRB} PRBs. The sub-channel m for m=0, 1, . . . , numSubchannel−1 consists of a set of n_{subCHsize} contiguous resource blocks with the physical resource block number n_{PRB}=n_{subCHRBstart}+m·n_{subCHsize}+j for j=0, 1, . . . , n_{subCHsize}−1, where n_{subCHRBstart} and n_{subCHsize} are given by higher layer parameters sl-StartRB-Subchannel and sl-SubchannelSize, respectively. A UE may not be expected to use the last N_{PRB} mod n_{subCHsize} PRBs in the resource pool.

A UE may be provided/configured with a number of symbols in a resource pool for PSCCH (e.g., by sl-TimeResourcePSCCH). The PSCCH symbols may start from a second symbol that is available for sidelink transmissions in a slot. The UE may be provided/configured with a number of PRBs in the resource pool for PSCCH (e.g., by sl-FreqResourcePSCCH). The PSCCH PRBs may start from the lowest PRB of the lowest sub-channel of the associated PSSCH, e.g., for a PSCCH transmission with a SCI format 1-A. In an example, PSCCH resource/symbols may be configured in every slot of the resource pool. In an example, PSCCH resource/symbols may be configured in a subset of slot of the resource pool (e.g., based on a period comprising two or more slots).

In an example, each PSSCH transmission is associated with an PSCCH transmission. The PSCCH transmission may carry the 1^{st} stage of the SCI associated with the PSSCH transmission. The 2^{nd} stage of the associated SCI may be carried within the resource of the PSSCH. In an example, the UE transmits a first SCI (e.g., 1^{st} stage SCI, SCI format 1-A) on PSCCH according to a PSCCH resource configuration in slot n and PSCCH resource m. For the associated PSSCH transmission in the same slot, the UE may transmit one transport block (TB) with up to two layers (e.g., one layer or two layers). The number of layers (U) may be determined according to the ‘Number of DMRS port’ field in the SCI. The UE may determine the set of consecutive symbols within the slot for transmission of the PSSCH. The UE may determine the set of contiguous resource blocks for transmission of the PSSCH. Transform precoding may not be supported for PSSCH transmission. For example, wideband precoding may be supported for PSSCH transmission.

The UE may set the contents of the second SCI (e.g., 2^{nd} stage SCI, SCI format 2-A). The UE may set values of the SCI fields comprising the ‘HARQ process number’ field, the ‘NDI’ field, the ‘Source ID’ field, the ‘Destination ID’ field, the ‘HARQ feedback enabled/disabled indicator’ field, the ‘Cast type indicator’ field, and/or the ‘CSI request’ field, as indicated by higher (e.g., MAC and/or RRC) layers. The UE may set the contents of the second SCI (e.g., 2^{nd} stage SCI, SCI format 2-B). The UE may set values of the SCI fields comprising the ‘HARQ process number’ field, the ‘NDI’ field, the ‘Source ID’ field, the ‘Destination ID’ field, the ‘HARQ feedback enabled/disabled indicator’ field, the ‘Zone ID’ field, and/or the ‘Communication range requirement’ field, as indicated by higher (e.g., MAC and/or RRC) layers.

In an example, one transmission scheme may be defined for the PSSCH and may be used for all PSSCH transmissions. PSSCH transmission may be performed with up to two antenna ports, e.g., with antenna ports 1000-1001.

In sidelink resource allocation mode 1, for PSSCH and/or PSCCH transmission, dynamic grant, configured grant type 1 and/or configured grant type 2 may be supported. The configured grant Type 2 sidelink transmission is semi-persistently scheduled by a SL grant in a valid activation DCI.

The UE may transmit the PSSCH in the same slot as the associated PSCCH. The (minimum) resource allocation unit in the time domain may be a slot. The UE may transmit the PSSCH in consecutive symbols within the slot. The UE may not transmit PSSCH in symbols which are not configured for sidelink. A symbol may be configured for sidelink, according to higher layer parameters indicating the starting sidelink symbol (e.g., startSLsymbols) and a number of consecutive sidelink symbols (e.g., lengthSLsymbols). For example, startSLsymbols is the symbol index of the first symbol of lengthSLsymbols consecutive symbols configured for sidelink. Within the slot, PSSCH resource allocation may start at symbol startSLsymbols+1 (e.g., second sidelink symbol of the slot). The UE may not transmit PSSCH in symbols which are configured for use by PSFCH, if PSFCH is configured in this slot. The UE may not transmit PSSCH in the last symbol configured for sidelink (e.g., last sidelink symbol of the slot). The UE may not transmit PSSCH in the symbol immediately preceding the symbols which are configured for use by PSFCH, if PSFCH is configured in this slot. FIG. 19 shows an example of sidelink symbols and the PSSCH resource allocation within the slot.

A Sidelink grant may be received dynamically on the PDCCH, and/or configured semi-persistently by RRC, and/or autonomously selected by the MAC entity of the UE. The MAC entity may have a sidelink grant on an active SL BWP to determine a set of PSCCH duration(s) in which transmission of SCI occurs and a set of PSSCH duration(s) in which transmission of SL-SCH associated with the SCI occurs. A sidelink grant addressed to SLCS-RNTI with NDI=1 is considered as a dynamic sidelink grant. The UE may be configured with Sidelink resource allocation mode 1. The UE may for each PDCCH occasion and for each grant received for this PDCCH occasion (e.g., for the SL-RNTI or SLCS-RNTI of the UE), use the sidelink grant to determine PSCCH duration(s) and/or PSSCH duration(s) for initial transmission and/or one or more retransmission of a MAC PDU for a corresponding sidelink process (e.g., associated with a HARQ buffer and/or a HARQ process ID).

The UE may be configured with Sidelink resource allocation mode 2 to transmit using pool(s) of resources in a carrier, based on sensing or random selection. The MAC entity for each Sidelink process may select to create a selected sidelink grant corresponding to transmissions of multiple MAC PDUs, and SL data may be available in a logical channel. The UE may select a resource pool, e.g., based on a parameter enabling/disabling sidelink HARQ feedback. The UE may perform the TX resource (re-)selection check on the selected pool of resources. The UE may select the time and frequency resources for one transmission opportunity from the resources pool and/or from the resources indicated by the physical layer, according to the amount of selected frequency resources and the remaining PDB of SL data available in the logical channel(s) allowed on the carrier. The UE may use the selected resource to select a set of periodic resources spaced by the resource reservation interval for transmissions of PSCCH and PSSCH corresponding to the number of transmission opportunities of MAC PDUs. The UE may consider the first set of transmission opportunities as the initial transmission opportunities and the other set(s) of transmission opportunities as the retransmission opportunities. The UE may consider the sets of initial transmission opportunities and retransmission opportunities as the selected sidelink grant. The UE may consider the set as the selected sidelink grant. The UE may use the selected sidelink grant to determine the set of PSCCH durations and the set of PSSCH durations.

The UE may for each PSSCH duration and/or for each sidelink grant occurring in this PSSCH duration, select a MCS table allowed in the pool of resource which is associated with the sidelink grant. The UE may determine/set the resource reservation interval to a selected value (e.g., 0 or more). In an example, if the configured sidelink grant has been activated and this PSSCH duration corresponds to the first PSSCH transmission opportunity within this period of the configured sidelink grant, the UE may set the HARQ Process ID to the HARQ Process ID associated with this PSSCH duration and, if available, all subsequent PSSCH duration(s) occurring in this period for the configured sidelink grant. The UE may flush the HARQ buffer of Sidelink process associated with the HARQ Process ID. The UE may deliver the sidelink grant, the selected MCS, and the associated HARQ information to the Sidelink HARQ Entity for this PSSCH duration.

The MAC entity may include at most one Sidelink HARQ entity for transmission on SL-SCH, which maintains a number of parallel Sidelink processes. The (maximum) number of transmitting Sidelink processes associated with the Sidelink HARQ Entity may be a value (e.g., 16). A sidelink process may be configured for transmissions of multiple MAC PDUs. For transmissions of multiple MAC PDUs with Sidelink resource allocation mode 2, the (maximum) number of transmitting Sidelink processes associated with the Sidelink HARQ Entity may be a second value (e.g., 4). A delivered sidelink grant and its associated Sidelink transmission information may be associated with a Sidelink process. Each Sidelink process may support one TB.

For each sidelink grant and for the associated Sidelink process, the Sidelink HARQ Entity may obtain the MAC PDU to transmit from the Multiplexing and assembly entity, if any. The UE may determine Sidelink transmission information of the TB for the source and destination pair of the MAC PDU. The UE may set the Source Layer-1 ID to the 8 LSB of the Source Layer-2 ID of the MAC PDU, and set the Destination Layer-1 ID to the 16 LSB of the Destination Layer-2 ID of the MAC PDU. The UE may set the following information of the TB: cast type indicator, HARQ feedback enabler/disabler, priority, NDI, RV. The UE may deliver the MAC PDU, the sidelink grant and the Sidelink transmission information of the TB to the associated Sidelink process. The MAC entity of the UE may instruct the associated Sidelink process to trigger a new transmission or a retransmission.

In sidelink resource allocation mode 1, for sidelink dynamic grant, the PSSCH transmission may be scheduled by a DCI (e.g., DCI format 3_0). In sidelink resource allocation mode 1, for sidelink configured grant type 2, the configured grant may be activated by a DCI (e.g., DCI format 3_0). In sidelink resource allocation mode 1, for sidelink dynamic grant and sidelink configured grant type 2 the “Time gap” field value m of the DCI may provide an index m+1 into a slot offset table (e.g., the table may be configured by higher layer parameter sl-DCI-ToSL-Trans). The table value at index m+1 may be referred to as slot offset K_{SL}. The slot of the first sidelink transmission scheduled by the DCI may be the first SL slot of the corresponding resource pool that starts not earlier than T_{DL}−T_{TA}/2+K_{SL}×Tₛₗₒₜ, where T_{DL} is the starting time of the downlink slot carrying the corresponding DCI, T_{TA} is the timing advance value corresponding to the TAG of the serving cell on which the DCI is received and K_{SL} is the slot offset between the slot of the DCI and the first sidelink transmission scheduled by DCI and Tₛₗₒₜ is the SL slot duration. The “Configuration index” field of the DCI, if provided and not reserved, may indicate the index of the sidelink configured type 2. In sidelink resource allocation mode 1, for sidelink configured grant type 1, the slot of the first sidelink transmissions may follow the higher layer configuration.

The resource allocation unit in the frequency domain may be the sub-channel. The sub-channel assignment for sidelink transmission may be determined using the “Frequency resource assignment” field in the associated SCI. The lowest sub-channel for sidelink transmission may be the sub-channel on which the lowest PRB of the associated PSCCH is transmitted. For example, if a PSSCH scheduled by a PSCCH would overlap with resources containing the PSCCH, the resources corresponding to a union of the PSCCH that scheduled the PSSCH and associated PSCCH DM-RS may not be available for the PSSCH.

The redundancy version for transmitting a TB may be given by the “Redundancy version” field in the 2^{nd} stage SCI (e.g., SCI format 2-A or 2-B). The modulation and coding scheme I_{M}CS may be given by the ‘Modulation and coding scheme’ field in the 1^{st} stage SCI (e.g., SCI format 1-A). The UE may determine the MCS table based on the following: a pre-defined table may be used if no additional MCS table is configured by higher layer parameter sl-MCS-Table; otherwise an MCS table is determined based on the ‘MCS table indicator’ field in the 1^{st} stage SCI (e.g., SCI format 1-A). The UE may use I_{M}CS and the MCS table determined according to the previous step to determine the modulation order (Qₘ) and Target code rate (R) used in the physical sidelink shared channel.

The UE may determine the TB size (TBS) based on the number of REs (N_{RE}) within the slot. The UE may determine the number of REs allocated for PSSCH within a PRB (N′_{RE}) by N′_{RE}=N_{sc}^{RB}(N_{symb}^{sh}−N_{symb}^{PSFCH})−Nₒₕ^{PRB}−N_{RE}^{DMRS}, where N_{sc}^{RB}=12 is the number of subcarriers in a physical resource block; N_{symb}^{sh}=sl-LengthSymbols−2, where sl-LengthSymbols is the number of sidelink symbols within the slot provided by higher layers; N_{symb}^{PSFCH}=3 if ‘PSFCH overhead indication’ field of SCI format 1-A indicates “1”, and N_{symb}^{PSFCH}=0 otherwise, if higher layer parameter sl-PSFCH-Period is 2 or 4. If higher layer parameter sl-PSFCH-Period is 0, N_{symb}^{PSFCH}=0. If higher layer parameter sl-PSFCH-Period is 1, N_{symb}^{PSFCH}=3. Nₒₕ^{PRB} is the overhead given by higher layer parameter sl-X-Overhead. N_{RE}^{DMRS} is given by higher layer parameter sl-PSSCH-DMRS-TimePattern. The UE may determine the total number of REs allocated for PSSCH (N_{RE}) by N_{RE}=NR′_{RE}·n_{PRB}−N_{RE}^{SCI,1}−N_{RE}^{SCI,2} where n_{PRB} is the total number of allocated PRBs for the PSSCH; N_{RE}^{SCI,1} is the total number of REs occupied by the PSCCH and PSCCH DM-RS; N_{RE}^{SCI,2} is the number of coded modulation symbols generated for 2^{nd}-stage SCI transmission (prior to duplication for the 2^{nd} layer, if present). The UE may determine the TBS based on the total number of REs allocated for PSSCH (N_{RE}) and/or the modulation order (Qₘ) and Target code rate (R) used in the physical sidelink shared channel.

For the single codeword q=0 of a PSSCH, the block of bits b^{(q)}(0), . . . , b^{(q)}(M_{bit}^{(q)}−1), where M_{bit}^{(q)}=M_{bit,SCI2}^{(q)}+M_{bit,data}^{(q)} is the number of bits in codeword q transmitted on the physical channel, may be scrambled prior to modulation (e.g., using a scrambling sequence based on a CRC of the PSCCH associated with the PSSCH). For the single codeword q=0, the block of scrambled bits may be modulated, resulting in a block of complex-valued modulation symbols d^{(q)}(0), . . . , d^{(q)}(M_{symb}^{(q)}−1) where M_{symb}^{(q)}=M_{symb,1}^{(q)}+M_{symb,2}^{(q)}. Layer mapping may be done with the number of layers v∈{1,2}, resulting in x(i)=[x⁽⁰⁾(i) . . . x^{(v-1)}(i)]^{T}, i=0, 1, . . . , M_{symb}^{layer}−1. The block of vectors [x⁽⁰⁾(i) . . . x^{(v-1)}(i)]^{T} may be pre-coded where the precoding matrix W equals the identity matrix and M_{symb}^{ap}=M_{symb}^{layer}. For each of the antenna ports used for transmission of the PSSCH, the block of complex-valued symbols z^{(p)}(0), . . . , z^{(p)}(M_{symb}^{ap}−1) may be multiplied with the amplitude scaling factor β_{DMRS}^{PSSCH} in order to conform to the transmit power and mapped to resource elements (k′, l)_{p,μ} in the virtual resource blocks assigned for transmission, where k′=0 is the first subcarrier in the lowest-numbered virtual resource block assigned for transmission. The mapping operation may be done in two steps: first, the complex-valued symbols corresponding to the bit for the 2^{nd}-stage SCI in increasing order of first the index k′ over the assigned virtual resource blocks and then the index 1, starting from the first PSSCH symbol carrying an associated DM-RS, wherein the corresponding resource elements in the corresponding physical resource blocks are not used for transmission of the associated DM-RS, PT-RS, or PSCCH; secondly, the complex-valued modulation symbols not corresponding to the 2^{nd}-stage SCI shall be in increasing order of first the index k′ over the assigned virtual resource blocks, and then the index 1 with the starting position, wherein the resource elements are not used for 2^{nd}-stage SCI in the first step; and/or the corresponding resource elements in the corresponding physical resource blocks are not used for transmission of the associated DM-RS, PT-RS, CSI-RS, or PSCCH.

The resource elements used for the PSSCH in the first OFDM symbol in the mapping operation above, including DM-RS, PT-RS, and/or CSI-RS occurring in the first OFDM symbol, may be duplicated in the OFDM symbol immediately preceding the first OFDM symbol in the mapping (e.g., for AGC training purposes).

Virtual resource blocks may be mapped to physical resource blocks according to non-interleaved mapping. For non-interleaved VRB-to-PRB mapping, virtual resource block n is mapped to physical resource block n.

For a PSCCH, the block of bits b(0), . . . , b(M_{bit}−1), where M_{bit} is the number of bits transmitted on the physical channel, may be scrambled prior to modulation, resulting in a block of scrambled bits \tilde{b}(0), . . . , \tilde{b}(M_{bit}−1) according to \tilde{b}(i)=(b(i)+c(i)) mod 2. The block of scrambled bits \tilde{b}(0), . . . , \tilde{b}(M_{bit}−1) may be modulated using QPSK, resulting in a block of complex-valued modulation symbols d(0), . . . , d(M_{symb}−1) where M_{symb}−M_{bit}/2. The set of complex-valued modulation symbols d(0), . . . , d(M_{symb}−1) may be multiplied with the amplitude scaling factor β_{DMRS}^{PSCCH} in order to conform to the transmit power and mapped in sequence starting with d(0) to resource elements (k, l)_{p,μ} assigned for transmission, and not used for the demodulation reference signals associated with PSCCH, in increasing order of first the index k over the assigned physical resources, and then the index l on antenna port p (e.g., p=2000).

The resource elements used for the PSCCH in the first OFDM symbol in the mapping operation above, including DM-RS, PT-RS, and/or CSI-RS occurring in the first OFDM symbol, may be duplicated in the immediately preceding OFDM symbol (e.g., for AGC training purposes).

For sidelink resource allocation mode 1, a UE upon detection of a first SCI (e.g., SCI format 1-A) on PSCCH may decode PSSCH according to the detected second SCI (e.g., SCI formats 2-A and/or 2-B), and associated PSSCH resource configuration configured by higher layers. The UE may not be required to decode more than one PSCCH at each PSCCH resource candidate. For sidelink resource allocation mode 2, a UE upon detection of a first SCI (e.g., SCI format 1-A) on PSCCH may decode PSSCH according to the detected second SCI (e.g., SCI formats 2-A and/or 2-B), and associated PSSCH resource configuration configured by higher layers. The UE may not be required to decode more than one PSCCH at each PSCCH resource candidate. A UE may be required to decode neither the corresponding second SCI (e.g., SCI formats 2-A and/or 2-B) nor the PSSCH associated with a first SCI (e.g., SCI format 1-A) if the first SCI indicates an MCS table that the UE does not support.

Throughout this disclosure, a (sub)set of symbols of a slot, associated with a resource pool of a sidelink BWP, that is (pre-)configured for sidelink communication (e.g., transmission and/or reception) may be referred to as ‘sidelink symbols’ of the slot. The sidelink symbols may be contiguous/consecutive symbols of a slot. The sidelink symbols may start from a sidelink starting symbol (e.g., indicated by an RRC parameter), e.g., sidelink starting symbol may be symbol #0 or symbol #1, and so on. The sidelink symbols may comprise one or more symbols of the slot, wherein a parameter (e.g., indicated by RRC) may indicate the number of sidelink symbols of the slot. The sidelink symbols may comprise one or more guard symbols, e.g., to provide a time gap for the UE to switch from a transmission mode to a reception mode. For example, the OFDM symbol immediately following the last symbol used for PSSCH, PSFCH, and/or S-SSB may serve as a guard symbol. As shown in FIG. 19, the sidelink symbols may comprise one or more PSCCH resources/occasions and/or one or more PSCCH resources and/or zero or more PSFCH resources/occasions. The sidelink symbols may comprise one or more AGC symbols.

An AGC symbol may comprise duplication of (content of) the resource elements of the immediately succeeding/following symbol (e.g., a TB and/or SCI may be mapped to the immediately succeeding symbol). In an example, the AGC symbol may be a dummy OFDM symbol. In an example, the AGC symbol may comprise a reference signal. For example, the first OFDM symbol of a PSSCH and its associated PSCCH may be duplicated (e.g., in the AGC symbol that is immediately before the first OFDM symbol of the PSSCH). For example, the first OFDM symbol of a PSFCH may be duplicated (e.g., for AGC training purposes).

In a sidelink slot structure configuration, the first symbol is used for automatic gain control (AGC) and the last symbol is used for a gap. During an AGC symbol, a receiving and/or sensing UE may perform AGC training. For AGC training, a UE detects the energy/power of a signal in the channel during the AGC symbol and applies a hardware gain to maximize the signal amplitude to the dynamic range of the analog to digital convertor (ADC) at the receiver. The receiver may determine a gain for a received signal, and an AGC duration allows time for the receiver to determine the gain and apply the gain (e.g., hardware gain component) such that when the receiver receives the data (e.g., in the next symbol(s)), the gain of the amplifier has already been adjusted.

For sidelink communication, the transmitter UE may not map data/control information to the AGC symbol. The AGC symbol may not be used for communication and sending information other than energy. The AGC symbol may be a last symbol prior to an earliest symbol of a transmission, such that a gap between AGC symbol and signal/channel transmission is minimized and an accurate gain is determined for receiving the following signal/channel. For example, the AGC symbol, as shown in FIG. 19, maybe a symbol immediately preceding the first/earliest symbol of a resource used for a transmission via a channel (e.g., PSCCH and/or PSSCH and/or PSFCH transmission).

In an example, the AGC symbol may comprise duplication of resource elements of the next (immediately following) OFDM symbol. In an example, the AGC symbol may comprise any signal, e.g., a per-defined signal/sequence and/or dummy information. The purpose of the AGC symbol is to allow the receiver UE to perform AGC training and adjust the hardware gain for a most efficient reception of the following signal.

The amount of data traffic carried over cellular networks is expected to increase for many years to come. The number of users/devices is increasing, and each user/device accesses an increasing number and variety of services, e.g., video delivery, large files, images. This requires not only high capacity in the network, but also provisioning of very high data rates to meet customer expectations on interactivity and responsiveness. More spectrum is therefore needed for cellular operators to meet the increasing demand. Considering user expectations of high data rates along with seamless mobility, it is beneficial that more spectrum be made available for deploying macro cells as well as small cells for cellular systems.

Striving to meet the market demands, there has been increasing interest from operators in deploying some complementary access utilizing unlicensed spectrum to meet the traffic growth. This is exemplified by the large number of operator-deployed Wi-Fi networks and the 3GPP standardization of interworking solutions with Wi-Fi, e.g., LTE/WLAN interworking. This interest indicates that unlicensed spectrum, when present, may be an effective complement to licensed spectrum for cellular operators to address the traffic explosion in some scenarios, such as hotspot areas. For example, licensed assisted access (LAA) and/or new radio on unlicensed band(s) (NR-U) may offer an alternative for operators to make use of unlicensed spectrum while managing one radio network, thus offering new possibilities for optimizing the network's efficiency.

Similar to the LAA feature introduced in LTE, the NR-U (e.g., in Rel-16 and Rel-17), the motivation and primary use of unlicensed spectrum is to expand 3GPP technologies into more vertical domains to support wider applications, enabling new services and creating more wireless product types. By not restricting to always rely on operator licensed carriers or dedicated carriers for V2X/D2D or Public Safety, which may not be always available depending on network deployment and availability, if devices are able to communicate directly with each other or sending out messages/signals on a frequency spectrum that is always readily available, this can be used to create exciting new services, applications and even saving lives in disaster areas (e.g. recent devastating flooding events in the US and China).

For example, sidelink in unlicensed spectrum, or a.k.a. SL-U, may be used in following applications and/or services. For example, for applications such as augmented reality (AR)/virtual reality (VR) interactive and gaming services, which often demands very low latency and high data rate communication over sidelink directly between devices. In another example, SL over unlicensed is also ideal for smart home applications, where tens of low-cost devices connecting to a central node like a customer premise equipment (CPE) within a home network to gain access to internet or just directly communicating with each other to share contents such as movies, videos, music, etc. When there are hundreds or thousands of these devices located within a cell area, it is not expected that all of these devices are to be connected to the mobile network and/or need to have the capability of supporting the Uu interface. Therefore, in order to enable these types of applications and expanding the usage of sidelink, the making use of unlicensed bands is the only choice. For wearable devices such as smart watches, bands, etc., it is already common not to have the capability to connect to a mobile network. In this case, unlicensed spectrum and sidelink connection to a smartphone is the only way for gaining access to the Internet. In another example, out of coverage network areas, such as disaster zones, rural sites, mines, deep basements, coast lines, or dangerous areas where unmanned vehicles, robots or UAVs needs to gain access into, unlicensed spectrum and NR sidelink communication is an ideal combination. In another example, IIoT/smart factory application is equally able to take an advantage of sidelink communication utilizing unlicensed spectrum. For traffic offloading from the Uu interface to sidelink in unlicensed band in a factory setting where not all communication data needs to go through a base station. Especially for coordination data messages between factory/warehouse moving equipment such that they don't collide with each other or to perform a synchronized movement between wheels. When the factory/warehouse is operating NR-U, the sidelink operation in the licensed spectrum can be dynamically control by the gNB as well. In another example, even for the cellular V2X (C-V2X) application, the current allocation of ITS spectrum in 5.9 GHz band dedicated for V2X communication only has very limited spectrum bandwidth. In some regions, total of 30 MHz while others have at most 40 MHz of bandwidth is allocated. This allocated bandwidth is to be shared at least between LTE and NR V2X. It is a well-known problem that this limited bandwidth allocation will not be able to support high data rate applications such as extended sensor data sharing and fully autonomous driving. With the local/regional regulators to increase the ITS bandwidth or designating additional spectrum for C-V2X, utilizing unlicensed spectrum is a viable option via SL carrier aggregation, where a vehicle UE transmits its essential/safety message data on the ITS band and the high data rate imaging over the unlicensed spectrum.

Increased sidelink data rate is motivated by applications such as sensor information (video) sharing between vehicles with high degree of driving automation. Commercial use cases could require data rates in excess of what is currently possible. Increased data rate can be achieved with the support of sidelink carrier aggregation and/or sidelink over unlicensed spectrum. Furthermore, by enhancing the FR2 sidelink operation, increased data rate can be more efficiently supported on FR2. While the support of new carrier frequencies and larger bandwidths would also allow to improve its data rate, the main benefit would come from making sidelink more applicable for a wider range of applications. More specifically, with the support of unlicensed spectrum and the enhancement in FR2, sidelink will be in a better position to be implemented in commercial devices since utilization of the ITS band is limited to ITS safety related applications.

Sidelink communication(s), e.g., in FIG. 17, may use radio resource(s) in an unlicensed band. For example, a sidelink BWP may be (pre-)configured in an unlicensed band/carrier. For example, a sidelink resource pool of the sidelink BWP may be (pre-)configured in an unlicensed band. For example, a base station may configure the sidelink BWP and/or the sidelink resource pool of the sidelink BWP in an unlicensed band. A first communication (e.g., UL and/or DL transmission) between a first device (e.g., a base station) and a second device (e.g., a first wireless device) via Uu interface and a second communication (e.g., sidelink transmission) between the second device (e.g., the first wireless device) and a third device (e.g., a second wireless device) via a sidelink may be performed in a same band or in different spectrum bands. For example, a wireless device may receive, from the base station, configuration parameters of communications via Uu interface and configuration parameters of communications via a sidelink. The configuration parameters may indicate that communications via Uu interface and via a sidelink are configured/scheduled in a same unlicensed band. The configuration parameters may indicate that communications via Uu interface and via a sidelink are configured/scheduled in different unlicensed bands. The configuration parameters may indicate that communications via Uu interface are configured/scheduled in a licensed band, while the communications via a sidelink are configured/scheduled in an unlicensed band. The configuration parameters may indicate that communications via Uu interface are configured/scheduled in an unlicensed band, while the communications via a sidelink are configured/scheduled in a licensed band.

In an example embodiment, Listen-before-talk (LBT) may be required for transmission in an unlicensed/shared band. A cell configured in unlicensed/shared cell may be referred to as an unlicensed/shared cell. The unlicensed/shared cell may be referred to as a LAA cell and/or a NR-U cell. The unlicensed/shared cell may be operated as non-standalone with an anchor cell in a licensed band or standalone without an anchor cell in a licensed band. LBT may comprise a clear channel assessment (CCA). For example, a carrier that is configured in the unlicensed/shared cell may be referred to as an unlicensed carrier. The base station may configure a cell on the carrier. For example, the unlicensed/shared cell may be configured on the unlicensed carrier.

For example, in an LBT procedure, equipment may apply a CCA before using the unlicensed/shared cell or channel. The CCA may comprise an energy detection (ED) that determines the presence of other signals on a channel (e.g., channel is occupied) or absence of other signals on a channel (e.g., channel is clear). A regulation of a country may impact the LBT procedure. For example, European and Japanese regulations mandate the usage of LBT in the unlicensed/shared bands, such as the 5 GHz unlicensed/shared band. Apart from regulatory requirements, carrier sensing via LBT may be one way for fairly sharing the unlicensed/shared spectrum among different devices and/or networks attempting to utilize the unlicensed/shared spectrum.

In an example embodiment, discontinuous transmission on an unlicensed/shared band with limited maximum transmission duration may be enabled. Some of these functions may be supported by one or more signals to be transmitted from the beginning of a discontinuous downlink transmission and/or a sidelink transmission in the unlicensed/shared band. Channel reservation may be enabled by the transmission of signals, after or in response to gaining channel access based on a successful LBT operation. Other nodes may receive the signals (e.g., transmitted for the channel reservation) with an energy level above a certain threshold that may sense the channel to be occupied. Functions that may need to be supported by one or more signals for operation in unlicensed/shared band with the discontinuous downlink transmission and/or sidelink transmission may comprise one or more of the following: detection of the downlink transmission and/or sidelink transmission in unlicensed/shared band (comprising cell identification) by wireless devices; time & frequency synchronization of wireless devices.

In an example embodiment, downlink/uplink and/or sidelink transmission and frame structure design for operation in an unlicensed/shared band may employ subframe, slot, mini-slot, and/or symbol boundary alignment according to timing relationships, e.g., across serving cells (e.g., configured on one or more carriers) aggregated by carrier aggregation. This may not imply that base station transmissions start at the subframe, (mini-)slot, and/or symbol boundary. The operation via the unlicensed/shared band may support transmitting PDCCH, PDSCH, PSBCH, PSCCH, PSSCH, and/or PSFCH, for example, when not all OFDM symbols are available for transmission in a slot according to LBT.

An LBT procedure may be employed for fair and friendly coexistence of a 3GPP system (e.g., LTE and/or NR) with other operators and/or radio access technologies (RATs), e.g., WiFi, and/or the like, operating in unlicensed/shared band. For example, a node attempting to transmit on a carrier in unlicensed/shared band may perform a CCA as a part of an LBT procedure to determine if a channel is free (e.g., idle) for use. For example, the channel may be confined within a range of frequency. For example, a regulation of a country may indicate the range of frequency that requires the LBT procedure to use the channel in the unlicensed/shared bands. For example, the channel may be 20 MHz or a multiple of 20 MHz. The channel may be referred to as an LBT band, a subband, and/or the like. The LBT procedure may comprise an ED performed by the node to determine if the channel is being free (e.g., idle) or used (e.g., occupied) for use. The wireless device may perform the ED for the range of frequency comprising the channel. For example, regulatory requirements in some regions, e.g., in Europe, specify an ED threshold such that if a node measures, detects, and/or receives energy greater than the ED threshold, the node determines that the channel is being used/occupied, e.g., by another node(s) (and/or is not free or idle for use/access). While nodes may follow such regulatory requirements, a node may optionally use a lower ED threshold for ED than that specified by regulatory requirements. A radio access technology (e.g., WiFi, LTE and/or NR) may employ a mechanism to adaptively change the ED threshold. For example, NR-U may employ a mechanism to adaptively lower the ED threshold from an upper bound. An adaptation mechanism may not preclude static or semi-static setting of the ED threshold. In an example, Category 4 LBT (CAT4 LBT) mechanism or other type of LBT mechanisms may be implemented.

In an example, if the detected energy during a CCA (e.g., initial CCA) period is lower than an ED threshold, the device may access the channel for a period referred to as Channel Occupancy Time (COT). Otherwise, the device may start an extended CCA period, in which the detected energy is again compared against the ED threshold until channel access is granted. The regulation may specify the CCA slot duration (e.g., 9 μs in the 5 GHz band, and 5 μs in the 60 GHz band), the initial and extended CCA check times (e.g., a multiple of 5 μs for initial CCA and 8+m×5 μs for extended CCA in the 60 GHz band, where m controls the backoff), and the ED threshold (e.g., −72 dBm for a 20 MHz channel bandwidth in the 5 GHz band, and −47 dBm for 40 dBm of radiated power in the 60 GHz band).

In an example, a LBT failure of a LBT procedure on the channel in an unlicensed band may indicate a channel access failure on the channel. For example, a LBT failure of a LBT procedure on the channel may indicate that the channel is not idle or is busy (e.g., occupied by another device(s)) during one or more sensing slot durations (e.g., CCA periods) before a transmission via the channel (e.g., or immediately before the transmission via the channel). In an example, a LBT success of a LBT procedure on the channel may indicate a channel access success of the channel. In an example, a LBT success of a LBT procedure on the channel may indicate that the channel is idle during one or more sensing slot durations (e.g., CCA periods) before a transmission via the channels (e.g., or immediately before the transmission via channels).

Various example LBT mechanisms may be implemented. In an example, for some signals, in some implementation scenarios, in some situations, and/or in some frequencies no LBT procedure may be performed by the transmitting entity. An LBT procedure referred in example embodiment(s) may comprise Category 1 LBT, Category 2 LBT, Category 3 LBT, and/or Category 4 LBT. A type of an LBT (e.g., Category 1 LBT, Category 2 LBT, Category 3 LBT, and/or Category 4 LBT) may be indicated

In an example, Category 1 (CAT1 LBT, e.g., no LBT) may be implemented in one or more cases. For example, a channel in unlicensed/shared band may be hold by a first device (e.g., for uplink, downlink, and/or sidelink transmissions). The first device may share the channel with a second device. For example, a second device may take over the channel in unlicensed/shared band for uplink, downlink, and/or sidelink transmissions, e.g., of a control signal (e.g., HARQ feedback of the uplink, downlink, and/or the sidelink transmissions) without performing the CAT1 LBT.

In an example, Category 2 (CAT2 LBT that may be referred to as one-shot LBT and/or a short LBT) may be implemented. The Category 2 may be an LBT without random back-off. The duration of time determining that the channel is idle may be deterministic (e.g., by a regulation). A transmitting device (e.g., a base station in Uu interface, a wireless device in Uu interface, and/or a transmitting device in a sidelink communication) may transmit a grant (e.g., uplink grant and/or a sidelink grant) indicating a type of LBT (e.g., CAT2 LBT) to a receiving device (e.g., a base station in Uu interface, a wireless device in Uu interface, and/or a receiving device in a sidelink communication).

In an example, Category 3 (CAT3, e.g. LBT with random back-off with a contention window of fixed size) may be implemented. The LBT procedure may have the following procedure as one of its components. The transmitting device may draw a random number N within a contention window. The size of the contention window may be specified by the minimum and maximum value of N. The size of the contention window may be fixed. The random number N may be employed in the LBT procedure to determine the duration of time that the channel is sensed to be idle before the transmitting device transmits on the channel.

In an example, Category 4 (CAT4, e.g. LBT with random back-off with a contention window of variable size) may be implemented. The transmitting device may draw a random number N within a contention window. The size of contention window may be specified by the minimum and maximum value of N. The transmitting device may vary the size of the contention window when drawing the random number N. The random number N may be used in the LBT procedure to determine the duration of time that the channel is sensed to be idle before the transmitting device transmits on the channel.

In an example, a transmission burst(s) may comprise a continuous (unicast, multicast, broadcast, and/or combination thereof) transmission on a carrier component (CC). A first transmission burst(s) may be a continuous transmission from a first device (e.g., a base station in Uu interface, a wireless device in Uu interface, and/or a transmitting device in a sidelink communication) to a second device (e.g., a base station in Uu interface, a wireless device in Uu interface, and/or a receiving device in a sidelink communication) on the channel of the CC in an unlicensed/shared band. A second transmission burst(s) may be a continuous transmission from the second device (e.g., a base station in Uu interface, a wireless device in Uu interface, and/or a transmitting device in a sidelink communication) to the first device (e.g., a base station in Uu interface, a wireless device in Uu interface, and/or a receiving device in a sidelink communication) on the channel of the CC in the unlicensed/shared band. In an example, the first transmission burst(s) and the second transmission burst(s) on the channel in the unlicensed/shared band may be scheduled in a TDM manner over the same unlicensed/shared band. Switching between the first transmission burst and the second transmission burst(s) may require an LBT (e.g., CAT1 LBT, CAT2 LBT, CAT3 LBT, and/or CAT4 LBT). For example, an instant in time may be part of the first transmission burst or the second transmission burst.

COT sharing may comprise a mechanism by which one or more devices share a channel, in an unlicensed/shared band, that is sensed as idle by at least one of the one or more devices. For example, one or more first devices may occupy the channel via an LBT (e.g., the channel is sensed as idle based on CAT4 LBT) and one or more second devices may use and/or share, for a transmission of the one or more second devices, the channel using a particular type of an LBT within a maximum COT (MCOT) limit.

In an example, various of LBT types may be employed for Channel occupancy time (COT) sharing. A transmitting device (e.g., a base station in Uu interface, a wireless device in Uu interface, and/or a transmitting device in a sidelink communication) may transmit a grant (e.g., uplink grant and/or a sidelink grant) to a receiving device (e.g., a base station in Uu interface, a wireless device in Uu interface, and/or a receiving device in a sidelink communication). For example, the grant (e.g., uplink grant and/or a sidelink grant) may indicate a trigger of the COT sharing and/or a type of LBT (e.g., CAT1 LBT, CAT2 LBT, CAT2 LBT, and/or CAT2 LBT) to be used for the receiving device during the COT acquired and/or shared by the transmitting device.

In an example, a regulation of certain region(s), e.g., Europe and Japan may prohibit continuous transmission in the unlicensed band and may impose limits on the COT, e.g., the maximum continuous time a device may use the channel. The maximum continuous time in which the device gains an access based on LBT procedure and uses the channel may be referred to as a maximum channel occupancy time (MCOT). The MCOT in the 5 GHz band may be limited to a certain period, e.g., 2 ms, 4 ms, or 6 ms, depending on the channel access priority class, and it may be increased up to 8-10 ms.

The MCOT in the 60 GHz band may be 9 ms. For example, the regulation (e.g., for the 5 GHz and 60 GHz bands) may allow the device (e.g., a wireless device of a Uu interface and/or a transmitting wireless device in a sidelink communication) to share the COT with the associated devices. For example, the associated device may be a wireless device and/or a base station in the Uu interface. For example, the associated device may be a wireless device of the sidelink (e.g., unicast, multicast, and/or broadcast) communication. For example, the device may get an (e.g., initial) access to the channel through the LBT procedure, e.g., for COT (or MCOT). The device may transmit, to the associated device, a control message and/or a control signal indicating sharing the COT (or MCOT) with the associated device and/or remaining time of the COT, and starting/ending times (e.g., in terms of symbol(s), slot(s), SFN(s), and/or a combination thereof) of the COT that the associated device to use/share the channel. The associated device may skip (e.g., may not perform) the CCA check and/or may perform Category 1 LBT procedure on the channel during the shared COT. The associated wireless device may transmit data via the channel during the shared COT based on a particular LBT type. The particular LBT type may comprise Category 1, Category 2, Category 3, and/or Category 4. For example, the MCOT may be defined and/or configured per priority class, logical channel priority, and/or device specific.

In an example, a first device may gain an access through the LBT procedure for a first (e.g., UL, DL, and/or sidelink) transmission in an unlicensed band. If the first device shares, with a second device, the channel, the second device may perform a second (e.g., UL, DL, and/or sidelink) transmission with a dynamic grant and/or a configured grant (e.g., Type 1 and/or Type2) with a particular LBT (e.g., CAT2 LBT) that the second device performs on a channel shared by a first device. The second device may use and/or occupy, e.g., by performing UL, DL, and/or sidelink transmission, the channel during the COT. For example, the first device performing the first transmission based on a configured grant (e.g., Type 1, Type2, autonomous UL) may transmit a control information (e.g., DCI, UCI, SCI, and/or MAC CE) indicating the COT sharing. The COT sharing may comprise switching, within a (M)COT, from the first transmission (e.g., UL, DL, and/or sidelink transmission) of the first device to the second transmission (e.g., UL, DL, and/or sidelink transmission) of the second device. A starting time of the second transmission in the COT sharing, e.g., triggered by the first device, may be indicated in one or more ways. For example, one or more parameters in the control information may indicate the starting time of the COT sharing at which the second device starts to access the channel and/or an ending time of the COT sharing at which the second device terminates/ends to use the channel. For example, resource configuration(s) of configured grant(s) may indicate the starting time and/or the ending time.

In an example, single and/or multiple switching of transmissions within a shared COT may be supported. For example, a switching of transmissions within the shared COT may comprise switching from the first transmission (e.g., UL, DL, and/or sidelink transmission) of the first device to the second transmission (e.g., UL, DL, and/or sidelink transmission) of the second device within the shared COT. A type of LBT required/performed, by the second device, for the second transmission may be different depending on a time gap between the first transmission and the second transmission. The time gap may be referred to as a COT gap. For example, the second wireless device may perform CAT1 LBT (e.g., may not perform or may skip LBT procedure) for the second transmission switched from the first transmission within the shared COT, e.g., if the time gap is less than a first time value, e.g., 16 us. For example, the second wireless device may perform CAT2 LBT for the second transmission switched from the first transmission within the shared COT, e.g., if the time gap is longer than the first time value and does not exceed a second time value, e.g., 25 us. For example, the second wireless device may perform CAT2 LBT for the second transmission switched from the first transmission within the shared COT, e.g., if the time gap exceeds the second time value. For example, the second wireless device may perform CAT4 LBT for the second transmission switched from the first transmission within the shared COT, e.g., if the time gap exceeds the second time value.

A sidelink resource of a sidelink communication may be configured in an unlicensed band. For example, a first wireless device may perform, during a period in one or more symbols, an LBT procedure on a channel comprising a sidelink resource (e.g., comprising PSBCH, PSCCH, PSSCH, and/or PSFCH) via which the first wireless device schedules (or is scheduled) to transmit a data and/or a signal to a second wireless device. For example, the LBT procedure may start during a first symbol that is at least one symbol or a certain period (e.g., in terms of p or ms) before and/or prior to a starting symbol of the sidelink resource (and/or a starting symbol of the transmission of the data and/or the signal). For example, the LBT procedure may end before and/or prior to the starting symbol of the sidelink resource (and/or the starting symbol of the transmission of the data and/or the signal). The wireless device may not transmit, via the sidelink resource (e.g., comprising PSBCH, PSCCH, PSSCH, and/or PSFCH), the data and/or the signal to the second wireless device, e.g., in response to the LBT procedure indicating the channel is busy. The wireless device may transmit, via the sidelink resource (e.g., comprising PSBCH, PSCCH, PSSCH, and/or PSFCH), the data and/or the signal to the second wireless device, e.g., in response to the LBT procedure indicating the channel is idle.

For example, the first wireless device may determine an AGC symbol located before or prior to a starting symbol of the PSBCH, PSCCH, PSSCH, and/or PSFCH via which the first wireless device schedules (or is scheduled) to transmit the data and/or the signal to the second wireless device. For example, the AGC symbol may be located one symbol before the starting symbol of sidelink resource (e.g., PSBCH, PSCCH, PSSCH, and/or PSFCH). Referring to FIG. 19, the AGC symbol is the second symbol in the slot (e.g., one symbol before a starting symbol (e.g., the third symbol in the slot) of a PSCCH (in the third, fourth and the fifth symbols in a subchannel in the slot) and/or a starting symbol (e.g., the third symbol in the slot) of PSSCH (e.g., from the third symbol to the eighth symbol in the slot), and/or a starting symbol (e.g., the tenth symbol in the slot) of a PSFCH (e.g., the eleventh symbol in the slot). For example, the first wireless device may start the LBT procedure at least one symbol or a certain period (e.g., in terms of p or ms) before and/or prior to a starting symbol of the AGC symbol. For example, the first wireless device may end the LBT procedure at least one symbol or a certain period (e.g., in terms of p or ms) before and/or prior to a starting symbol of the AGC symbol. For example, referring to FIG. 19, the first wireless device may start the LBT procedure

For example, the LBT procedure may start during a first symbol that is at least one symbol or a certain period (e.g., in terms of p or ms) before and/or prior to a starting symbol of the AGC symbol (e.g., located one symbol before the PSCCH, PSSCH, and/or PSFCH in FIG. 19). For example, the LBT procedure may end before and/or prior to the starting symbol. The wireless device may not transmit, via the AGC symbol, an AGC signal (e.g., that is for the second wireless device to determine/adjust/train parameter values of its AGC) to the second wireless device, e.g., in response to the LBT procedure indicating the channel is busy. The wireless device may transmit, via the AGC symbol, the AGC signal to the second wireless device, e.g., in response to the LBT procedure indicating the channel is idle.

A wireless device may receive message(s) comprising configuration parameters of one or more sidelink resource pools configured in an unlicensed spectrum. The wireless device may select and/or determine a sidelink resource pool from the one or more sidelink resource pools for a sidelink transmission and/or a sidelink reception in the unlicensed spectrum. The wireless device may select and/or a sidelink resource from the sidelink resource pool for the sidelink transmission and/or sidelink reception in the unlicensed spectrum

In an example, a first wireless device may be a transmitting wireless device of one or more sidelink transmissions. A second wireless device may be a receiving wireless device of the one or more sidelink transmissions. For example, the second wireless device may be a desired/intended receiver of the one or more sidelink transmissions. For example, a SCI (e.g., a second-stage SCI) scheduling the one or more sidelink transmissions may comprise/indicate an ID (e.g., destination ID) of the second wireless device indicating that the second wireless device is a desired/intended/destination receiver of the one or more sidelink transmissions. For example, the second wireless device may not be a desired/intended receiver of the one or more sidelink transmissions, e.g., if a SCI (e.g., a second-stage SCI) scheduling the one or more sidelink transmissions may not comprise/indicate an ID (e.g., destination ID) of the second wireless device. For example, the second wireless device that is not a desired/intended receiver of the one or more sidelink transmissions may be a device that monitors and/or receives the SCI (e.g., comprising an ID (e.g., destination ID) of another wireless device) transmitted by the first wireless devices using the one or more sidelink resource pools. In an example, the one or more sidelink transmissions may comprise PSCCH and/or PSSCH transmissions. In an example, the one or more sidelink transmissions may comprise one or more unicast transmissions, one or more groupcast transmissions, and/or one or more broadcast transmissions.

A base station and/or a wireless device may transmit a message to the first wireless device. The message may comprise an RRC message, SIB, a MAC CE, DCI, and/or SCI. The message may comprise a field indicating/configuring one or more sidelink resource pools in a sidelink BWP. The message may further indicate/configure (e.g., frequency location of) the sidelink BWP in a frequency band, e.g., an unlicensed band. In an example, the sidelink BWP may be in an unlicensed/shared spectrum/carrier/band/cell with a plurality of RATs (e.g., wifi, etc.). The one or more sidelink resource pools and/or sidelink BWP may be pre-configured to the first wireless device. A bandwidth of the frequency band may be at least as wide as (e.g., wider than or equal to) a minimum regularized bandwidth in a respective unlicensed band. In an example, the message transmitted by the base station and/or the wireless device may comprise/indicate a threshold indicating a bandwidth (e.g., a minimum bandwidth). The bandwidth indicated by the threshold may be wider than or equal to the minimum regularized bandwidth in the unlicensed spectrum. In an example, the threshold indicating the bandwidth may be pre-configured to the first wireless device. In an example, the frequency band may have a frequency band identifier (ID)/index. Each of the one or more sidelink resource pools (e.g., in the frequency band) may have a sidelink resource pool ID/index. The message, received by the first wireless device and/or the second wireless device from the base station and/or the wireless device, may comprise/indicate/configure the frequency band ID/index and the sidelink resource pool ID/index for the each of the one or more sidelink resource pools in the frequency band. The message may comprise/indicate/configure a mapping (e.g., an association) between the frequency band and the one or more sidelink resource pools in the frequency band. The mapping may indicate that the ID/index of the frequency band is associated with the IDs/Indexes of the one or more sidelink resource pools in the frequency band. In an example, the frequency ID/index, the sidelink resource pool IDs/indexes of the one or more sidelink resource pools in the frequency band, and/or the mapping between the frequency band and the one or more sidelink resource pools in the frequency band may be pre-configured to the first wireless device and/or the second wireless device. The first wireless device may select, from the one or more sidelink resource pools, a sidelink grant comprising one or more resources for the one or more sidelink transmissions. The first wireless device may select the sidelink grant based on a resource selection procedure in the frequency band (e.g., unlicensed band). In an example, the resource selection procedure may comprise at least one of sensing procedures and/or actions described in FIG. 25, FIG. 26, and/or FIG. 27.

A sidelink resource pool may be confined within an unlicensed band. The unlicensed band may comprise a channel having a bandwidth (e.g., a range of frequency) requiring an LBT procedure. For example, a wireless device determine/select the sidelink resource pool and determine/select a sidelink resource among one or more sidelink resources of the sidelink resource pool. The wireless device may perform the LBT on the channel. The bandwidth may comprise one or more subchannel of the sidelink resource. The sidelink BWP comprising the sidelink resource pool may be confined in the unlicensed band. The sidelink BWP comprising the sidelink resource pool may be confined in the unlicensed band.

FIG. 28 illustrates an example configuration of a sidelink resource pool in a frequency band as per an aspect of an example embodiment of the present disclosure. In FIG. 28, a sidelink resource pool may refer to the one in FIG. 18. For example, a wireless device may receive a message (e.g., RRC message and/or a SIB) from a base station and/or another wireless device. The message may comprise configuration parameters of sidelink BWP. The configuration parameters may indicate a bandwidth (e.g., and/or frequency size) of the sidelink BWP. The configuration parameters may indicate a first sidelink resource pool is configured in the sidelink BWP. The configuration parameters may indicate that the sidelink BWP is confined and/or configured in a particular frequency band (e.g., unlicensed band). For example, the size of the sidelink BWP may be equal to or smaller than a minimum regularized bandwidth for which the wireless device performs an LBT procedure to gain access on a channel. For example, the size of the sidelink BWP may be smaller than or equal to 20 MHz, e.g., the particular frequency band is an unlicensed band in 5 GHz, 6 GHz, and/or FR1 band. For example, the configuration parameters may further indicate a second sidelink resource pool is configured in the sidelink BWP. A first sidelink resource of the first sidelink resource pool may overlap in time with a second sidelink resource of the second sidelink resource pool, e.g., Slot 3 in FIG. 28.

FIG. 29 illustrates an example configuration of a sidelink resource pool in a frequency band as per an aspect of an example embodiment of the present disclosure. In FIG. 29, a sidelink resource pool may refer to the one in FIG. 18. For example, a wireless device may receive a message (e.g., RRC message and/or a SIB) from a base station and/or another wireless device. The message may comprise configuration parameters of sidelink BWP. The configuration parameters may indicate a bandwidth (e.g., and/or frequency size) of the sidelink BWP. For example, the sidelink BWP may be a wideband sidelink BWP that has a bandwidth larger than a minimum regularized bandwidth for which the wireless device performs an LBT procedure to gain access on a channel. For example, the sidelink BWP may be larger than 20 MHz. The configuration parameters may indicate that one or more sidelink resource pools are configured in the sidelink BWP. The configuration parameters may indicate that each of the one or more sidelink resource pools is confined and/or configured in a respective frequency band (e.g., unlicensed band). In FIG. 29, three sidelink resource pools are in a sidelink BWP. The sidelink BWP may comprise a frequency band 1 (e.g., unlicensed band 1) and a frequency band 2 (e.g., unlicensed band 2). The first sidelink resource pool and the second sidelink resource pool may be confined in the frequency band 1. The third sidelink resource pool may be confined in the frequency band 2. The frequency band 1 (e.g., unlicensed band 1) and the frequency band 2 (e.g., unlicensed band 2) may require different and/or independent LBT procedures. For example, the wireless device may perform a first LBT procedure that may indicate a channel of frequency band 1 being idle in Slot 3. For example, the wireless device may transmit, in response to the channel of frequency band 1 being idle in Slot 3, a sidelink data via a sidelink resource selected from the first sidelink resource pool or the second sidelink resource pool that are configured in the frequency band 1. For example, the wireless device may not transmit, in response to the channel of frequency band 1 being idle in Slot 3, a sidelink data via a sidelink resource selected from the third sidelink resource pool that are configured in the frequency band 2. Transmitting a sidelink data via a sidelink resource selected from the third sidelink resource pool that are configured in the frequency band 2 may require a second LBT procedure.

A sidelink resource pool may be configured in a sidelink carrier. The sidelink carrier may be configured, e.g., by a base station, in an unlicensed carrier/frequency/band/spectrum. For example, the sidelink carrier may be configured for operation with shared spectrum channel access. For example, a wireless device may receive one or more RRC messages comprising configuration parameters of the sidelink carrier, and/or a serving cell associated with the sidelink carrier, for operation with shared spectrum channel access. The configuration parameters (e.g., channel access configuration parameters) may be used for channel access procedures of operation with shared spectrum channel access, e.g., one or more types of channel access procedures and/or LBT procedures. The configuration parameters may comprise an energy detection configuration/threshold; and/or COT sharing configuration.

The parameters of COT sharing configuration may indicate: a COT sharing energy detection threshold; and/or energy detection threshold offset. The parameters of COT sharing configuration may indicate that COT sharing between sidelink UEs is allowed/enabled/configured. In an example, configuration parameters of a sidelink resource pool may comprise COT sharing parameters, indicating that COT sharing is allowed/enabled/configured between wireless devices using/communicating via the resource pool.

A sidelink resource pool, configured for operation with shared spectrum channel access (unlicensed band), may be associated with sidelink resource allocation mode 1 and/or sidelink resource allocation mode 2. A UE may use channel access procedures in combination with resource allocation mode 1 and/or resource allocation mode 2. A UE may perform sidelink resource reservation by sending a SCI indicating reservation of a time-frequency resource (transmission occasion) in the resource pool.

A UE performing transmission(s) on SL-U carrier(s) and/or channel(s) and/or a UE scheduling or configuring SL transmission(s) for a UE performing transmissions on channel(s) may perform the channel access procedures to access the channels on which the transmission(s) are performed. Transmissions from a UE may be considered as separate SL transmissions, irrespective of having a gap between transmissions or not. A UE may perform channel access procedures, e.g., in dynamic channel access, unless a higher layer parameter indicates not to (e.g., if ChannelAccessMode is configured/provided and/or ChannelAccessMode=‘semiStatic’, or if a RRC parameter indicates absence of any other technology (RAT) sharing the carrier).

A UE may access a channel on which SL transmission(s) are performed according to one of a plurality of types of channel access procedures/LBTs (e.g., Type 1 SL channel access procedure and/or Type 2 SL channel access procedure). In an example, a UE may perform Type 1 channel access procedures and/or Type 2 (2A/2B/2C) channel access procedures to access a channel for a sidelink transmission.

In a channel access procedure, the UE performs energy detection (ED). If the detected energy during a sensing period (e.g., clear channel assessment (CCA) period) is lower than an ED threshold, the UE may determine a successful LBT (e.g., idle/available channel). If the detected energy during the sensing period (e.g., CCA period) is higher than the ED threshold, the UE may determine a failed LBT or LBT failure (e.g., busy channel). The ED threshold may be configured by RRC signaling. In response to determining a successful LBT, the UE may perform the sidelink transmission. In response to determining a failed LBT (failure of the LBT procedure), the UE may not perform (e.g., drop or cancel) the sidelink transmission.

In the present disclosure, the terms LBT and channel access procedure may be used interchangeably.

Upon a successful LBT on a channel, the UE may access the channel for a period referred to as Channel Occupancy Time (COT). This is referred to as COT initiation. In an example, a UE may initiate a COT using a first type of channel access procedure, e.g., Type 1 channel access procedure or Type 1 LBT.

Upon a failed LBT on a channel, the device may start an extended CCA period (e.g., continue sensing and energy detection), in which the detected energy is again compared against the ED threshold until channel access is granted. The regulation may specify the CCA slot duration (e.g., 9 μs in the 5 GHz band, and 5 μs in the 60 GHz band), the initial and extended CCA check times (e.g., a multiple of 5 μs for initial CCA and 8+m×5 μs for extended CCA in the 60 GHz band, where m controls the backoff), and the ED threshold (e.g., −72 dBm for a 20 MHz channel bandwidth in the 5 GHz band, and −47 dBm for 40 dBm of radiated power in the 60 GHz band).

Various example LBT mechanisms/procedures may be implemented. In an example, for some signals, in some implementation scenarios, in some situations, and/or in some frequencies no LBT procedure may be performed by the transmitting entity. An LBT procedure referred in example embodiment(s) may comprise Type 1 LBT, Type 2A LBT, Type 2B LBT, and/or Type 2C LBT. A type of an LBT (e.g., Type 1 LBT, Type 2 LBT, Type 2A LBT, Type 2B LBT, and/or Type 2C LBT) may be indicated or determined by the UE.

In an example, a UE may use Type 2 channel access procedures, including Type 2A channel access procedure, Type 2B channel access procedure, and/or Type 2C channel access procedure. In Type 2 channel access procedures, the time duration spanned by the sensing slots that are sensed to be idle before a SL transmission(s) may be deterministic.

In an example, Type 2C channel access procedure (Type 2C LBT, or CAT1 LBT e.g., no LBT) may be configured for one or more sidelink signals and/or channels. For example, a channel in unlicensed/shared band may be occupied by a first device (e.g., for uplink, downlink, and/or sidelink transmissions) for a duration of a channel occupancy time (COT). The first device may share the channel (e.g., a portion of the duration of the COT) with a second device. For example, a second device may take over the channel in unlicensed/shared band for uplink, downlink, and/or sidelink transmissions, e.g., of a control signal (e.g., HARQ feedback of the uplink, downlink, and/or the sidelink transmissions) based on a Type 2C channel access procedure (e.g., without sensing the channel before the transmission). For example, the duration of the corresponding transmission may be less than a threshold (e.g., 584 micro seconds).

In an example, Type 2B channel access procedure (Type 2CLBT or CAT2 LBT that may be referred to as one-shot LBT and/or a short LBT) may be configured for one or more sidelink signals and/or channels. The Type 2B may be an LBT without random back-off. The duration of time determining that the channel is idle may be deterministic (e.g., by a regulation, e.g., 16 micro second). A transmitting device (e.g., a base station in Uu interface, a wireless device in Uu interface, and/or a transmitting device in a sidelink communication) may transmit a grant (e.g., uplink grant and/or a sidelink grant) indicating a type of LBT (e.g., Type 2 BLBT) to a receiving device (e.g., a base station in Uu interface, a wireless device in Uu interface, and/or a receiving device in a sidelink communication). For example, a channel in unlicensed/shared band may be occupied by a first device (e.g., for uplink, downlink, and/or sidelink transmissions) for a duration of a channel occupancy time (COT). The first device may share the channel (e.g., a portion of the duration of the COT) with a second device. For example, a second device may take over the channel in unlicensed/shared band for uplink, downlink, and/or sidelink transmissions, e.g., of a control signal (e.g., HARQ feedback of the uplink, downlink, and/or the sidelink transmissions) based on a Type 2B channel access procedure (e.g., with short/one-shot sensing the channel before the transmission). For example, the UE may transmit the transmission immediately after sensing the channel to be idle within a duration T_{f} (e.g., T_{f}=16 us), including a sensing slot that occurs within the last time interval (e.g., 9 us) of the duration T_{f}. The channel is considered to be idle within the duration T_{f} if the channel is sensed to be idle for total of at least 5 us with at least 4 us of sensing occurring in the sensing slot.

In an example, Type 2A channel access procedure (Type 2A LBT or CAT3 LBT, e.g., LBT with deterministic back-off) may be configured for one or more sidelink signals and/or channels. A UE may be indicated to perform Type 2A channel access procedure in a SL grant. For example, a channel in unlicensed/shared band may be occupied by a first device (e.g., for uplink, downlink, and/or sidelink transmissions) for a duration of a channel occupancy time (COT). The first device may share the channel (e.g., a portion of the duration of the COT) with a second device. For example, a second device may take over the channel in unlicensed/shared band for uplink, downlink, and/or sidelink transmissions, e.g., of a control signal (e.g., HARQ feedback of the uplink, downlink, and/or the sidelink transmissions) based on a Type 2A channel access procedure. For example, the UE may use Type 2A channel access procedures for a SL transmission. The UE may transmit the transmission immediately after sensing the channel to be idle for at least a sensing interval T_{short_ul} (e.g., T_{short_ul}=25 us), consisting of a duration T_{f} (e.g., T_{f}=16 us) immediately followed by one sensing slot and T_{f} including a sensing slot at start of T_{f}. The channel is considered to be idle for T_{short_ul} if both sensing slots of T_{short_ul} are sensed to be idle.

In an example, Type 1 channel access procedure (Type 1 LBT or CAT4 LBT, e.g. LBT with random back-off with a contention window of variable size) may be implemented. The time duration spanned by the sensing slots that are sensed to be idle before a SL transmission(s) based on Type 1 LBT is random. A UE may transmit a SL transmission using Type 1 channel access procedure after first sensing the channel to be idle during the slot durations of a defer duration T_{d}, and after a counter N is zero. The UE may adjust the counter N by sensing the channel for additional slot duration(s) according to the steps described below.

Type 1 channel access procedure may be applicable to SL transmissions comprising PSCCH and/or PSSCH and/or PSFCH transmission and/or SL-SSB. In an example, the SL transmission may be schedule by the base station (e.g., mode 1). In an example, the SL transmission may be determined by the UE (e.g., mode 2).

Type 2 channel access procedure (e.g., Type 2A and/or Type 2B and/or Type 2C) may be applicable to SL transmissions comprising PSCCH and/or PSSCH and/or PSFCH transmission and/or SL-SSB. In an example, the SL transmission may be schedule by the base station (e.g., mode 1). In an example, the SL transmission may be determined by the UE (e.g., mode 2).

In Type 1 channel access procedure, the transmitting device may draw/determine a random number N within a contention window (e.g., N=Nᵢₙᵢₜ, where Nᵢₙᵢₜ is a random number uniformly distributed between 0 and CWₚ). The size of contention window may be specified by the minimum and maximum value of N, e.g., based on a channel access priority class (CAPC) associated with the corresponding SL transmission. The transmitting device may vary the size of the contention window when drawing the random number N. The random number N may be used in the LBT procedure to determine the duration of time that the channel is sensed to be idle before the transmitting device transmits on the channel. The UE may choose to decrement the counter, e.g., set N=N−1, if N>0. The UE may sense the channel for an additional slot duration. For example, if the additional slot duration is idle, the UE may stop if N=O. For example, if the additional slot duration is idle, the UE may decrement the counter N if N>0. For example, if the additional slot duration is busy (not idle), the UE may sense the channel until either a busy slot is detected within an additional defer duration T_{d} or all the slots of the additional defer duration T_{d} are detected to be idle. In an example, if the channel is sensed to be idle during all the slot durations of the additional defer duration T_{d}, the UE may stop if N=O. In an example, if the channel is sensed to be idle during all the slot durations of the additional defer duration T_{d}, the UE may decrement the counter N if N>0. In an example, if the channel is sensed to be idle during all the slot durations of the additional defer duration T_{d}, the UE may sense the channel until either a busy slot is detected within an additional defer duration T_{d} or all the slots of the additional defer duration T_{d} are detected to be idle.

In an example, if a UE has not transmitted a SL transmission on a channel on which SL transmission(s) are performed after the above LBT procedure is stopped, the UE may transmit a transmission on the channel, if the channel is sensed to be idle at least in a sensing slot duration Tₛₗ when the UE is ready to transmit the transmission and/or if the channel has been sensed to be idle during all the slot durations of a defer duration T_{d} immediately before the transmission. In an example, if the channel has not been sensed to be idle in a sensing slot duration Tₛₗ when the UE first senses the channel after it is ready to transmit, and/or if the channel has not been sensed to be idle during any of the sensing slot durations of a defer duration T_{d} immediately before the intended transmission, the UE resets the counter (e.g., set N=Nᵢₙᵢₜ,) after sensing the channel to be idle during the slot durations of a defer duration T_{d}.

In an example, the defer duration T_{d} may consists of duration T_{f}=16 us immediately followed by my consecutive slot durations, where each slot duration is Tₛₗ=9 us, and T_{f} includes an idle slot duration Tₛₗ at start of T_{f}. The value of mₚ may depend on a channel access priority class of the corresponding SL transmission.

In an example, the value/size of the contention window CWₚ may be determined/adjusted based on a channel access priority class (CAPC) of the corresponding SL transmission, e.g., CW_{min,p}≤CWₚ≤CW_{max,p}, where CW_{min,p} and CW_{max,p} are based on the CAPC. In an example, CW_{min,p} and CW_{max,p} are chosen before the channel access procedure. In an example, mₚ, CW_{min,p}, and CW_{max,p} are based on a channel access priority class (CAPC p) as shown in the Table of FIG. 30.

For operation with shared spectrum, the UE may perform a channel access procedure (a.k.a. LBT procedure). The UE may determine a channel access priority class (CAPC) for a LBT procedure. For example, the parameters of the LBT procedure may be based on the corresponding CAPC. The UE may determine the parameters of the LBT procedure, e.g., contention window size (CWₚ) and/or the defer duration (T_{d}) based on the respective CAPC. The UE may determine a duration of a channel occupancy time (COT), initiated by the LBT procedure, based on the CAPC of the LBT procedure. The LBT procedure may be a Type 1 LBT procedure (e.g., Type 1 SL channel access procedure).

FIG. 30 shows a table of example parameters for sidelink channel access procedure. The table may comprise one or more entries that may comprise one or more values (e.g., one or more elements). An entry of the table may be referred to as a row of the table. An entry of the table may be referred to as an n-tuple (e.g., n-tuple may refer to a set of n elements). For example, the table may be implemented as a list of n-tuple. For example, the table in FIG. 30 is a list of 6-tuple, wherein each entry in the table comprises values corresponding to 6 parameters (e.g., CAPC (or p), mₚ, CW_{min,p}, CW_{max,p}, T_{sl-mcot,p} (or T_{mcot,p}), and/or allowed CWₚ sizes). At least one entry and/or At least one value in the table may be predefined. At least one entry and/or At least one value in the table may be configurable by a message that a UE receives from a base station. Each entry in the table may comprise a respective identifier. For example, in FIG. 30, the identifier 1 (or p=1) indicates a top entry in the table and identifier 2 (or p=2) indicates a second top entry in the table. A CAPC value and/or a priority indication of a respective CAPC may be an identifier of an entry in the table. A UE may determine a CAPC (or CAPC value) for performing a channel access procedure (and/or LBT procedure) for an uplink or sidelink transmission. The UE may perform the channel access procedure (and/or LBT procedure) using the values in the entry indicated by the determined CAPC (or determined CAPC value), which is described in the example embodiment of present disclosure. For example, if a UE determines a CAPC (or CAPC value) as 2 (e.g., p=2) for a channel access procedure (and/or LBT procedure) for an uplink or sidelink transmission, the UE, based on FIG. 30, uses mₚ=2, CW_{min,p}=7, CW_{max,p}=15, T_{sl-mcot,p} (or T_{mcot,p})=4 ms, and/or allowed CWₚ sizes={7,15} as parameters values used during (or for) the channel access procedure.

A UE may use the table in FIG. 30 for a Type 1 SL channel access procedure (LBT procedure). In unlicensed operation, each transmission may be associated with a respective channel access priority class (CAPC). For example, a UE may determine to transmit a sidelink transmission (e.g., S-SSB, PSSCH, PSCCH, and/or PSFCH transmission) in a resource pool configured in an unlicensed spectrum. The Tx UE may determine to perform a LBT procedure (e.g., Type 1 LBT procedure) prior to the sidelink transmission. The UE may determine a value of the CAPC (e.g., CAPC value, or p as in FIG. 30) for the LBT procedure prior to the sidelink transmission, e.g., p=1 or p=2 or p=3 or p=4. A CAPC value (e.g., p) may indicate the CAPC associated with/of the sidelink transmission. For example, lower CAPC value may mean/indicate/correspond to higher priority of channel access for the sidelink transmission. For example, a lowest CAPC value (e.g., p=1) may indicate a highest channel access priority for a transmission. For example, a highest CAPC value (e.g., p=4) may indicate a lowest channel access priority for a transmission.

The UE may determine the CAPC of a sidelink transmission. For example, a plurality of CAPC values may be defined/provided/configured for sidelink transmissions. A first sidelink transmission may be associated with a first CAPC value. A second sidelink transmission may be associated with a second CAPC value, and so on. For example, CAPC value for one or more first sidelink transmission may be pre-defined (e.g., for S-SSB transmission and/or PSFCH transmission). For example, the UE may determine a lowest CAPC value (e.g., p=1) for S-SSB transmission. For example, a UE (e.g., Tx UE and/or Rx UE) may determine a CAPC value of one or more second sidelink transmissions (e.g., PSSCH and/or PSCCH and/or PSFCH transmissions) based on one or more rules and/or configuration parameters.

For example, a Tx UE may determine a CAPC value for a PSSCH/PSCCH transmission. The PSSCH/PSCCH transmission may comprise a SL TB and/or may be associated with a SL TB. For example, the Tx may determine to transmit a first TB via a first PSSCH transmission occasion in a first slot. The first PSSCH transmission occasion may be associated with a first PSCCH transmission occasion. For example, a first SCI transmitted via the first PSCCH transmission occasion may indicate scheduling information of the first TB and/or the first PSSCH transmission occasion. The Tx UE may determine to perform a Type 1 LBT procedure prior to transmission of the first TB. The Tx UE may determine a first channel access priority class (e.g., CAPC value or p as in FIG. 30) for the first TB.

The CAPC value of a TB may be indicated by a first information field (e.g., ChannelAccess-CPext-CAPC) in a DCI. For example, the UE may receive the DCI (e.g., DCI format 3_0 or format 3_1 or format 3_2) from a base station, wherein the DCI comprises scheduling information of the TB (e.g., for SL dynamic grant). In an example, the DCI may not comprise the first information field indicating the CAPC value of the TB (e.g., SL configured grant and/or SL selected grant). For example, in SL mode 2, the UE may select a grant (e.g., a first single-slot resource or PSSCH transmission occasion) for a TB transmission. The UE may determine a CAPC value associated with the TB (e.g., to use for LBT procedure prior to transmission of the TB via the grant) based on the content of the TB (e.g., the data multiplexed in the TB or the MAC PDU), e.g., if not indicated by a DCI or SCI.

Throughout this disclosure: the term CAPC may refer to priority of channel access for a transmission, indicating how important it is to transmit that transmission; and the term CAPC value may refer to a value of CAPC of a transmission, indicating a value/quantity that represents the respective CAPC. The relationship between a CAPC and its respective CAPC value may be reverse, e.g., as CAPC increases (more important/prioritized to access the channel) the CAPC value decreases (e.g., smaller/lower number is used to represent the CAPC).

FIG. 31A and FIG. 31B illustrate examples of TB generation for sidelink. In the example of FIG. 31A, the UE (MAC layer of the UE) generates two SL TBs (SL PHY SDUs or SL MAC PDUs) by multiplexing one or more MAC SDUs in each SL MAC PDU. In this example, the UE multiplexes three MAC SDUs in a first SL MAC PDU (or SL PHY SDU or SL transport block (TB)), and one MAC SDU in a second SL MAC PDU (or SL PHY SDU or SL transport block). The UE (MAC) may attach a MAC subheader to a MAC SDU to form a SL MAC PDU. The MAC subheaders (labeled with an “H” in FIG. 31A and FIG. 31B) may be distributed across the SL MAC PDU, as illustrated in FIG. 31A. For example, one MAC subheader may be placed before a corresponding MAC SDU. As shown in FIG. 31A, a SL-SCH subheader may be inserted at the beginning of a SL MAC PDU. For example, the SL-SCH subheader may be placed before all MAC subPDUs. An example of SL-SCH subheader is depicted in FIG. 23. The SL-SCH subheader is of a fixed size and consists of the seven header fields V/R/R/R/R/SRC/DST, as shown in FIG. 23, which is used for determining the source ID and destination ID of logical channels multiplexed in the SL MAC PDU.

FIG. 31B illustrates an example format of a MAC subheader in a SL MAC PDU. The MAC subheader includes: an SDU length field for indicating the length (e.g., in bytes) of the (following) MAC SDU to which the MAC subheader corresponds; a logical channel identifier (LCID) field for identifying the SL logical channel from which the MAC SDU originated to aid in the demultiplexing process; a flag (F) for indicating the size of the SDU length field; and a reserved bit (R) field for future use. In an example, the UE may multiplex one or more MAC CEs and/or padding in a SL MAC PDU (TB). FIG. 31B further illustrates MAC control elements (CEs) inserted/multiplexed into the SL MAC PDU by a UE. In this example, the SL MAC PDU comprises two MAC CEs and two MAC SDUs. For example, FIG. 31B illustrates two MAC CEs multiplexed into the SL MAC PDU. SL MAC subPDU(s) with MAC SDU(s) may be placed after the SL-SCH subheader and before the MAC subPDU with a MAC CE and the MAC subPDU with padding in the SL MAC PDU as depicted in FIG. 31B. SL MAC subPDU with a MAC CE is placed after all the MAC subPDU(s) with MAC SDU and before the MAC subPDU with padding in the SL MAC PDU. The size of padding may be zero.

SL MAC CEs may be used for in-band control signaling. Example SL MAC CEs comprise: sidelink buffer status report (e.g., BSR MAC CEs); sidelink channel state information (CSI) reporting MAC CE; sidelink discontinuous reception (DRX) command MAC CE; sidelink configured grant confirmation MAC CE.

The UE may determine a CAPC associated with a TB based on the content/data in the TB. Referring to FIG. 31A and FIG. 31B, a TB or MAC PDU may comprise one or more MAC SDUs and zero or one or more MAC-CEs. A MAC SDU may comprise data (e.g., data units or higher layer PDUs) of a SL logical channel. The UE may multiplex data (e.g., data units or MAC SDUs) of (e.g., data coming from a data buffer of) one or more SL logical channels in a MAC PDU. The UE may multiplex data of a sidelink control channel (SCCH) or a sidelink traffic channel (STCH) in a MAC PDU (based on SL-SCH). The UE may further multiplex one or more SL MAC CEs (e.g., MAC control information of sidelink) in the MAC PDU.

A SL TB may comprise one or more MAC CEs and/or one or more MAC SDUs. A SL TB may comprise data (e.g., one or more MAC SDUs) of a SCCH logical channel. The data/MAC SDU of a SCCH may comprise SL control data or one or more SL control messages. A SL TB may comprise data (e.g., one or more MAC SDUs) of a STCH logical channel. The data/MAC SDU of a STCH may comprise SL traffic data coming from one or more application services (e.g., from application layer). A MAC SDU may comprise data of a SL logical channel (e.g., SCCH or STCH). A MAC SDU may comprise data from (e.g., associated with) a SL radio bearer (e.g., SL SRB or SL DRB). A TB or MAC PDU may comprise data of a SL logical channel (e.g., SCCH or STCH). A TB or MAC PDU may comprise data from (e.g., associated with) a SL radio bearer (e.g., SL SRB or SL DRB).

For example, SL data from higher layers (e.g., SL control messages and/or data from SL applications) may be buffered/stored in one or more SL radio bearer. For example, control data may be buffered in SL signaling radio bearer (SL SRB). For example, application/traffic data may be buffered in SL data radio bearer (SL DRB). For example, a SL radio bearer may be linked to or associated with a SL logical channel. Upper layers of the UE may map data from a SL radio bearer (e.g., SL SRB and/or SL DRB) to a SL logical channel (e.g., SBCH, SCCH, and/or STCH), and vice versa. The mapping between SL radio bearers and SL logical channels may be pre-defined and/or pre-configured by RRC configurations. For example, data from a SL SRB may be buffered/stored in a SCCH. For example, data from a SL DRB may be buffered/stored in a STCH. A SCCH logical channel may comprise data from at least one SL SRB. A STCH logical channel may comprise data from at least one SL DRB.

Sidelink radio bearers and/or sidelink logical channels may be associated with different CAPC values. For example, the CAPC (or CAPC value) of one or more first SL radio bearers or SL logical channels or SL MAC CEs may be predefined (e.g., fixed). For example, the CAPC (or CAPC value) of one or more second SL radio bearers or SL logical channels or SL MAC CEs may be configured by gNB (e.g., indicated via RRC configuration parameters).

The Channel Access Priority Classes (CAPC) of radio bearers and MAC CEs may be pre-defined (e.g., fixed) or configurable (e.g., via RRC configuration parameters). For example, the CAPC may be fixed to the lowest priority for the padding BSR and recommended bit rate MAC CEs. For example, the CAPC may be fixed to the highest priority for SL SRB0, SL SRB1, SL SRB3 and other MAC CEs. For example, the CAPC may be configured by the gNB for SL SRB2 and SL DRB(s). For example, when choosing the CAPC of a DRB, the gNB may take into account the PQIs of one or more QoS flows multiplexed in that DRB, e.g., while considering fairness between different traffic types and transmissions. For example, a mapping may be defined/provided to show which CAPC value should be used for which standardized PQIs, e.g., which CAPC to use for a given QoS flow. For example, for one or more first PQIs (e.g., PQI=1, 3, 5, 65, 66, 67, 69, 70, 79, 80, 82, 83, 84, 85) a first CAPC value (e.g., p=1) may be used. For example, for one or more second PQIs (e.g., PQI=2, 7, 71) a second CAPC value (e.g., p=2) may be used. For example, for one or more third PQIs (e.g., PQI=4, 6, 8, 9, 72, 73, 74, 76) a third CAPC value (e.g., p=3) may be used. A QoS flow corresponding to a non-standardized PQI (e.g., operator specific PQI) may use the CAPC of the standardized PQI which best matches the QoS characteristics of the non-standardized PQI.

For example, PQI (PC5-5QI) may be used to determine the CAPC mapping in SL-U. For example, for SL-DRB the CAPC value may be (pre)configurable per-DRB. For example, for all SL-SRBs, CAPC value may be fixed to the highest priority (i.e., lowest CAPC value). For example, for all SL MAC CEs, CAPC value may be fixed to the highest priority (i.e., lowest CAPC value). For example, at least PDB may be used as the criterion to determine the CAPC mapping.

The UE may determine a CAPC value for a SL transmission based on an indication. A CAPC value of a SL transmission (e.g., PSSCH/PSCCH and/or PSFCH) may be indicated by control signaling, e.g., DCI and/or SCI. For example, a DCI comprising a sidelink grant for a SL TB transmission via PSSCH may comprise a field indicating the CAPC value for the TB transmission. For example, a SCI scheduling a SL TB transmission via PSSCH may comprise a field indicating the CAPC value for the TB transmission and/or corresponding SL transmission (e.g., corresponding PSFCH and/or PUCCH transmissions comprising HARQ feedback information and/or inter-UE coordination information). For example, a SCI comprising COT sharing information may comprise a field indicating the CAPC value associated with the COT and/or SL transmissions within the COT.

The UE may select/determine a CAPC/CAPC value for a transmission of a SL TB/MAC PDU, e.g., when performing Type 1 LBT for the transmission of the sidelink TB/MAC PDU. The UE may select/determine a CAPC for a transmission of a SL TB/MAC PDU, e.g., when the CAPC/CAPC value is not indicated in a DCI or SCI. For example, the UE may select/determine a CAPC for a transmission of a SL TB/MAC PDU when the UE selects a resource for the transmission of the SL TB/MAC PDU (e.g., mode 2).

The UE may select/determine a CAPC/CAPC value for a transmission of a SL TB/MAC PDU based on one or more SL radio bearers or SL logical channels or SL MAC CEs multiplexed in the SL TB/MAC PDU. For example, if only MAC CE(s) are included/multiplexed in the TB, the UE selects/uses the highest priority CAPC (e.g., the lowest CAPC value) of those MAC CE(s). For example, if SCCH SDU(s) are included in the TB, the UE selects/uses the highest priority CAPC (e.g., lowest CAPC value). For example, if SCCH SDU(s) are included in the TB, the UE selects/uses the highest priority CAPC (e.g., lowest CAPC value) of the SCCH(s). Otherwise, the UE selects/uses the lowest priority CAPC (e.g., highest CAPC value) of the logical channel(s) with MAC SDU multiplexed in the TB. For example, if no SCCH SDU(s) are multiplexed/included in the TB, and/or if only MAC CE(s) are not included/multiplexed in the TB, the UE selects/uses the lowest priority CAPC (e.g., highest CAPC value) of the logical channel(s) with MAC SDU multiplexed in the TB.

For example, if the SL TB/MAC PDU comprises only MAC CE(s), the UE selects/uses the highest priority CAPC of those MAC CE(s). For example, if the SL TB/MAC PDU comprises SCCH SDU(s) (e.g., data of/from SCCH logical channel(s) or SL SRB(s)), the UE selects/uses the highest priority CAPC (e.g., the highest priority CAPC of the SCCH(s)). For example, if the SL TB/MAC PDU does not comprise SCCH SDU(s) (e.g., data of/from SCCH logical channel(s) or SL SRB(s)) and/or comprises STCH SDUs (e.g., data of/from STCH logical channel(s) or SL DRB(s)), the UE selects/uses the lowest priority CAPC of the logical channel(s) with MAC SDU multiplexed in the TB/MAC PDU.

For example, if only SL MAC CE(s) are included in the SL TB, the highest priority SL CAPC (e.g., lowest CAPC value) may be used. For example, if SL MAC CE(s) is multiplexed with STCH SDU(s), the highest priority SL CAPC (e.g., lowest CAPC value) may be used. For example, if SCCH SDU(s) are included in the SL TB, the highest priority SL CAPC (e.g., lowest CAPC value) may be used.

The UE may perform one or more LBT procedures based on the determined/selected CAPC value (p). For example, the UE may perform the one or more LBT procedures using the selected/determined CAPC/CAPC value. The LBT procedure may be a Type 1 LBT procedure (e.g., Type 1 SL channel access procedure). For example, the UE (e.g., Tx UE) may determine the parameters of the one or more LBT procedures based on the determined/selected/indicated CAPC value, e.g., contention window size (CWₚ) and/or the defer duration (T_{d}) based on the (determined/selected/indicated) CAPC/CAPC value. The UE may determine a duration of a channel occupancy time (COT), initiated by the LBT procedure, based on the CAPC value of the LBT procedure. Referring to FIG. 30, the UE may determine a minimum contention window size associated with the CAPC value (CW_{min,p}) and a maximum contention window size associated with the CAPC value (CW_{max,p}) and a set of allowed contention window sized within the range indicated by the minimum contention window size and the maximum contention window size, associated with the CAPC value (allowed CWₚ sizes) for the one or more LBT procedures. The UE may determine a defer duration (T_{d}) based on the parameter associated with the CAPC value (p). For example, the defer duration T_{d} may comprise a duration T_{f} (e.g., T_{f}=16 s) followed by (e.g., immediately followed by) mₚ consecutive sensing slot durations Tₛₗ, and T_{f} comprises an idle sensing slot duration Tₛₗ at start of T_{f}. The UE may transmit the transmission using Type 1 channel access procedure after first sensing the channel to be idle during the slot durations of a defer duration T_{d}, and after a counter N is zero, wherein the counter N is initialized with a random number uniformly distributed between 0 and CWₚ, and CW_{min,p}≤CWₚ≤CW_{max,p} is the contention window selected based on the table in FIG. 30 for the corresponding CAPC value (p).

The UE may initiate a COT based on a successful LBT procedure (e.g., Type 1 LBT procedure). As shown in FIG. 30, the UE may determine a duration (e.g., maximum duration) of the initiated COT (T_{sl-mcot,p}) based on the CAPC value (p) used for the corresponding LBT procedure.

In an example, a first UE may receive a COT sharing indication, e.g., from a second UE. For example, the second UE may send a SCI comprising the COT sharing indication. In an example, the base station may send a DCI comprising the COT sharing indication. For example, the second UE may initiate the COT (e.g., based on a first duration) and may share a remainder duration (from the first duration) of the COT with the first UE. For example, the COT sharing indication may indicate the CAPC value of/associated with the COT (e.g., the CAPC value that the second UE used in the LBT procedure when initiating the COT). The first UE may determine whether to share the COT or not based on the indicated CAPC value of the COT. For example, the first UE may have a second SL transmission associated with a second CAPC value. The first UE may determine whether to transmit the second SL transmission within/based on the shared COT based on comparing the second CAPC value with the indicated CAPC value of the COT. For example, for fair channel access, the first UE may share the COT if the second CAPC value is lower/smaller than or equal to the indicated CAPC value of the COT.

A UE may receive RRC message(s) comprising sidelink configuration parameters. The sidelink configuration parameters may comprise inter-UE coordination (IUC) configuration. For example, the sidelink configuration parameters may comprise a parameter (e.g., SL-InterUE-CoordinationScheme1 or interUECoordinationScheme1) indicating that inter-UE coordination scheme 1 is enabled in one or more resource pools. For example, the sidelink configuration parameters may comprise a parameter (e.g., SL-InterUE-CoordinationScheme2 or interUECoordinationScheme2) indicating that inter-UE coordination scheme 2 is enabled in one or more resource pools.

In an example, the inter-UE coordination may be an inter-UE coordination scheme 1. In the inter-UE coordination scheme 1, a coordinating wireless device may select a set of preferred resources and/or a set of non-preferred resources for a requesting wireless device. The coordinating wireless device may transmit/send/provide/indicate the set of preferred resources and/or the set of non-preferred resources (e.g., coordination information/assistance information) to the requesting wireless device. The requesting wireless device may transmit one or more sidelink transmissions based on the set of preferred resources and/or the set of non-preferred resources.

In an example, a preferred resource, for transmitting (e.g., by a requesting wireless device of an inter-UE coordination) and/or receiving (e.g., by a coordinating wireless device of the inter-UE coordination) a sidelink transmission, may be a resource with a RSRP (e.g., measured by the coordinating wireless device) being lower than a RSRP threshold. In an example, a preferred resource, for transmitting (e.g., by a requesting wireless device of an inter-UE coordination) and/or receiving (e.g., by a coordinating wireless device of the inter-UE coordination) a sidelink transmission, may be a resource with a priority value being greater than a priority threshold.

In an example, a non-preferred resource, for transmitting (e.g., by a requesting wireless device of an inter-UE coordination) and/or receiving (e.g., by a coordinating wireless device of the inter-UE coordination) a sidelink transmission, may be a resource with a RSRP (e.g., measured by the coordinating wireless device) being higher than a RSRP threshold (e.g., hidden node problem with high interference level). In an example, a non-preferred resource, for transmitting (e.g., by a requesting wireless device of an inter-UE coordination) and/or receiving (e.g., by a coordinating wireless device of the inter-UE coordination) a sidelink transmission, may be a resource with a priority value being smaller than the priority threshold (e.g., resource collision problem with another sidelink transmission/reception, which has a high priority). In an example, a non-preferred resource, for transmitting (e.g., by a requesting wireless device of an inter-UE coordination) and/or receiving (e.g., by a coordinating wireless device of the inter-UE coordination) a sidelink transmission, may be a resource being reserved for a second sidelink and/or uplink transmission by the coordinating wireless device and/or an intended receiver (e.g., half-duplex problem). The coordinating wireless device may or may not perform a resource selection procedure for selecting a set of non-preferred resources. The coordinating wireless device may select the set of non-preferred resources based on sensing results of the coordinating wireless device.

In an example, a larger priority value may indicate a lower priority (PHY priority or physical layer priority). A smaller priority value may indicate a higher priority (PHY priority or physical layer priority). For example, a first sidelink transmission may have a first priority value. A second sidelink transmission may have a second priority value. The first priority value may be greater than the second priority value, while a first priority of the first sidelink transmission indicated by the first priority value is lower than a second priority of the second sidelink transmission indicated by the second priority value.

In an example, the inter-UE coordination may be an inter-UE coordination scheme 2. Inter-UE coordination scheme 2 may enable transmission of a resource conflict indication. The UE (e.g., coordinator UE) may determine/consider that a resource conflict occurs on a first reserved resource (r1) indicated by a first received SCI format if one or more conditions are satisfied.

FIG. 32 illustrates an example of a sidelink inter-UE coordination (e.g., an inter-UE coordination scheme 2). A first wireless device and a second wireless device may perform an inter-UE coordination, e.g., based on inter-UE coordination scheme 2. The first wireless device may be a requesting wireless device of the inter-UE coordination between the first wireless device and the second wireless device. The first wireless device may be a transmitter of one or more first sidelink transmissions. The second wireless device may be a coordinating wireless device of the inter-UE coordination. The second wireless device may or may not be an intended receiver of the one or more first sidelink transmissions by the first wireless device.

Referring to FIG. 19, a sidelink transmission may comprise a PSCCH, a PSSCH and/or a PSFCH. A SCI of the sidelink transmission may comprise a destination ID of the sidelink transmission. A wireless device may be an intended receiver of the sidelink transmission when the wireless device has a same ID as the destination ID in the SCI.

In an example, the first wireless device may request, from the second wireless device, coordination information (e.g., assistance information or conflict information) for the one or more sidelink transmissions. The first wireless device may send/transmit, to the second wireless device and via sidelink, a request message, for the requesting of the coordination information, to trigger the inter-UE coordination. The second wireless device may trigger the inter-UE coordination based on the receiving of the request message from the first wireless device. In an example, the first wireless device may not transmit a request message to trigger the inter-UE coordination. The second wireless device may trigger the inter-UE coordination based on an event and/or condition.

In an example, the second wireless device may receive a first SCI from the first wireless device. The first SCI may reserve one or more first resources for the one or more sidelink transmissions. In an example, the request message may comprise the first SC. In an example, the first SCI may comprise a field/flag indicating that the first wireless device (e.g., the transmitter wireless device) can/may be a wireless device to receive conflict information. In an example, the one or more sidelink transmissions may comprise the first SC. For example, the first SCI may indicate reservation of the one or more first resources (e.g., first reserved resources).

In an example, the second wireless device may receive, from a third wireless device, one or more second sidelink transmissions. The one or more second sidelink transmissions may comprise a second SCI. The second SCI may reserve one or more second resources for the one or more second sidelink transmissions. For example, the second SCI may indicate reservation of the one or more second resources (e.g., second reserved resources). The second wireless device may or may not be an intended receiver of the one or more second sidelink transmissions.

In response to the triggering of the inter-UE coordination, the second wireless device may determine the coordination information (e.g., the conflict information) for the inter-UE coordination. In an example, the second wireless device may determine the coordination information based on the first SCI. The second wireless device may determine the one or more first resources comprising resources on which the second wireless device would not receive the one or more first sidelink transmissions, e.g., when the second wireless device is an intended receiver of the one or more first sidelink transmissions. The second wireless device may transmit via sidelink and/or uplink via the resources on which the second wireless device would not receive the one or more first sidelink transmissions. The second wireless device may experience half-duplex when transmitting via the resources (e.g., transmit via sidelink). The coordination information may comprise/indicate the resources on which the second wireless device would not receive the one or more first sidelink transmissions, e.g., when the second wireless device is an intended receiver of the one or more first sidelink transmissions. In an example, the second wireless device may determine the coordination information based on the first SCI and/or the second SCI. In an example, the second wireless device may determine the one or more first resources fully/partially overlapping with the one or more second resources. The second wireless device may determine the coordination information indicating overlapped resources (conflicting resources) of the one or more first resources and the one or more second resources. The overlapped resources may be expected/potential overlapped resources (e.g., future resources) and/or detected overlapped resources (e.g., past resources). The overlapped resources may be referred to as resource conflict. The coordination information may comprise/indicate the overlapped resources (e.g., the resource conflict) between the one or more first resources and the one or more second resources. Fully overlapping between a first set of resources and a second set of resources may indicate that the first set of resources is the same as the second set of resources (e.g., or is the same as a subset of the second set of resources). Partially overlapping between a first set of resources and a second set of resources may indicate that the first set of resources and the second set of resources comprise overlapped (e.g., identical) one or more first sidelink resource units and/or non-overlapped (e.g., different) one or more second sidelink resource units.

In an example, the second wireless device may transmit, to the first wireless device and via sidelink, a message (e.g., coordination information/assistance information/conflict information) comprising/indicating the coordination information, e.g., comprising indication of one or more resources based on example embodiments described above. The coordination information in IUC scheme 2 may be referred to as conflict information. For example, the conflict information may indicate the resource conflict. The message may comprise a RRC, MAC CE, SCI and/or a PSFCH (e.g., a PSFCH format 0). A PSFCH format 0 may be a pseudo-random (PN) sequence defined by a length-31 Gold sequence. An index of a PN sequence of a PSFCH format 0 may indicate a resource collision/conflict on a resource, when the resource is associated with a PSFCH resource conveying the PSFCH format 0. Referring to FIG. 19, the SCI may comprise a first stage and a second stage. In an example, the first stage of the SCI may comprise/indicate the coordination information. In an example, the second stage of the SCI may comprise/indicate the coordination information.

In response to receiving the message, the first wireless device may select and/or update a set of resources for the one or more first sidelink transmissions based on the coordination information. In an example, the first wireless device may trigger a resource selection procedure for the selecting/updating of the set of resources. In an example, the first wireless device may not trigger a resource selection procedure for the selecting/updating of the set of resources. In an example, the first wireless device may determine whether to retransmit the one or more first sidelink transmissions based on the coordination information.

The example of the inter-UE coordination in FIG. 32 may be an inter-UE coordination scheme 2. In the inter-UE coordination scheme 2, a coordinating wireless device may determine coordination information based on expected/potential overlapped/collided resources (e.g., future resources) and/or detected overlapped/collided resources (e.g., past resources) between a first set of resources reserved by a requesting wireless device and a second set of resources reserved by a third wireless device.

A UE may receive RRC message(s) comprising sidelink configuration parameters. The sidelink configuration parameters may comprise inter-UE coordination (IUC) configuration. For example, the sidelink configuration parameters may comprise a parameter (e.g., SL-InterUE-CoordinationScheme2 or interUECoordinationScheme2) indicating that inter-UE coordination scheme 2 is enabled in one or more resource pools. Based on inter-UE coordination scheme 2, the UE may transmit a conflict information indication a resource conflict. The UE (e.g., coordinator UE) may determine/consider that a resource conflict occurs on a first reserved resource (r1) indicated by a first received SCI format if one or more conditions are satisfied. The one or more conditions are discussed as follows.

The UE (e.g., the first UE) may receive/detect a first SCI (e.g., SCI format) from a second UE. The first SCI may comprise one or more fields indicating reservation of one or more first resources for one or more first transmissions of the second UE. Each of the one or more first resources may be/comprise time/frequency resources indicated by the first SCI, as shown in FIG. 20. Each of the one or more first resources may be a PSSCH transmission occasion.

The first SCI (e.g., SCI format 1-A and/or SCI format 1-B) may comprise one or more fields indicating the one or more first resources for transmission of one or more SL TBs via one or more PSSCH/PSCCH transmissions. For example, the first SCI may comprise a frequency resource assignment field and/or a time resource assignment field. The UE may determine the set of slots/symbols/mini-slots and/or resource blocks/interlaces for PSSCH transmission based on the resource used for the PSCCH transmission (PSCCH transmission occasion) containing the first SCI, and/or the frequency resource assignment field and/or the time resource assignment field of/in the first SCI.

The time resource assignment field may indicate at least one logical/physical slot offset of the one or more first resources reserved by the first SCI. Referring to FIG. 19 and FIG. 20, a first resource of the one or more first resources may be in a first slot where the first SCI is received (e.g., for initial transmission of a TB). A second resource of the one or more first resources may be in a second slot that is by a first slot offset, of the at least one logical/physical slot offset, after the first slot (e.g., for a first retransmission of the first TB). A third resource of the one or more first resources may be in a third slot that is by a second slot offset, of the at least one logical/physical slot offset, after the first slot (e.g., for a second retransmission of the first TB). The second resource and/or the third resource may be referred to as reserved resources. For example, the first SCI may indicate, through time/frequency resource assignment fields, reservation of the second resource and/or the third resources.

The frequency resource assignment field may indicate one or more RBs/interlaces/subchannels of a SL BWP in a resource pool for at least one of the one or more first resources. The frequency resource assignment field may indicate a number of allocated subchannels and/or interlaces for each of the one or more first resources. The frequency resource assignment field may indicate a starting subchannel/interlace index for each of the one or more first resources. Referring to FIG. 19 and FIG. 20, a starting subchannel/interlace of the first resource of the one or more first resources may be the lowest subchannel/interlace on which the associated PSCCH (first SCI) is received (e.g., for initial transmission of a TB). The UE may determine starting subchannels/interlaces of the second resource (e.g., for the first retransmission of the first TB) and the third resource (e.g., for the second retransmission of the first TB), of the one or more first resources, based on a first starting subchannel/interlace index and a second starting subchannel/interlace index indicated by the frequency resource assignment field, respectively. The second resource and/or the third resource may be referred to as reserved resources. For example, the first SCI may indicate, through time/frequency resource assignment fields, reservation of the second resource and/or the third resource.

The first SCI may comprise a resource reservation period field indicating the resource reservation period. Referring to FIG. 20, each of the one or more first resources indicated by the first SCI may be repeated in time domain based on the resource reservation period. For example, the UE may determine a fourth resource of the one or more first resources, with the same time/frequency resource assignment as the first resource, which occurs after the resource reservation period from the first resource. The fourth resource may be for initial transmission of a second TB. For example, the UE may determine a fifth resource of the one or more first resources, with the same time/frequency resource assignment as the second resource, which occurs after the resource reservation period from the second resource. The fifth resource may be for a first retransmission of the second TB. For example, the UE may determine a sixth resource of the one or more first resources, with the same time/frequency resource assignment as the third resource, which occurs after the resource reservation period from the third resource. The sixth resource may be for a second retransmission of the second TB. The fourth resource and/or the fifth resource and/or the sixth resource may be referred to as reserved resources. For example, the first SCI may indicate, through time/frequency resource assignment fields and/or the resource reservation period field, reservation of the fourth resource and/or the fifth resource and/or the sixth resource.

FIG. 33 shows an example of resource conflict on two reserved resources in a resource pool.

As shown in FIG. 33, a first UE (UE #1) may receive/detect a first SCI (e.g., SCI format, SCI #1) from a second UE (UE #2). The first SCI may comprise one or more fields indicating reservation of one or more first resources for one or more first transmissions of the second UE. For example, the first SCI may indicate a first reserved resource (e.g., r1 or 1^{st} PSSCH resource). For example, the first SCI may indicate a time domain resource assignment (e.g., slot/mini-slot/symbol) and/or a frequency domain resource assignment (e.g., starting RB/interlace/subchannel and/or number of (consecutive) RBs/interlaces/subchannels) for the first reserved resource. For example, the first SCI may indicate that the first reserved resource is for transmission of a first SL TB of the second UE. The first UE may or may not be an intended receiver of the first TB. The first SCI may indicate a first priority/priority value (e.g., prio1 or p1) for the first SL TB and/or the first reserved resource.

The first UE may receive/detect a second SCI (e.g., SCI format, SCI #2) from a third UE (UE #3). The second SCI may comprise one or more fields indicating reservation of one or more second resources for one or more second transmissions of the third UE. For example, the second SCI may indicate a second reserved resource (e.g., r2 or 2^{nd} PSSCH resource). For example, the second SCI may indicate a time domain resource assignment (e.g., slot/mini-slot/symbol) and/or a frequency domain resource assignment (e.g., starting RB/interlace/subchannel and/or number of (consecutive) RBs/interlaces/subchannels) for the second reserved resource. For example, the second SCI may indicate that the second reserved resource is for transmission of a second SL TB of the third UE. The first UE may or may not be an intended receiver of the second TB. The second SCI may indicate a second priority/priority value (e.g., prio2 or p2) for the second SL TB and/or the second reserved resource.

The first UE may determine that the first reserved resource (r1) overlaps with the second reserved resource (r2). For example, the first reserved resource may fully or partially overlap with the second reserved resource in time and/or frequency domain. The first UE may determine a resource conflict occurring on the first reserved resource and the second reserved resource, based on the first reserved resource overlapping with the second reserved resource.

The first UE may determine that a second RSRP measurement performed for the second SCI (e.g., RSRP2) is higher than a threshold (e.g., Th(prio₂, prio₁)). For example, the first UE may be a destination (e.g., intended receiver) of the first TB to be transmitted in the first reserved resource by the second UE. The first UE may determine the threshold based on the first priority of the first transmission/TB/reserved resource/SCI (prio1) and/or the second priority of the second transmission/TB/reserved resource/SCI (prio2). For example, the first UE may receive a SL configuration parameter (ThresPSSCH-RSRP-List Th(pᵢ, pⱼ)) indicating a list of RSRP thresholds, comprising the threshold, for each priority combination (pᵢ, pⱼ). For example, the first UE may determine a resource conflict occurring on the first reserved resource and the second reserved resource, based on the second RSRP measurement of the second SCI being higher than the threshold. For example, a sidelink configuration parameter (e.g., optionForCondition2A1Scheme2) may indicate a first option (e.g., ‘RSRP-ThresPerPriorities’) is enabled for conditions of resource conflict.

The first UE may determine that a first RSRP measurement performed for the first SCI (e.g., RSRP1) is higher than a threshold (e.g., Th(prio₁, pri2)). For example, the first UE may be a destination (e.g., intended receiver) of the second TB to be transmitted in the second reserved resource by the third UE. The first UE may determine the threshold based on the first priority of the first transmission/TB/reserved resource/SCI (prio1) and/or the second priority of the second transmission/TB/reserved resource/SCI (prio2). For example, the first UE may receive a SL configuration parameter (ThresPSSCH-RSRP-List Th(pᵢ, pⱼ)) indicating a list of RSRP thresholds, comprising the threshold, for each priority combination (pᵢ, pⱼ). For example, the first UE may determine a resource conflict occurring on the first reserved resource and the second reserved resource, based on the first RSRP measurement of the first SCI being higher than the threshold. For example, a sidelink configuration parameter (e.g., optionForCondition2A1Scheme2) may indicate a first option (e.g., ‘RSRP-ThresPerPriorities’) is enabled for conditions of resource conflict.

The first UE may determine that a second RSRP measurement performed for the second SCI (e.g., RSRP2) is higher than a first RSRP measurement performed for the first SCI (e.g., RSRP1) by a value that is higher than a RSRP threshold (e.g., if RSRP₂>RSRP₁+Delta_Th). For example, the first UE may be a destination (e.g., intended receiver) of the first TB to be transmitted in the first reserved resource by the second UE. The first UE may receive a SL configuration parameter (deltaRSRPThresh) indicating the RSRP threshold (Delta_Th). For example, the first UE may determine a resource conflict occurring on the first reserved resource and the second reserved resource, based on the second RSRP measurement of the second SCI being above the first RSRP measurement of the first SCI by a delta that is higher than the RSRP threshold. For example, a sidelink configuration parameter (e.g., optionForCondition2A1Scheme2) may indicate a first option (e.g., ‘RSRP-ThresWithRsrpMeasurement’) is enabled for conditions of resource conflict.

The first UE may determine that a first RSRP measurement performed for the first SCI (e.g., RSRP1) is higher than a second RSRP measurement performed for the second SCI (e.g., RSRP2) by a value that is higher than a RSRP threshold (e.g., if RSRP₁>RSRP₂+Delta_Th). For example, the first UE may be a destination (e.g., intended receiver) of the second TB to be transmitted in the second reserved resource by the third UE. The first UE may receive a SL configuration parameter (deltaRSRPThresh) indicating the RSRP threshold (Delta_Th). For example, the first UE may determine a resource conflict occurring on the first reserved resource and the second reserved resource, based on the first RSRP measurement of the first SCI being above the second RSRP measurement of the second SCI by a delta that is higher than the RSRP threshold. For example, a sidelink configuration parameter (e.g., optionForCondition2A1Scheme2) may indicate a first option (e.g., ‘RSRP-ThresWithRsrpMeasurement’) is enabled for conditions of resource conflict.

The first UE may determine that the first reserved resource occurs in a slot in which the first UE does not expect to perform SL reception, e.g., due to half-duplex operation and/or UL transmission. For example, the first UE may be a destination (e.g., intended receiver) of the first TB to be transmitted in the first reserved resource by the second UE. For example, the first UE may determine a resource conflict occurring on the first reserved resource, based on the first reserved resource occurring in a time/slot that the UE may not perform SL reception.

The first UE may be enabled (e.g., by a SL configuration parameters inter-UECoordinationScheme2) to transmit a PSFCH with conflict information in a resource pool. The first UE may determine, based on an indication by the first SCI, a set of resources that includes one or more slots and resource blocks that are reserved for PSSCH transmission (e.g., comprising the first reserved resource). If the first UE determines a conflict for the first reserved resource for PSSCH transmission, the first UE provides conflict information in a PSFCH (e.g., via a PSFCH transmission), as shown in FIG. 33.

The first UE may receive a SL configuration parameter (e.g., sl-PSFCH-Conflict-RB-Set) indicating a set of PRBs in a resource pool for PSFCH transmission with conflict information in a PRB of the resource pool. In an example, different PRBs may be (pre)configured for conflict information and HARQ-ACK information. The first UE may determine a number of PSFCH resources/occasions available for multiplexing conflict information in a PSFCH transmission. For example, the number of PSFCH resources/occasions may be based on a number of cyclic shift pairs configured for the resource pool and/or a number of PRBs associated with a starting subchannel/interlace of the corresponding PSSCH. For example, for conflict information, the corresponding PSSCH may be determined based on a SL configuration parameter (e.g., PSFCHOccasionScheme2) indicating a reference slot for determining the slot comprising the PSFCH occasion. For example, the first UE may determine the number of PSFCH resources/occasions for conflict information based on a number of PRBs associated with a subchannel of the reference slot indicated by the SL configuration parameter for the PSFCH transmission with the conflict information.

The PSFCH resources/occasions may be first indexed according to an ascending order of the PRB index, and then according to an ascending order of the cyclic shift pair index.

The first UE may determine an index of a PSFCH resource/occasion for a PSFCH transmission with conflict information corresponding to the first reserved resource based on a physical layer source ID (e.g., PID) provided by a third SCI (e.g., SCI format 2-A/2-B/2-C) corresponding to the first SCI (e.g., SCI format 1-A). The first SCI indicates the first resource reservation by the second UE. The first UE may determine to transmit the conflict information to the second UE. The first UE may determine the index of the PSFCH resource/occasion based on the source ID of the second UE to which the PSFCH with the conflict information is to be transmitted.

The first UE may determine a UE, from the second UE and the third UE, to provide the conflict information to. The conflict information may indicate a resource conflict. For example, the first UE may transmit the conflict information to the second UE and/or the third UE. The first UE may transmit the conflict information in a PSFCH transmission. The PSFCH transmission comprising the conflict information may be associated/mapped to the first reserved resource and/or the second reserved resource. The PSFCH transmission comprising the conflict information may be associated/mapped to the second UE and/or the third UE.

The first UE may determine the second UE for providing/transmitting the conflict information to based on the first UE being an intended receiver (e.g., destination) of the second UE for the first reserved resource (e.g., the first TB). The conflict information may be for the second UE. For example, the conflict information may be associated with the first reserved resource of the second UE. For example, the conflict information may indicate a resource conflict associated with the first reserved resource indicated by the first SCI of (transmitted by) the second UE. In an example, the first UE may determine the second UE for providing/transmitting the conflict information to, based on the first UE not expecting to perform reception on the sidelink (e.g., SL reception), e.g., due to half-duplex operation, in the slot of the first reserved resource indicated by the first SCI of (transmitted by) the second UE. The first UE may determine to transmit to the second UE the PSFCH transmission with/comprising the conflict information.

In an example, the first UE may be indicated the first reserved resource and the second reserved resource as resources for PSSCH reception. For example, the first UE may be an intended receiver (e.g., destination) of the second UE for the first reserved resource (e.g., the first TB). For example, the first UE may be an intended receiver (e.g., destination) of the third UE for the second reserved resource (e.g., the second TB).

The first UE may receive the first SCI, from the second UE, indicating the first reserved resource and/or a first priority value (prio1 or p1). The first reserved resource may be for transmission of a first TB. The first reserved resource may be for a first PSSCH transmission from the second UE. The first TB and/or the first PSSCH transmission and/or the first SCI may be associated with the first priority/priority value. The first UE may receive the second SCI, from the third UE, indicating the second reserved resource and/or a second priority value (prio2 or p2). The second reserved resource may be for transmission of a second TB. The second reserved resource may be for a second PSSCH transmission from the third UE. The second TB and/or the second PSSCH transmission and/or the second SCI may be associated with the second priority/priority value. The first UE may determine that the first reserved resource and the second reserved resource overlap (e.g., fully or partially) in time and/or frequency.

The first UE may determine to transmit the conflict information to the second UE. For example, the first UE may determine that the first reserved resource and/or the first TB and/or the first PSSCH transmission of the second UE is less important than the second reserved resource and/or the second TB and/or the second PSSCH transmission of the third UE. For example, the first UE may determine that the second reserved resource/TB/PSSCH transmission is prioritized over the first reserved resource/TB/PSSCH transmission. For example, the first UE may determine that the second priority value (p2) in the second SCI is smaller than or equal to the first priority value (p1) in the first SCI, e.g., p2<p1 (note: lower priority value indicates higher physical layer priority/importance).

The first UE may determine to transmit the conflict information to the second UE. The first UE may be an intended receiver (e.g., destination) of the second UE for the first reserved resource (e.g., the first TB). For example, the first UE may receive a sidelink configuration parameter (e.g., typeAUEScheme2 or sl-TypeUE-A) indicating that a non-destination receiver UE of a TB (e.g., the first TB) cannot/may not send inter-UE coordination information (e.g., the conflict information) to the transmitter UE (e.g., the second UE) (e.g., typeAUEScheme2 or sl-TypeUE-A is disabled). For example, the first UE may be a destination UE of another TB (e.g., the second TB) conflicting with the TB (e.g., the first TB) transmitted by the transmitter UE (e.g., the second UE).

The first UE may determine to transmit the conflict information to the second UE. The first UE may not be an intended receiver (e.g., destination) of the second UE for the first reserved resource (e.g., the first TB). For example, the first UE may receive a sidelink configuration parameter (e.g., typeAUEScheme2 or sl-TypeUE-A) indicating that a non-destination receiver UE of a TB (e.g., the first TB) can/may send inter-UE coordination information (e.g., the conflict information) to the transmitter UE (e.g., the second UE) (e.g., typeAUEScheme2 or sl-TypeUE-A is enabled). For example, the first UE may be a destination UE of another TB (e.g., the second TB) conflicting with the TB (e.g., the first TB) transmitted by the transmitter UE (e.g., the second UE).

The first UE may determine to transmit the conflict information to either the second UE or the third UE. For example, the first UE may determine that the first reserved resource and/or the first TB and/or the first PSSCH transmission of the second UE is as important as the second reserved resource and/or the second TB and/or the second PSSCH transmission of the third UE. For example, the first UE may determine that the second priority value (p2) in the second SCI is equal to the first priority value (p1) in the first SCI, e.g., p2=p1.

The first UE may determine to transmit the conflict information to the second UE or the third UE. For example, the first SCI may comprise a field (e.g., indicationUEB flag) indicating that the second UE is a conflict information receiver (e.g., if flag is set to a first value, 1). For example, the field (e.g., indicationUEB flag) may indicate that the second UE can/may be a UE to receive conflict information. For example, the second SCI may comprise a field (e.g., indicationUEB flag) indicating that the third UE is a conflict information receiver (e.g., if flag is set to a first value, 1). For example, the field (e.g., indicationUEB flag) may indicate that the third UE can/may be a UE to receive conflict information. For example, the first UE may receive a SL configuration parameter (e.g., indicationUEBScheme2) indicating that indication of conflict information reception capability is enabled.

The first UE may determine to transmit the conflict information to the second UE or the third UE. For example, the first UE may determine that the first SCI and/or the second SCI are not received later than a time gap (e.g., sl-MinTimeGapPSFCH) before the PSFCH occasion for the conflict information. For example, the time gap may be a processing time required by the first UE to prepare the conflict information based on the first SCI and/or the second SCI. For example, the PSFCH occasion for transmitting the conflict information may be at least by the time gap after reception of the first SCI and/or the second SCI. The first UE may determine that the PSFCH occasion for/associated with the resource conflict information is valid.

The first UE may transmit the conflict information in/via a PSFCH occasion/resource. The conflict information may correspond to the first reserved resource indicated by/in the first SCI. The PSFCH occasion may be in a slot if the resource pool. The first UE may determine the slot based on a SL configuration parameter (e.g., PSFCHOccasionScheme2). For example, the SL configuration parameter may indicate a reference slot for determining the slot comprising the PSFCH occasion. For example, the first UE may determine the slot for PSFCH transmission with the conflict information based on the reference slot indicated by the SL configuration parameter. A first value of the SL configuration parameter (e.g., ‘followSCI’) may indicate that a slot where the first SCI is received is used as the reference slot. For example, the first UE may transmit the PSFCH with the conflict information in a first slot that includes PSFCH resources and/or is at least a number of slots (e.g., based on the PSFCH time gap) after a PSCCH reception comprising/providing the first SCI. The PSFCH occasion/resource may be in a slot that is at least T₃ slots before the resource associated with the conflict information (e.g., the first reserved resource). The first UE may not transmit the PSFCH with conflict information, otherwise. A second value of the SL configuration parameter (e.g., ‘followReservedResource’) may indicate that a slot where expected/potential resource conflict occurs on the first PSSCH resource indicated/reserved by the first SCI is used as the reference slot. For example, the first UE may transmit the PSFCH with the conflict information in a latest slot that includes PSFCH resources and/or is at least T₃ slots before a slot of the resource associated with conflict information (e.g., the first reserved resource). The PSFCH occasion/resource may be in a slot that is at least a number of slots (e.g., based on the PSFCH time gap) after a slot of a PSCCH reception that provides the SCI. The first UE may not transmit the PSFCH with conflict information, otherwise.

The first UE may transmit the conflict information via/in the PSFCH transmission. As shown in FIG. 33., the first UE may determine a priority value of the PSFCH transmission with the conflict information. For the PSFCH transmission with conflict information, the priority value for the PSFCH may be equal to the smallest priority value determined by the corresponding SCI formats (e.g., SCI formats 1-A) for the conflicting resources. For example, the first UE may determine the priority value of the PSFCH transmission with the conflict information based on the first priority value in the first SCI (p1) and/or the second priority value in the second SCI (p2). For example, the priority value of the PSFCH transmission with the conflict information may be equal to a smallest priority value between the first priority value and the second priority value, e.g., min(p1, p2).

For PSFCH reception with conflict information, a priority value for the PSFCH may be equal to the priority value determined by the corresponding SCI format (e.g., SCI format 1-A) for the conflicting resource. For example, the second UE receiving the PSFCH with the conflict information, from the first UE, may determine a priority of the PSFCH reception based on the first priority of the first reserved resource indicated in the first SCI.

PSFCH transmissions in a slot may have a same priority value as the smallest priority value among PSSCH receptions with corresponding HARQ-ACK information provided by the PSFCH transmissions in the slot, if any. PSFCH transmissions in a slot may have a same priority value as the smallest priority value among PSFCH transmissions with conflict information in the slot, if any, where each priority value is equal to the smallest priority value determined by corresponding SCI formats (e.g., the first SCI and the second SCI associated with the resource conflict).

PSFCH receptions in a slot may have a same priority value as the smallest priority value among PSSCH transmissions with corresponding HARQ-ACK information provided by the PSFCH receptions in the slot, if any. PSFCH receptions in a slot may have a same priority value as the smallest priority value among PSFCH receptions with conflict information in the slot, if any, where each priority value is equal to the priority value determined by corresponding SCI format.

The second UE may receive the PSFCH with the conflict information. The second UE may determine the resource conflict on the first reserved resource based on the PSFCH reception. The second UE may determine that the first reserved resource overlaps with a conflict resource. If a next resource of the selected sidelink grant which has been indicated by a prior SCI is overlapped with conflict resource(s) indicated by the physical layer, the second UE may remove the resource from the selected sidelink grant associated to the Sidelink process. For example, the second UE may determine to remove the first reserved resource from a selected SL grant for transmission of the first TB. The second UE may trigger resource reselection in response to receiving the conflict information. For example, the second UE may randomly select time and frequency resource(s) from a set of resources indicated by the physical layer excluding the conflict resource(s) for the removed resource. The second UE may replace the removed resource by the selected resource for the selected sidelink grant.

A UE may use the priority (e.g., physical layer priority) of a SL transmission to determine whether to transmit the SL transmission, e.g., when the SL transmission overlaps with a second SL transmission or an UL transmission. The UE may use the priority (e.g., physical layer priority) of the SL transmission to determine a transmission power of the SL transmission, e.g., when the SL transmission overlaps with a second SL transmission or an UL transmission. For example, the UE may determine a plurality of transmissions, comprising at least one SL transmission and/or at least one UL transmission, that overlap in time and frequency. The UE may determine which transmissions of the plurality of transmissions to transmit based on its simultaneous transmission capability and the respective priority of each transmission of the plurality of transmissions. For example, the UE may transmit one or more first transmissions (including SL transmission(s) and/or UL transmissions) of the plurality of transmissions that have the highest priorities. For example, the UE may drop (e.g., not transmit) one or more second transmissions (including SL transmission(s) and/or UL transmissions) of the plurality of transmissions that have the lowest priorities. The UE may determine transmission power of the plurality of transmissions based on a configured maximum transmission power (total) and the respective priority of each transmission of the plurality of transmissions. For example, the UE may allocate transmission power to one or more first transmissions (including SL transmission(s) and/or UL transmissions) of the plurality of transmissions that have the highest priorities. For example, the UE may not allocate power (e.g., not transmit) one or more second transmissions (including SL transmission(s) and/or UL transmissions) of the plurality of transmissions that have the lowest priorities. For example, the UE may allocate transmission power to the plurality of transmissions in the order of respective priorities.

A SL transmission may be a PSFCH transmission. The PSFCH transmission may comprise one or more HARQ-ACK information of one or more SL TBs. The PSFCH transmission may comprise one or more conflict information of one or more SL resource conflicts.

A first UE may receive a first SCI (e.g., SCI format 1-A or 1-B) via a PSCCH reception. The first SCI may schedule a PSSCH reception. The PSSCH reception may comprise a second SCI and a SL TB. The first UE may determine to be the intended receiver (e.g., the destination UE) of the SL TB. For example, a destination ID of the UE may match the destination ID indicated by a second SCI (e.g., SCI format 2-A or 2-B or 2-C) of the PSSCH reception. The first SCI may indicate to the first UE (e.g., the intended receiver) to transmit a PSFCH with HARQ-ACK information in response to the PSSCH reception. The first UE may provide HARQ-ACK information that comprises ACK or NACK, or only NACK.

The first UE may be provided (e.g., by RRC parameter sl-PSFCH-Period) a number of slots in a resource pool for a period of PSFCH transmission occasion resources. If the number is zero, PSFCH transmissions from the UE in the resource pool are disabled. The first UE may determine slots in the resource pool that have a PSFCH transmission occasion resource based on the period of the PSFCH transmission occasion resources. In an example, the second SCI associated with the PSSCH reception may comprise a HARQ feedback enabled/disabled indicator field that has a first value (e.g., 1). The first UE may provide/transmit the HARQ-ACK information of the PSSCH reception in a PSFCH transmission in the resource pool. The first UE may transmit the PSFCH in a first slot that includes PSFCH transmission occasion resources and/or is at least a number of slots (e.g., provided by RRC parameter sl-MinTimeGapPSFCH) of the resource pool after a last slot of the PSSCH reception.

The first UE may determine a number of PSFCH resources available for multiplexing HARQ-ACK information in a PSFCH transmission occasion resource (e.g., in at least one symbol of a slot) based on: a number of cyclic shift pairs for the resource pool; and a number of PRBs associated with the starting sub-channel of the corresponding PSSCH. The first UE may determine indexes of the PSFCH resources according to an ascending order of the PRB index, followed by an ascending order of the cyclic shift pair index.

The first UE determines an index of a PSFCH resource for the PSFCH transmission with HARQ-ACK information in response to the PSSCH reception based on a physical layer source ID provided by the second SCI associated with (e.g., scheduling) the PSSCH reception, and/or an identity of the first UE receiving the PSSCH (e.g., physical layer destination ID), e.g., indicated by higher layers.

The first UE may determine a priority value of the PSFCH transmission with/comprising the HARQ-ACK information based on a priority value indicated by the first SCI associated with the PSFCH resource. For example, the priority value of the PSFCH transmission may be equal to the priority value indicated by the first SCI. the first SCI may be a SCI format 1-A scheduling the PSSCH reception that is associated with the PSFCH resource. For example, the first UE may transmit the HARQ-ACK of the PSSCH reception via the PSFCH resource. The priority value of the PSFCH transmission with the HARQ-ACK information may be equal to the priority value of the corresponding PSSCH reception (TB) whose HARQ-ACK is to be transmitted via the PSFCH transmission.

FIG. 34 shows an example of PSFCH transmission with HARQ-ACK information. A UE may receive/detect a SCI scheduling a PSSCH. The PSSCH may comprise a TB and a second SCI. The UE may determine to be the intended receiver (e.g., the destination UE) of the TB in the PSSCH, e.g., based on the destination ID in the second SCI. The UE may receive the PSSCH based on the information fields in the SCI. The SCI may comprise a priority field indicating a first priority value (e.g., P1). The UE may determine a priority of the PSSCH reception and/or the TB to be equal to the first priority value (P1). The UE may or may not successfully receive the TB multiplexed in the PSSCH. The UE may transmit (e.g., report or provide) a feedback information (e.g., HARQ-ACK information) of the TB via a PSFCH transmission. As shown in FIG. 34, the UE may determine a priority of the PSFCH transmission to be equal to the first priority value (P1).

In an example, the PSFCH transmission may be on a resource pool that is configured in an unlicensed SL BWP/carrier. For example, the SL BWP and/or SL carrier may be configured for operation with shared spectrum.

The UE may perform at least one channel access procedure (LBT procedure) prior to the PSFCH transmission. For example, the UE may perform a Type 1 LBT procedure. For example, the UE may determine that the PSFCH resource/transmission is not within a COT duration. The UE may determine a channel access priority class (CAPC) for the PSFCH transmission.

The SCI, as shown in FIG. 34, may comprise a field indicating a first CAPC value (e.g., CAPC1). For example, a transmitter UE may have transmitted the SCI (e.g., the PSCCH comprising the SCI and the corresponding PSSCH) based on an LBT procedure (e.g., Type 1 LBT procedure) using the first CAPC value. For example, the PSCCH/PSSCH transmission may be associated with the first CAPC value. For example, the transmitter UE may have initiated a COT based on the first CAPC value. For example, the transmitter UE may have transmitted the SCI/PSSCH/PSCCH in a COT that is initiated based on the first CAPC value. For example, the first CAPC value may indicate the channel access priority class associated with the data multiplexed in the PSSCH, e.g., representing how important it is to quickly access the shared spectrum to transmit this data.

The PSFCH transmission comprising/with the HARQ-ACK information of the TB/PSSCH reception indicated by the SCI may be associated with the same channel access priority class as the TB/PSSCH reception/transmission. For example, accessing channel for transmitting feedback of a data reception may be as important as accessing channel for transmitting the data itself. The UE may determine the CAPC value associated with the PSFCH transmission with the HARQ-ACK information to be equal to the first CAPC value (CAPC1). As shown in FIG. 34, the UE may perform an LBT procedure (LBT Type 1 procedure) prior to the PSFCH transmission with the HARQ-ACK information of the PSSCH reception. The LBT procedure may be based on the first CAPC value. The SCI scheduling the PSSCH reception may indicate the first CAPC value.

Throughout this disclosure the terms “CAPC” and “CAPC value” (or a value of CAPC) may be used interchangeably when referring to the general concept of channel access priority. “CAPC value” may specifically refer to a value or quantity of a parameter or field indicating CAPC. For example, a CAPC may take a quantity represented by the CAPC value, as shown in FIG. 30. Note that a smaller/lower CAPC value indicates a higher CAPC (e.g., a larger/higher channel access priority class and/or a larger/higher channel access priority).

In the existing technology, the CAPC value of a PSFCH transmission may be equal to the CAPC value of the corresponding PSSCH transmission, e.g., indicated by the scheduling SCI. However, this may only work for PSFCH transmission comprising HARQ-ACK information. A PSFCH transmission may comprise conflict information. For PSFCH transmission with conflict information, the existing technology may not be able to determine the appropriate CAPC value, because a conflict information is associated with at least two conflicting PSSCH transmissions. The conflict information (e.g., based on inter-UE coordination scheme 2) may indicate collision/overlap of two reserved resources (PSSCH/PSCCH resources), each indicated by a respective detected SCI. In fact, as opposed to PSFCH comprising HARQ-ACK information, there is no one-to-one correspondence/association between a PSFCH comprising conflict information and a PSSCH/PSCCH transmission. The two reserved resources may be associated with different CAPC values. For example, each of the two conflicting PSSCH resources may be reserved/indicated by a SCI which indicates a different CAPC value from the other one. Based on the existing technology, a UE transmitting a PSFCH with conflict information may not be able to determine a CAPC value for performing LBT and/or determining/sharing a COT.

Referring to FIG. 33, a first UE (UE #1) may receive/detect a first SCI (SCI #1), from a second UE (UE #2) indicating a first reserved resource (1^{st} PSSCH resource). The first SCI may indicate a first CAPC value (CAPC1). The first UE may receive/detect a second SCI (SCI #2), from a third UE (UE #3) indicating a second reserved resource (2^{nd} PSSCH resource). The second SCI may indicate a second CAPC value (CAPC2). The UE may determine the first reserved resource and the second reserved resource overlap in time and frequency. The UE may determine a resource conflict based on the first SCI and the second SCI. The UE may determine to transmit a conflict information, indicating the determined resource conflict, in a PSFCH transmission. The UE may perform an LBT procedure for the PSFCH transmission. Based on the existing technology, the UE may not be able to determine an appropriate CAPC value for the PSFCH transmission comprising conflict information. This is while CAPC is a key enabler of successful and fair channel access of all devices and technologies to the shared/unlicensed spectrum.

The first UE may determine a first slot for the PSFCH transmission with the conflict information based on a reference slot (e.g., indicated by a SL configuration parameter). The first UE may determine the first slot based on the transmitter UE (Tx UE, or UE-B) to whom it intends to transmit the PSFCH with the conflict information, e.g., the conflicting UE with the larger reservation priority value (e.g., lower priority). In the example of FIG. 33, the first UE transmits the PSFCH with the conflict information to the second UE (UE #2). For example, P1>P2. The first UE may determine the first slot for PSFCH transmission based on a reference slot associated with a transmission of the second UE (e.g., the conflicting UE who should preempt). For example, the reference slot may be a slot where the first SCI is received. The reference slot may be a slot where expected/potential resource conflict occurs on the first PSSCH resource indicated/reserved by the first SCI.

The first UE may determine a first PSFCH resource/occasion (e.g., in the first slot) for the PSFCH transmission with the conflict information based on a source ID of the transmitter UE (Tx UE, or UE-B) to whom it intends to transmit the PSFCH with the conflict information, e.g., the conflicting UE with the larger reservation priority value (e.g., lower priority), e.g., UE #2 in FIG. 33. The first UE may determine the first PSFCH resource based on the source ID indicated by a PSSCH (second stage SCI or SCI format 2-A/2-B/2-C) corresponding to the first SCI (SCI #1, e.g., SCI format 1-A).

Time and/or frequency resource (e.g., slot and RB) of the PSFCH transmission with conflict information may be determined based on one of the conflicting SCIs/PSSCHs (e.g., the second SCI in FIG. 33) reserving the resource from the UE to be provided with the conflict information (e.g., UE #2 in FIG. 33). For example, time and/or frequency resource of the PSFCH transmission with conflict information may be determined based on a corresponding PSSCH involved in the resource conflict that is reserved by a SCI indicating a larger priority value (e.g., P1 in FIG. 33 where P2<P1). However, the PHY priority value of the PSFCH transmission with conflict information may be determined differently. For example, the priority value of the PSFCH transmission may be equal to the smallest priority value determined by the two corresponding SCIs (SCI #1 and SCI #2) for the conflicting resources (e.g., P2 in FIG. 33 where P2<P1).

Based on the existing technology, there may be no specific or unique association between the PSFCH with a conflict information and one of the two (or more) SCIs reserving the conflicting resources. The existing technology fails to define a specific PSSCH and/or SCI associated with a PSFCH transmission with conflict information for the purpose of CAPC determination for the PSFCH transmission. There is a need to design a mechanism for determination of CAPC associated with a PSFCH transmission with conflict information.

Referring to FIG. 33, the first SCI may indicate a first priority value (P1) for the first reserved resource. The second SCI may indicate a second priority value (P2) for the second reserved resource. The first UE may determine a third priority value (physical layer priority, P3) for the PSFCH transmission comprising conflict information of the first reserved resource and the second reserved resource based on the first priority value and/or the second priority value. For example, a priority value of the PSFCH transmission with conflict information may be equal to the smallest priority value between the first priority value (P1) and the second priority value (P2), e.g., P3=min (P1, P2). The first UE may transmit the PSFCH with the conflict information to one of the UEs with the lower priority (e.g., the second UE, UE #2 in FIG. 33). The first UE may determine some physical layer behaviors and/or parameters based on the third priority value. For example, the first UE may determine prioritization of simultaneous SL and/or UL transmissions based on the third priority value. The first UE may determine whether to transmit the PSFCH transmission based on the third priority value. The first UE may determine a transmission power of the PSFCH transmission based on the third priority value. For example, the third priority value may be used in internal procedures/behaviors/parameters of the first UE.

For example, the second UE may receive the PSFCH transmission with the conflict information. The second UE may determine a fourth priority for the PSFCH reception. The second UE may determine that the conflict information is associated with a resource conflict on the first reserved resource indicated by the first SCI, e.g., based on the mapping/association between the PSFCH resource and the first SCI and/or the first reserved resource. The second UE may determine the fourth priority value (physical layer priority, P4) for the PSFCH reception comprising conflict information of the first reserved resource, based on the first priority value. For example, a priority value of the PSFCH reception with conflict information may be equal to the first priority value (P1), e.g., P4=P1. The second UE may determine some physical layer behaviors and/or parameters based on the fourth priority value. For example, the second UE may determine prioritization of simultaneous SL reception(s) and/or UL transmission(s) based on the fourth priority value. The second UE may determine whether to receive the PSFCH transmission based on the fourth priority value. For example, the fourth priority value may be used in internal procedures/behaviors/parameters of the second UE. Therefore, the third priority value (P3) for PSFCH transmission and the fourth priority value (P4) for PSFCH reception are independently determined and have different values.

As opposed to physical layer priority, the channel access priority class (CAPC) is not an internal UE parameter. In fact, the CAPC value may be used to facilitate fair and efficient access of different users and radio access technologies (RATs) to the shared spectrum. Based on the CAPC, each user can access the unlicensed channel in a way that important information/data can be efficiently (e.g., quickly) transmitted and at the same time fairness among different users and RATs and services is maintained. Therefore, as opposed to PHY priority, CAPC is a means to manage the multiple access challenges and collisions among nodes/UEs by enabling access prioritization between nodes/UEs (and not internal UE prioritization procedures), through LBT and/or COT sharing. For example, the CAPC value may be used to determine a contention window size for the LBT Type 1 procedure when performing a transmission. In another example, a UE may receive a COT sharing indication, indicating a first CAPC value associated with the COT (e.g., used for COT initiation). The UE may use the CAPC value of a first transmission to determine whether it can share a COT (e.g., use a shared COT) for the first transmission with the said CAPC value or not. For example, regulations may allow COT sharing if a the CAPC value is lower/smaller than or equal to the first CAPC value used for initiation of the COT (e.g., only more important transmissions with higher or equal priority are allowed in the COT). For example, the regulations may not allow COT sharing if a the CAPC value is higher than the first CAPC value used for initiation of the COT (e.g., less important transmissions with lower priority are not allowed in the COT). Thus, when a first UE transmits a first transmission and initiates a COT based on a Type 1 LBT with the first transmission and shares the COT with a second UE, and when the second UE receives the COT sharing indication and determines to share the COT for a second transmission, a same/unique CAPC value should be used by both UEs. So, as opposed to the PHY priority, transmissions and receptions of a same signal/packet/message cannot have independent or different CAPC values, due to the system level role of the CAPC value. Consequently, it may not be possible or efficient, for CAPC determination of PSFCH with conflict information, to follow the priority determination mechanism.

For a sidelink transmission (e.g., TB and/or PSSCH and/or PSFCH and/or feedback information and/or conflict information), the PHY priority value and the CAPC value may be determined differently. For example, the PHY priority and the CAPC of a TB may be determined based on the logical channels (and/or MAC CEs) multiplexed in the TB. For example, each logical channel may be configured/associated with a logical channel priority and/or a CAPC value. Referring to FIG. 31A and FIG. 31B, if only STCH (SL DRB) SDUs are multiplexed in a TB, the CAPC of the TB is equal to the highest CAPC value of logical channels (STCHs) with MAC SDUs multiplexed in the TB. However, the PHY priority of the TB may be determined based on the lowest priority value of the logical channels multiplexed in the TB. In fact, the PHY priority and the CAPC of a TB may not necessarily be representative of or related to a same logical channel (e.g., data or information). Therefore, determination of priority value and CAPC value may not follow a same logic.

For example, referring to FIG. 33, the first priority value of the first reserved resource indicated by the first SCI may be larger than the second priority value of the second reserved resource indicated by the second SCI (P1>P2). In an example, the first CAPC value indicated by the first SCI may be larger than the second CAPC value indicated by the second SCI (CAPC1>CAPC2). But, in another example with the same priority values (P1>P2), the first CAPC value indicated by the first SCI may be smaller than the second CAPC value indicated by the second SCI (CAPC1<CAPC2), e.g., depending on the type of logical channels and/or MAC-CEs multiplexed in the TB to be transmitted in the first reserved resource or the second reserved resource. In both examples, the priority value of the PSFCH comprising the conflict information associated with the first SCI and the second SCI may be equal to the smaller priority value (P2). However, the existing technology may fail to enable determination of the CAPC value associated with the PSFCH comprising the conflict information in such examples.

For example, the lowest CAPC value of the two SCIs associated with the resource conflict is used for the CAPC of the PSFCH transmission with the conflict information. For example, if in FIG. 33, P1>P2 but CAPC1<CAPC2 (e.g., the second transmission has a higher PHY priority but a lower channel access priority), then for the PSFCH transmission with the conflict information, P3=P2 and CAPC3=CAPC1. In this example, the second transmission of UE #3 reserved by SCI #2 may be more important (has a higher physical priority or lower priority value) than the first transmission of UE #2 reserved by SCI #1. So, the transmission of the PSFCH with the conflict information may be at least as important as the second transmission (P3=P2). However, for CAPC, if the lower CAPC value of the other conflicting resource is used for the PSFCH with conflict information (CAPC3=CAPC1), then it might be unfair to other transmissions in the unlicensed band and against the regulations of the unlicensed spectrum.

On the other hand, if a too high CAPC value (with low priority) is used for transmission of the PSFCH with conflict information, it may be inefficient and result in a long LBT (e.g., long sensing and backoff duration in LBT procedure), which increases the likelihood of LBT failure for the transmission of the conflict information, resulting in collision on the conflicting resources and failure of both transmissions. Whereas if the conflict information was successfully transmitted based on a successful LBT with a low CAPC, then both transmissions could survive.

In an example and for transmission of a PSFCH comprising conflict information, a UE may use a too small CAPC value with a too high channel access priority, this may be unfair to other devices having transmissions in the same RB set, e.g., if the conflict information is not as vital. In another example, the UE may use a too large CAPC value with a too low channel access priority, this may be inefficient in terms of successfully accessing the channel and performing the transmission, e.g., if the conflict information is vital. Therefore, it is important, for a balance of QoS consideration and fairness, to determine the CAPC of the PSFCH with conflict information properly.

Embodiments enable determination of a reference PSSCH/SCI for CAPC value determination of a PSFCH transmission comprising conflict information. In an embodiment, the CAPC value of the PSFCH with conflict information may be determined based on the CAPC value of the prioritized data/transmission involved in the conflict. For example, the conflict information may be transmitted to help the prioritized transmission survive, therefore, it may have the same urgency as the data/transmission itself. To abide by the regulations of the unlicensed spectrum, it may be desired and fair to transmit the conflict information based on the same urgency (channel access priority class) as the intended transmission (the prioritized transmission), as opposed to the urgency (channel access priority class) of a more urgent conflicting transmission (deprioritized transmission which may be more urgent).

Embodiments enable CAPC determination for PSFCH transmission with conflict information such that a balance between QoS considerations and fairness is achieved. In an embodiment, the CAPC value of the PSFCH with conflict information may be determined based on a lowest/smallest CAPC value of the data/transmissions involved in the conflict. This may facilitate successful transmission of the conflict information, which not only helps the prioritized transmission to survive, but also helps the deprioritized/conflicting transmission to select a different resource and avoid collision.

In an embodiment, the CAPC value of the PSFCH with conflict information may be determined based on both CAPC values of the data/transmissions involved in the conflict. In an embodiment, the CAPC value of the PSFCH with conflict information may be determined based on both priority values of the data/transmissions involved in the conflict. For example, a table/matrix of CAPC values may be (pre)configured or (pre)defined for each pair of PHY priority value or each pair of CAPC value associated with the two SCIs reserving conflicting resources. This may enable more control over the conflict situation depending on the specific combination of control channels involved in the conflict.

Embodiments enable CAPC determination for PSFCH transmission with conflict information by consideration of the status of the unlicensed spectrum. For example, based on whether other RATs are present in the unlicensed band or not, the criteria of CAPC determination for PSFCH transmission with conflict information may be different according to some embodiments. In an embodiment, an RRC message may indicate, via a parameter, what CAPC value should be used for the PSFCH with conflict information. In an embodiment, an RRC message may indicate, via a parameter, which PSSCH/SCI should be the reference PSSCH/SCI for CAPC determination of the PSFCH with conflict information. Embodiments improve transmission of inter-UE coordination scheme 2 in unlicensed spectrum, enhance channel access, and promote fairness in accessing the unlicensed spectrum.

In an embodiment, a UE may determine a CAPC value of a PSFCH transmission comprising conflict information based on at least one of a first SCI and a second SCI indicating the conflicting reserved resources. In an embodiment, the UE may determine the CAPC value of the PSFCH transmission comprising the conflict information based on a CAPC value indicated by one of the first SCI and the second SCI. In an embodiment, the UE may determine the CAPC value of the PSFCH transmission comprising the conflict information based on a CAPC value indicated by an SCI, among the first SCI and the second SCI, that indicates a lower priority value. In an embodiment, the UE may determine the CAPC value of the PSFCH transmission comprising the conflict information based on a CAPC value indicated by an SCI, among the first SCI and the second SCI, whose RSRP measurement is higher than a threshold.

FIG. 35 shows an example of transmitting conflict information. A first UE (UE #1) may be in the communication range of a second UE (UE #2). The first UE may be in the communication range of a third UE (UE #3). For example, the second UE and the third UE my nit in the communication range of each other (e.g., hidden node). The second UE may transmit a first SCI (SCI #1) to reserve a first SL resource. The third UE may transmit a second SCI (SCI #2) to reserve a second SL resource. The first UE may receive the first SCI and the second SCI.

For example, the first UE may receive the first SCI indicating a first reserved resource (r1). For example, the first UE may receive the second SCI indicating a second reserved resource (r2). The first UE may determine a resource conflict on the first reserved resource and the second reserved resource. For example, the first reserved resource and the second reserved resource may overlap in time and frequency (e.g., r1 overlaps with r2). The first UE may determine conflict of the first reserved resource and the second reserved resource. The first SCI may indicate a first priority value (P1) and/or a first CAPC value (CAPC1). The second SCI may indicate a second priority value (P2) and/or a second CAPC value (CAPC2).

The first UE may determine a first RSRP measurement (RSRP1) of the first SC. The first UE may determine a second RSRP measurement (RSRP2) of the second SC. The first UE may determine the resource conflict of the first reserved resource and the second reserved resource based on at least one of the RSRP measurements.

In an example, the first UE may determine that the RSRP of the third UE (UE #3) is above a threshold. For example, the RSRP measured on the second SCI (RSRP2) may be above the threshold. In an example, the second RSRP (e.g., the RSRP measurement of the second SCI, RSRP2) may be higher than the first RSRP (e.g., the RSRP measurement of the first SCI, RSRP1), at least by a RSRP threshold (e.g., delta). The first UE may determine to be the intended receiver (destination) of a first transmission scheduled by the first SCI. For example, the first UE may be the intended receiver (destination) of a first transmission to be transmitted by the first reserved resource. For example, the destination ID in the second stage SCI (SCI format 2-A/2-b/2-C) associated with the first SCI may match the destination ID of the first UE. The first UE may determine the resource conflict of the first and the second reserved resources.

In an example, the first UE may determine that the RSRP of the second UE (UE #2) is above a threshold. For example, the RSRP measured on the first SCI (RSRP1) may be above the threshold. In an example, the first RSRP (e.g., the RSRP measurement of the first SCI, RSRP1) may be higher than the second RSRP (e.g., the RSRP measurement of the second SCI, RSRP2), at least by a RSRP threshold (e.g., delta). The first UE may determine to be the intended receiver (destination) of a second transmission scheduled by the second SCI. For example, the first UE may be the intended receiver (destination) of a second transmission to be transmitted by the second reserved resource. For example, the destination ID in the second stage SCI (SCI format 2-A/2-b/2-C) associated with the second SCI may match the destination ID of the first UE. The first UE may determine the resource conflict of the first and the second reserved resources.

The threshold of RSRP measurement may be configured by RRC signaling. For example, one or more RRC parameters may indicate a value of the threshold. The threshold may be based on the first priority in the first SCI and the second priority in the second SCI (e.g., Th(p₂, p₁)). In an example, the RSRP threshold/delta may be configured by RRC signaling (e.g., Delta_Th).

In response to determining the resource conflict, the first UE may determine one of the second UE and the third UE for providing the conflict information to. For example, the first UE may transmit a PSFCH comprising a conflict information indicating the resource conflict to at least one of the second UE and the third UE. For example, the first UE may determine that the first priority value, indicated by the first SCI, is larger/higher than the second priority value, indicated by the second SCI (P2<P1 in FIG. 35). The first UE may determine to transmit to the second UE the PSFCH with the conflict information. For example, the first priority value, indicated by the first SCI, may be equal to the second priority value, indicated by the second SCI (P2=P1). For example, the first UE may determine the second UE as the conflicting UE. In response to receiving the PSFCH with the conflict information, the second UE may discard/drop/cancel the first reservation and/or trigger reselect reselection by removing the first reserved resource from the candidate resource set. For example, the third UE may perform a transmission via the second reserved resource (r2). For example, the second UE may select a third resource (e.g., r3) for the transmission.

In an embodiment, the first UE may transmit the conflict information based on a third CAPC value (CAPC3 in FIG. 35). The first UE may determine the third CAPC value based on at least one of the first CAPC value and the second CAPC value. For example, the first CAPC value may be equal to the second CAPC value, and the first UE may determine the third CAPC value to be equal to the first and second CAPC value (CAPC3=CAPC1=CAPC2). In another example, the first CAPC value and the second CAPC value may be different. The first UE may determine the third CAPC value based on one of the first CAPC value and the second CAPC value that is indicated by the conflicting UE (e.g., UE #2 in FIG. 35). For example, the conflicting UE may be the UE with the SCI indicating a lower priority. For example, the conflicting UE may be the UE with the lower RSRP measured by the first UE (e.g., lower from the other UE's RSRP and/or lower than a RSRP threshold). For example, the conflicting UE may be the UE to whom the conflict indication is to be transmitted. For example, the third CAPC value may be equal to a CAPC value indicated by one of the SCIs reserving the conflicting resources.

For example, the third CAPC value may be equal to a CAPC value indicated by one of the first SCI and the second SCI that indicates a lower priority value (e.g., corresponding to a higher priority reservation). In the example of FIG. 35, the second SCI may comprise a priority field indicating the second priority value, and the second priority value (P2) may be lower/smaller or equal to a first priority value. For example, the first SCI may comprise a field indicating the first priority value (P1, where P1>P2). The first UE may determine a third priority value of the PSFCH transmission with the conflict information to be equal to the lowest priority value indicated by the two SCIs. For example, the third priority value may be equal to the second priority value (P3=P2). In this example, the first UE may determine the third CAPC to be equal to the CAPC value associated with the lower/smaller priority value (e.g., P2). For example, the third CAPC value may be equal to the second CAPC value (CAPC3=CAPC2). In an embodiment, the priority value and the CAPC value of the PSFCH with conflict information may be based on one of the SCIs (involved in the conflict, e.g., indicating conflicting reserved resources) indicating the lowest priority value. The first UE may perform an LBT based on the third CAPC value to transmit the PSFCH comprising the conflict information. The conflict information may enable successful transmission of the third UE indicated/reserved by the second SCI which has a higher priority (lower priority value) than the transmission of the second UE indicated/reserved by the first SCI. Therefore, the CAPC of the conflict information may be based on the CAPC of the second SCI, and/or irrespective of the CAPC of the first SCI. This may result in an appropriate LBT procedure and a fair channel access proportional to the class (CAPC) of the intended transmission.

For example, the third CAPC value may be equal to a CAPC value indicated by one of the first SCI and the second SCI that is received with a higher RSRP. For example, the third CAPC value may be equal to a CAPC value indicated by one of the first SCI and the second SCI whose RSRP is above the threshold. In the example of FIG. 35, the first UE may receive the second SCI with the second RSRP (RSRP2) that is above the threshold (e.g., RSRP2>Th(P1, P2)). In an example, the second RSRP may be higher than the first RSRP (RSRP1) measured on the first SCI (e.g., RSRP2>RSRP1). In an example, the second RSRP may be higher than the first RSRP (RSRP1) measured on the first SCI by at least a threshold/delta value (e.g., RSRP2>RSRP1+Delat_Th). In this example, the first UE may determine the third CAPC to be equal to the CAPC value associated with the higher RSRP (e.g., RSRP2). For example, the third CAPC value may be equal to the second CAPC value (CAPC3=CAPC2). The first UE may perform an LBT based on the third CAPC value to transmit the PSFCH comprising the conflict information. The conflict information may enable successful transmission of the third UE indicated/reserved by the second SCI which has a higher RSRP (lower priority value) and is more likely to be successful.

In an embodiment, a UE may determine a CAPC value of a PSFCH transmission comprising conflict information based on at least one of a first SCI and a second SCI indicating the conflicting reserved resources. In an embodiment, the UE may determine the CAPC value of the PSFCH transmission comprising the conflict information based on a lower CAPC value among a first CAPC indicated by the first SCI and a second CAPC value indicated by the second SCI. In an embodiment, the UE may determine the CAPC value of the PSFCH transmission comprising the conflict information to be equal to a smallest CAPC value among a first CAPC indicated by the first SCI and a second CAPC value indicated by the second SCI.

In the example of FIG. 33 or FIG. 35, the first SCI may indicate the first CAPC value, and/or the second SCI may indicate the second CAPC value. For example, the first SCI may comprise a field indicating the first CAPC value. For example, the first SCI and/or the second SCI may comprise a COT sharing indication. The COT sharing indication may indicate the first CAPC value associated with the COT (e.g., used in the LBT procedure initiating the COT). For example, first SCI may schedule a first PSSCH for a first TB transmission (e.g., in the same slot). The first SCI may indicate the first CAPC value of/associated with the first TB and/or the first PSSCH. In an embodiment, the first CAPC value may be associated with the intended transmission in the first reserved resource. In an example, the first UE may determine the first CAPC value based on an information field in the first SCI (e.g., the priority field). For example, the first UE may determine the first CAPC value based on the first priority value indicated by the first SCI. In an example, the first UE may determine the first CAPC value based on an information field in a second stage SCI scheduled by the first SCI. In an example, the first PSSCH and/or the first TB comprise a field indicating the first CAPC value.

The first UE may determine the first CAPC value associated with the first SCI and the second CAPC value associate with the second SCI, e.g., as described above. For example, the first CAPC value may be lower/smaller than the second CAPC value (CAPC1<CAPC2). For example, the first CAPC value may be equal to the second CAPC value (CAPC1=CAPC2). In an embodiment, the first UE may determine the third CAPC of the PSFCH transmission with the conflict information to be equal to the smallest/lowest CAPC value (e.g., CAPC1). For example, the third CAPC value may be equal to the first CAPC value (CAPC3=CAPC1). For example, the CAPC value of the PSFCH with the conflict information may be equal to the smallest CAPC value (e.g., highest channel access priority) associated with or indicated by the SCIs reserving the conflicting resources. In the above example, the third priority value of the PSFCH transmission is equal to the second priority value (the smallest priority value). In an embodiment, the priority value and the CAPC value of the PSFCH with conflict information may be based on different SCIs (involved in the conflict, e.g., indicating conflicting reserved resources), e.g., if one SCI indicates a lower priority value but a higher CAPC value. The first UE may perform an LBT based on the third CAPC value to transmit the PSFCH comprising the conflict information. The conflict information may enable successful transmission of both UEs (second UE and the third UE) indicated/reserved by the first SCI and the second SCI. Therefore, the CAPC of the conflict information may be based on the lowest CAPC of the two SCIs, and/or irrespective of the priority values indicated by the SCIs. This may result in an increased likelihood of LBT success for transmitting the conflict information and thus, reducing the chance of collision in the sidelink resource pool, however, the channel access fairness towards other radio technologies may decline.

In an embodiment, a UE may determine a CAPC value of a PSFCH transmission with conflict information based on both CAPC values indicated by the SCIs involved in the conflict. In an embodiment, a UE may determine a CAPC value of a PSFCH transmission with conflict information based on both priority values indicated by the SCIs involved in the conflict. For example, a table/matrix of CAPC values may be (pre)configured or (pre)defined for each pair of PHY priority value or each pair of CAPC value associated with the two SCIs reserving conflicting resources. This may enable more control over the conflict situation depending on the specific combination of control channels involved in the conflict

In an embodiment, RRC SL configuration may indicate the reference transmission/reception/SCI/PSSCH/reservation for CAPC determination of a conflict information. The first UE may receive an RRC message, e.g., from another UE or the base station. The RRC message may comprise sidelink configuration parameters. The SL configuration parameters may comprise a first parameter indicating the reference SCI associated with the CAPC of the conflict information.

In an embodiment the first parameter may indicate whether the reference SCI is (1) a first SCI associated with (or indicating) a lowest CAPC value, or (2) a second SCI indicating the lowest priority value.

In an example, a first value of the first parameter may indicate that the CAPC value of the PSFCH transmission is determined based on one of the SCIs (of the resource conflict) that indicates a lower/lowest priority value. For example, referring to FIG. 33 or FIG. 35, the first value of the first parameter may indicate that the third CAPC value is equal to the second CAPC value. The second SCI indicates the lowest priority value among the first priority value and the second priority value (P2<P1). For example, the first value of the first parameter indicates that the reference SCI/transmission/reception/TB/PSSCH for CAPC determination in the inter-UE coordination is the one associated with the lowest priority value (highest priority) in the resource conflict.

In an example, a second value of the first parameter may indicate that the CAPC value of the PSFCH transmission is determined based on one of the SCIs (of the resource conflict) that indicates a lower/lowest CAPC value. For example, referring to FIG. 33 or FIG. 35, the second value of the first parameter may indicate that the third CAPC value is equal to the first CAPC value. The first SCI indicates the lowest CAPC value among the first CAPC value and the second CAPC value (CAPC1<CAPC2). For example, the second value of the first parameter indicates that the reference SCI/transmission/reception/TB/PSSCH for CAPC determination in the inter-UE coordination is the one associated with the lowest CAPC value (highest channel access priority) in the resource conflict. Based on the first parameter indicating the second value, the first UE may determine the third CAPC value of the PSFCH transmission with conflict information to be equal to the smallest/lowest CAPC value associated with the conflicting resources (or indicated by the SCIs scheduling the conflicting reserved resources).

The base station may set the value of the first parameter based on the status of the unlicensed band/channel, e.g., based on the presence of other RATs. For example, in absence of other RATs, there may be no concern about fairness, and the lowest CAPC value of the conflicting resources may be used for the PSFCH transmission comprising the conflict information for increased likelihood of LBT success. However, in the presence of other RATs, the CAPC of the prioritized transmission (e.g., reserved by the SCI indicating the lowest priority value) may be used for the PSFCH transmission comprising the conflict information for a fair channel access.

For example, if the first parameter is configured (e.g., present in the RRC message) or enabled, the first UE may determine the CAPC value of the PSFCH based on a first mode. For example, if the first parameter is not configured (e.g., absent in the RRC message) or disabled, the first UE may determine the CAPC value of the PSFCH based on a second mode. The first mode or the second mode may indicate to use the lowest CAPC value among the CAPC values associated with the conflicting resources, e.g., the lowest CAPC value indicated by the SCI reserving conflicting resources. The first mode or the second mode may indicate to use the CAPC value associated with the SCI that indicates the lowest priority value and/or has a higher RSRP (or RSRP above a threshold).

In an embodiment, SL configuration parameters may indicate a table/list/matrix of CAPC values associated with conflict information for different combinations of resource conflict with different priority value and/or CAPC values. In an embodiment, each entry of the table/list/matrix of CAPC values may correspond to a pair of priority values, e.g., (P1, P2), where P1 is the priority value indicated by SCI #1 and P2 is the priority value indicated by SCI #2. For example, SCI #1 indicates a first reserved resource that overlaps/conflicts with a second reserved resource indicated by SCI #2. In an embodiment, each entry of the table/list/matrix of CAPC values may correspond to a pair of CAPC values, e.g., (CAPC1, CAPC2), where CAPC1 is the CAPC value indicated by or associate with SCI #1 and CAPC2 is the CAPC value indicated by or associated with SCI #2. For example, in FIG. 33 or FIG. 35, the first UE may determine the third CAPC value based on the first priority value and the second priority value. For example, in FIG. 33 or FIG. 35, the first UE may determine the third CAPC value based on the first CAPC value and the second CAPC value. For example, the first UE may determine the third CAPC value based on the first SCI and the second SCI.

FIG. 36 shows an example of CAPC determination for a PSFCH with conflict information. As shown in this example, the first UE (UE #1) receives a first SCI (SCI #1) from a second UE (UE #2) and a second SCI (SCI #2) from a third UE (UE #3). The first SCI indicates reservation of a first reserved resource (r1). The first SCI comprises/indicates a first priority value (p1). The first SCI indicates a first CAPC value (CAPC1). The second SCI indicates reservation of a second reserved resource (r2). The second SCI comprises/indicates a second priority value (p2). The second SCI indicates a second CAPC value (CAPC2). The first UE determines resource conflict, e.g., based on the first reserved resource and the second reserved resource overlap in time and frequency. The first UE may determine to transmit a PSFCH comprising conflict information indicating the resource conflict. The first UE may determine to transmit the PSFCH to the second UE, e.g., based on the first priority value being higher/larger than the second priority value. The first UE may determine to transmit the PSFCH to the second UE, e.g., a second RSRP measurement of the second SCI being higher than a threshold and/or a first RSRP measurement of the first SCI. The first UE may determine a third CAPC value associated with the PSFCH transmission based on the first SCI and/or the second SCI, e.g., based on one or more information fields in the first SCI and/or the second SCI.

FIG. 37 shows an example of CAPC determination for a PSFCH with conflict information. As shown in this example, the first UE (UE #1) receives a first SCI (SCI #1) from a second UE (UE #2) and a second SCI (SCI #2) from a third UE (UE #3). The first SCI indicates reservation of a first reserved resource (r1). The first SCI comprises/indicates a first priority value (p1). The first SCI indicates a first CAPC value (CAPC1). The first UE determines a first RSRP measurement (RSRP1) of the first SCI. The second SCI indicates reservation of a second reserved resource (r2). The second SCI comprises/indicates a second priority value (p2). The second SCI indicates a second CAPC value (CAPC2). The first UE determines a second RSRP measurement (RSRP2) of the first SCI. The first UE determines resource conflict, e.g., based on the first reserved resource and the second reserved resource overlap in time and frequency. The first UE may determine to transmit a PSFCH comprising conflict information indicating the resource conflict. The first UE may determine to transmit the PSFCH to the second UE, e.g., based on the second priority value being lower/smaller than or equal to the first priority value. The first UE may determine to transmit the PSFCH to the second UE, e.g., based on the second RSRP measurement being higher than a threshold (e.g., a threshold determined based on the first priority value and the second priority value). The first UE may determine to transmit the PSFCH to the second UE, e.g., based on the second RSRP measurement being higher than the first RSRP measurement by at least by a threshold. The first UE may determine a third CAPC value associated with the PSFCH transmission based on the first SCI and/or the second SCI, e.g., based on one or more information fields in the first SCI and/or the second SCI.

In an embodiment, the first UE may determine the third CAPC value based on the information associated with the destination of the PSFCH, e.g., the priority value indicated by the second UE or the CAPC value associated with the second UE's transmission/reservation. For example, in response to determining to transmit the PSFCH with the conflict information to the second UE, the first UE may determine the third CAPC value to be equal to the first CAPC value indicated by the first SCI. In an embodiment, the first UE may determine the third CAPC value based on the SCI scheduling a reception with the first UE as the intended receiver (e.g., destination UE). For example, the first SCI may schedule a PSSCH indicating the first UE as the destination UE. For example, the second SCI may schedule a PSSCH which not indicating the first UE as the destination UE. The first UE may determine the third CAPC value based on the first SCI, e.g., the priority and/or CAPC value indicated by the first SCI.

FIG. 38 shows an example of CAPC determination for a PSFCH with conflict information. As shown in this example, the first UE (UE #1) receives a first SCI (SCI #1) from a second UE (UE #2). The first SCI indicates reservation of a first reserved resource (r1). The first SCI comprises/indicates a first priority value (p1). The first SCI indicates a first CAPC value (CAPC1). The first UE determines resource conflict, e.g., based on the first reserved resource being in a slot where the first UE cannot perform SL reception, e.g., due to half-duplex. For example, the first UE may not expect to perform reception on the sidelink due to half-duplex operation in the slot. The first UE may determine that the first reserved resource occurs in a slot in which the first UE does not expect to perform SL reception, e.g., due to half-duplex operation and/or UL transmission. For example, the first UE may be a destination (e.g., intended receiver) of the first TB to be transmitted in the first reserved resource by the second UE. For example, the first UE may determine a resource conflict occurring on the first reserved resource, based on the first reserved resource occurring in a time/slot that the UE may not perform SL reception. The first UE may determine to transmit a PSFCH comprising conflict information indicating the resource conflict. The first UE may determine to transmit the PSFCH to the second UE. The first UE may determine a third CAPC value associated with the PSFCH transmission based on the first SCI, e.g., based on a CAPC value indicated by the first SC. The first UE may determine a third CAPC value associated with the PSFCH transmission based on the first CAPC value.

In an embodiment, a UE may determine a PSFCH transmission comprising a HARQ-ACK codebook. The HARQ ACK codebook may comprise a plurality HARQ-ACK information (e.g., feedback information) of one or more PSSCH receptions. The one or more PSSCH receptions may be associated with different CAPC values. For example, a received SCI scheduling a respective PSSCH reception may indicate the corresponding CAPC value of the PSSCH reception. The UE may multiplex the plurality of HARQ-ACK information bits in the PSFCH resource/occasion/transmission. The UE may determine a CAPC value for the PSFCH transmission comprising the plurality of HARQ-ACK information based on at least one of the CAPC values associated with the received SCIs and/or PSSCH receptions. For example, a first SCI may indicate a first CAPC value and/or schedule a first PSSCH reception associated with the first CAPC value. For example, a second SCI may indicate a second CAPC value and/or schedule a second PSSCH reception associated with the second CAPC value, where the second CAPC value is smaller than or equal to the first CAPC value. The UE may generate a HARQ-ACK codebook comprising HARQ-ACK information of the first PSSCH reception and the second PSSCH reception. The UE may transmit the HARQ-ACK codebook via a PSFCH transmission. The UE may determine a CAPC value of the PSFCH (and/or HARQ-ACK codebook) to be equal to a smallest/lowest CAPC value among the plurality of CAPC values associated with the PSSCH receptions and/or indicated by the received SCIs. For example, the CAPC value of the PSFCH transmission may be equal to the second CAPC value which is smallest CAPC value among the plurality of CAPC values comprising the first CAPC value and the second CAPC value.

FIG. 39 shows an example call flow for CAPC determination associated with conflict information. At 3901, the wireless device may determine a resource conflict based on a first SCI and a second SCI. At 3902, the wireless device may determine a CAPC value, for transmission of a conflict information indicating the resource conflict, based on the first SCI and/or the second SCI. At 3903, the wireless device may transmit the conflict information via a feedback channel using the determined CAPC value.

In an example, a first wireless device may receive from a second wireless device, a first sidelink control information (SCI) indicating: a first reserved resource for a first transmission of the second wireless device; a first priority value of the first transmission; and/or a first channel access priority class (CAPC) value of the first SC. The first wireless device may receive from a third wireless device, a second SCI indicating: a second reserved resource for a second transmission of the third wireless device; a second priority value of the second transmission; and/or a second CAPC value of the second SC. The first wireless device may determine a resource conflict based on the first reserved resource overlapping with the second reserved resource.

The first wireless device may determine for transmission of an indication of the resource conflict and based on the second priority value being smaller than the first priority value, a CAPC value to be equal to the second CAPC value. The first wireless device may transmit a feedback channel with the indication of the resource conflict based on a listen before talk (LBT) procedure using the determined CAPC value.

The first wireless device may determine for transmission of an indication of the resource conflict and based on the second CAPC value being lower than the first CAPC value, a CAPC value to be equal to the second CAPC value. The first wireless device may transmit a feedback channel with the indication of the resource conflict based on a listen before talk (LBT) procedure using the determined CAPC value.

The first wireless device may determine a resource conflict based on a first sidelink control information (SCI) and a second SCI. The first wireless device may determine a channel access priority class (CAPC) value, for a transmission of a conflict information (e.g., as an indication of the resource conflict) indicating the resource conflict, based on one of the first SCI and the second SCI. The first wireless device may transmit the conflict information via a feedback channel using the determined CAPC value.

Either alone or in combination with any of the above or below features, the first wireless device may receive the first SCI from a second wireless device.

Either alone or in combination with any of the above or below features, the first wireless device may receive the second SCI from a third wireless device.

Either alone or in combination with any of the above or below features, the first SCI may indicate a first reserved resource for a first transmission (e.g., a first PSSCH and/or 1st stage SCI and/or 2nd stage SCI that correspond to the first PSSCH) of the second wireless device.

Either alone or in combination with any of the above or below features, the second SCI may indicate a second reserved resource for a second transmission (e.g., a second PSSCH and/or 1st stage SCI and/or 2nd stage SCI that correspond to the second PSSCH) of the third wireless device.

Either alone or in combination with any of the above or below features, the first SCI may further indicate a first priority value of the first transmission.

Either alone or in combination with any of the above or below features, the second SCI may further indicate a second priority value of the second transmission.

Either alone or in combination with any of the above or below features, the first SCI mat further indicate a first CAPC value of the first SCI (or of the first transmission).

Either alone or in combination with any of the above or below features, the second SCI may further indicate a second CAPC value of the second SCI (or of the second transmission).

Either alone or in combination with any of the above or below features, the first wireless device may determine the resource conflict based on the first reserved resource overlapping with the second reserved resource.

Either alone or in combination with any of the above or below features, the first reserved resource and the second reserved resource may overlap in time and frequency.

Either alone or in combination with any of the above or below features, the first wireless device may determine the resource conflict based on the second priority value being smaller than or equal to the first priority value.

Either alone or in combination with any of the above or below features, the first wireless device may be an intended receiver (e.g., destination wireless device) of a transmission, by the second wireless device, via (and/or in) the first reserved resource of the second wireless device.

Either alone or in combination with any of the above or below features, the first wireless device may determine the resource conflict based on a reference signal received power (RSRP) of the second SCI (or the third wireless device) being above a RSRP threshold.

Either alone or in combination with any of the above or below features, a value of the RSRP threshold may be associated a first priority value of the first transmission and a second priority value of the second transmission.

Either alone or in combination with any of the above or below features, the first wireless device may receive a radio resource control (RRC) message comprising sidelink configuration parameters indicating one or more values of RSRP thresholds, wherein: each of the one or more values may be associated with a respective RSRP threshold, among the RSRP thresholds, that is associated with respective one or more priority values; and the value is associated with the RSRP threshold that is associated with the first priority value and the second priority value.

Either alone or in combination with any of the above or below features, the first wireless device may determine the resource conflict based on a second reference signal received power (RSRP) of the second SCI (or the third wireless device) being greater than a first RSRP of the first SCI (or the second wireless device) plus a RSRP threshold delta.

Either alone or in combination with any of the above or below features, the first wireless device may receive a radio resource control (RRC) message comprising sidelink configuration parameters indicating the RSRP threshold delta.

Either alone or in combination with any of the above or below features, the first wireless device may be a destination wireless device (e.g., intended receiver) of a transport block (TB) to be transmitted by the second wireless device via and/or in the first reserved resource.

Either alone or in combination with any of the above or below features, the first wireless device may determine to transmit to the second wireless device the feedback channel with the conflict information.

Either alone or in combination with any of the above or below features, the first wireless device may transmit the conflict information to the second wireless device.

Either alone or in combination with any of the above or below features, the first wireless device may determine the second wireless device for providing and/or transmitting the conflict information to in the feedback channel, based on the first wireless device being an intended receiver of the second wireless device for the first reserved resource.

Either alone or in combination with any of the above or below features, the first wireless device may be an intended receiver of the second wireless device for a physical sidelink shared channel (PSSCH) transmission in a slot.

Either alone or in combination with any of the above or below features, the first wireless device may receive a radio resource control (RRC) message comprising a sidelink configuration parameter indicating that a non-destination wireless device cannot send conflict information.

Either alone or in combination with any of the above or below features, the first wireless device may not be an intended receiver of the second wireless device for the first reserved resource.

Either alone or in combination with any of the above or below features, the first wireless device may receive a radio resource control (RRC) message comprising a sidelink configuration parameter indicating that a non-destination wireless device can send conflict information.

Either alone or in combination with any of the above or below features, the first wireless device may be an intended receiver of the third wireless device for the second reserved resource.

Either alone or in combination with any of the above or below features, the first wireless device may determine the second wireless device for providing the conflict information to in the feedback channel, based on a first priority value of the first transmission of the second wireless device being larger than or equal to a second priority value of the second transmission of the third wireless device.

Either alone or in combination with any of the above or below features, the first wireless device may determine a PSFCH resource for the PSFCH transmission with the conflict information, based on a source id indicated by the first SCI.

Either alone or in combination with any of the above or below features, the feedback channel may be a physical sidelink feedback channel (PSFCH).

Either alone or in combination with any of the above or below features, the first wireless device may transmit the PSFCH with the conflict information in a first slot, wherein the first slot is at least a number of slots after a second slot where the first SCI is received.

Either alone or in combination with any of the above or below features, the first wireless device may determine the CAPC value based on an indication by one of the first SCI and the second SCI.

Either alone or in combination with any of the above or below features, the first wireless device may determine the CAPC value to be equal to a second CAPC value indicated by the second SCI.

Either alone or in combination with any of the above or below features, the second SCI may comprise a field indicating the second CAPC value.

Either alone or in combination with any of the above or below features, the determining the CAPC value to be equal to the second CAPC value may be based on the second SCI indicating a second priority value that is smaller than or equal to a first priority value indicated by the first SCI.

Either alone or in combination with any of the above or below features, the determining the CAPC value to be equal to the second CAPC value may be further based on the second CAPC value being associated with a second transmission scheduled by the second SCI with the second priority value.

Either alone or in combination with any of the above or below features, the determining the CAPC value to be equal to the second CAPC value may be based on the second CAPC value being lower than or equal to a first CAPC value indicated by the first SCI.

Either alone or in combination with any of the above or below features, the first SCI may comprise a field indicating the first CAPC value.

Either alone or in combination with any of the above or below features, the determining the CAPC value to be equal to the second CAPC value may be based on a second reference signal received power (RSRP) of the second SCI (or the third wireless device) being above a RSRP threshold.

Either alone or in combination with any of the above or below features, the determining the CAPC value to be equal to the second CAPC value may be further based on the second CAPC value being associated with a second transmission scheduled by the second SCI with the second RSRP.

Either alone or in combination with any of the above or below features, the determining the CAPC value to be equal to the second CAPC value may be based on the first wireless device being a destination wireless device of a second transport block (TB) to be transmitted by the third wireless device in a second reserved resource indicated by the second SCI.

Either alone or in combination with any of the above or below features, the determining the CAPC value to be equal to the second CAPC value may be further based on the second CAPC value being associated with the second TB.

Either alone or in combination with any of the above or below features, the first wireless device may not be a destination wireless device of a first TB to be transmitted by the second wireless device in a first reserved resource indicated by the first SCI.

Either alone or in combination with any of the above or below features, the first wireless device may transmit the feedback channel with the conflict information based on a listen before talk (LBT) procedure using the determined CAPC value.

Either alone or in combination with any of the above or below features, a priority value for the feedback channel with the conflict information may be equal to a second priority value indicated by the second SCI, based on the second priority value being smaller than or equal to a first priority value indicated by the first SCI.

Either alone or in combination with any of the above or below features, the first CAPC value may be associated with the first SCI, and a RSRP measurement performed for the first SCI may be higher than a threshold.

Either alone or in combination with any of the above or below features, the threshold may be based on a first priority of the first SCI and a second priority of the second SCI.

Either alone or in combination with any of the above or below features, the first CAPC may be associated with the first SCI, and a RSRP measurement performed for the first SCI may be higher than the RSRP measurement performed for the second SCI.

Either alone or in combination with any of the above or below features, the wireless device may be a destination UE of a TB to be transmitted in a resource that is reserved by the first SCI.

Either alone or in combination with any of the above or below features, the second SCI may indicate COT sharing with the first wireless device (e.g., the first wireless device may be a recipient of the COT sharing).

Either alone or in combination with any of the above or below features, the second wireless device and the third wireless device may be the same.

Either alone or in combination with any of the above or below features, a destination identifier of the second wireless device is the same as a destination identifier of the third wireless device.

Either alone or in combination with any of the above or below features, a higher priority value may indicate a lower priority.

Either alone or in combination with any of the above or below features, a lower priority value may indicate a higher priority.

An example method comprising: receiving, by a first wireless device from a second wireless device, a first sidelink control information (SCI) indicating: a first reserved resource for a first transmission of the second wireless device; a first priority value of the first transmission; and a first channel access priority class (CAPC) value of the first SCI; and receiving, by the first wireless device from a third wireless device, a second SCI indicating: a second reserved resource for a second transmission of the third wireless device; a second priority value of the second transmission; and a second CAPC value of the second SCI; determining a resource conflict based on the first reserved resource overlapping in time with the second reserved resource; based on the second priority value being smaller than the first priority value, determining, for an indication of the resource conflict, a CAPC value to be equal to the second CAPC value; and transmitting, based on a listen before talk (LBT) procedure with the determined CAPC value, the indication of the resource conflict.

An example method comprising: receiving, by a first wireless device from a second wireless device, a first sidelink control information (SCI) indicating: a first reserved resource for a first transmission of the second wireless device; and a first channel access priority class (CAPC) value of the first SCI; receiving, by the first wireless device from a third wireless device, a second SCI indicating: a second reserved resource for a second transmission of the third wireless device; and a second CAPC value of the second SCI; determining, based on the first reserved resource overlapping in time with the second reserved resource, a CAPC value among the first CAPC value and the second CAPC value; and transmitting, based on a listen before talk (LBT) procedure with the determined CAPC value, an indication of the first reserved resource overlapping in time with the second reserved resource.

An example method comprising: receiving, by a first wireless device from a second wireless device, a first sidelink control information (SCI) indicating: a first reserved resource for a first transmission of the second wireless device; a first priority value of the first transmission; and a first channel access priority class (CAPC) value of the first SCI; and receiving, by the first wireless device from a third wireless device, a second SCI indicating: a second reserved resource for a second transmission of the third wireless device; a second priority value of the second transmission; and a second CAPC value of the second SCI; determining a resource conflict based on the first reserved resource overlapping with the second reserved resource; determining, for transmission of an indication of the resource conflict and based on the second CAPC value being lower than the first CAPC value, a CAPC value to be equal to the second CAPC value; and transmitting an indication of the resource conflict based on a listen before talk (LBT) procedure using the determined CAPC value.

An example method comprising: receiving, by a first wireless device from a second wireless device, a first sidelink control information (SCI) indicating: a first reserved resource for a first transmission of the second wireless device; a first priority value of the first transmission; and a first channel access priority class (CAPC) value of the first SCI; and receiving, by the first wireless device from a third wireless device, a second SCI indicating: a second reserved resource for a second transmission of the third wireless device; a second priority value of the second transmission; and a second CAPC value of the second SCI; determining a resource conflict based on the first reserved resource overlapping with the second reserved resource; transmitting an the indication of the resource conflict based on a listen before talk (LBT) procedure using the determined CAPC value.

An example method comprising: determining, by a first wireless device, a resource conflict based on a first sidelink control information (SCI) and a second SCI; determining a channel access priority class (CAPC) value, for a transmission of a conflict information (e.g., as an indication of the resource conflict) indicating the resource conflict, based on one of the first SCI and the second SCI; and transmitting the conflict information via a feedback channel using the determined CAPC value.

One or more of the above example methods, further comprising receiving, by the first wireless device: the first SCI from a second wireless device; and the second SCI from a third wireless device.

One or more of the above example methods, wherein: the first SCI indicates a first (e.g., reserved) resource for a first transmission (e.g., a first PSSCH) of the second wireless device; and the second SCI indicates a second (e.g., reserved) resource for a second transmission (e.g., a second PSSCH) of the third wireless device.

One or more of the above example methods, wherein: the first SCI further indicates a first priority value of the first transmission; and the second SCI further indicates a second priority value of the second transmission.

One or more of the above example methods, wherein: the first SCI further indicates a first CAPC value of the first SCI (or of the first transmission); and the second SCI further indicates a second CAPC value of the second SCI (or of the second transmission).

One or more of the above example methods, further comprising determining the resource conflict based on the first reserved resource overlapping with the second reserved resource.

One or more of the above example methods, wherein the first reserved resource and the second reserved resource overlap in time and/or in frequency.

One or more of the above example methods, further comprising determining the resource conflict based on the second priority value being smaller than or equal to the first priority value.

One or more of the above example methods, wherein the first wireless device is an intended receiver (e.g., destination wireless device) of a transmission, by the second wireless device, via and/or in the first reserved resource.

One or more of the above example methods, further comprising determining the resource conflict based on a reference signal received power (RSRP) of the second SCI (or the third wireless device) being above a RSRP threshold.

One or more of the above example methods, wherein a value of the RSRP threshold is associated a first priority value of the first transmission and a second priority value of the second transmission.

One or more of the above example methods, further comprising receiving a radio resource control (RRC) message comprising sidelink configuration parameters indicating one or more values of RSRP thresholds, wherein: each of the one or more values is associated with a respective RSRP threshold, among the RSRP thresholds, that is associated with respective one or more priority values; and the value is associated with the RSRP threshold that is associated with the first priority value and the second priority value.

One or more of the above example methods, further comprising determining the resource conflict based on a second reference signal received power (RSRP) of the second SCI (or the third wireless device) being greater than a first RSRP of the first SCI (or the second wireless device) plus a RSRP threshold delta.

One or more of the above example methods, further comprising receiving a radio resource control (RRC) message comprising sidelink configuration parameters indicating the RSRP threshold delta.

One or more of the above example methods, wherein the first wireless device is a destination wireless device (e.g., intended receiver) of a transport block (TB) to be transmitted by the second wireless device via and/or in the first reserved resource.

One or more of the above example methods, further comprising determining to transmit to the second wireless device the feedback channel with the conflict information.

One or more of the above example methods, further comprising transmitting the conflict information to the second wireless device.

One or more of the above example methods, further comprising determining the second wireless device for providing and/or transmitting the conflict information in the feedback channel, based on the first wireless device being an intended receiver of the second wireless device for the first reserved resource.

One or more of the above example methods, wherein the first wireless device is an intended receiver of the second wireless device for a physical sidelink shared channel (PSSCH) transmission in a slot.

One or more of the above example methods, further comprising receiving a radio resource control (RRC) message comprising a sidelink configuration parameter indicating that a non-destination wireless device cannot send conflict information.

One or more of the above example methods, wherein the first wireless device is not an intended receiver of the second wireless device for the first reserved resource.

One or more of the above example methods, further comprising receiving a radio resource control (RRC) message comprising a sidelink configuration parameter indicating that a non-destination wireless device can send conflict information.

One or more of the above example methods, wherein the first wireless device is an intended receiver of the third wireless device for the second reserved resource.

One or more of the above example methods, further comprising determining the second wireless device for providing the conflict information to in the feedback channel, based on a first priority value of the first transmission of the second wireless device being larger than or equal to a second priority value of the second transmission of the third wireless device.

One or more of the above example methods, further comprising determining a PSFCH resource for the PSFCH transmission with the conflict information, based on a source id indicated by the first SCI.

One or more of the above example methods, wherein the feedback channel is a physical sidelink feedback channel (PSFCH).

One or more of the above example methods, further comprising transmitting the PSFCH with the conflict information in a first slot, wherein the first slot is at least a number of slots after a second slot where the first SCI is received.

One or more of the above example methods, further comprising determining the CAPC value based on an indication by one of the first SCI and the second SCI.

One or more of the above example methods, further comprising determining the CAPC value to be equal to a second CAPC value indicated by the second SCI.

One or more of the above example methods, wherein the second SCI comprises a field indicating the second CAPC value.

One or more of the above example methods, wherein the determining the CAPC value to be equal to the second CAPC value is based on the second SCI indicating a second priority value that is smaller than or equal to a first priority value indicated by the first SCI.

One or more of the above example methods, wherein the determining the CAPC value to be equal to the second CAPC value is further based on the second CAPC value being associated with a second transmission scheduled by the second SCI with the second priority value.

One or more of the above example methods, wherein the determining the CAPC value to be equal to the second CAPC value is based on the second CAPC value being lower than or equal to a first CAPC value indicated by the first SCI.

One or more of the above example methods, wherein the first SCI comprises a field indicating the first CAPC value.

One or more of the above example methods, wherein the determining the CAPC value to be equal to the second CAPC value is based on a second reference signal received power (RSRP) of the second SCI (or the third wireless device) being above a RSRP threshold.

One or more of the above example methods, wherein the determining the CAPC value to be equal to the second CAPC value is further based on the second CAPC value being associated with a second transmission scheduled by the second SCI with the second RSRP.

One or more of the above example methods, wherein the determining the CAPC value to be equal to the second CAPC value is based on the first wireless device being a destination wireless device of a second transport block (TB) to be transmitted by the third wireless device in a second reserved resource indicated by the second SCI.

One or more of the above example methods, wherein the determining the CAPC value to be equal to the second CAPC value is further based on the second CAPC value being associated with the second TB.

One or more of the above example methods, wherein the first wireless device is not a destination wireless device of a first TB to be transmitted by the second wireless device in a first reserved resource indicated by the first SCI.

One or more of the above example methods, further comprising transmitting the feedback channel with the conflict information based on a listen before talk (LBT) procedure using the determined CAPC value.

One or more of the above example methods, wherein a priority value for the feedback channel with the conflict information is equal to a second priority value indicated by the second SCI, based on the second priority value being smaller than or equal to a first priority value indicated by the first SCI.

One or more of the above example methods, wherein the second wireless device and the third wireless device is the same.

One or more of the above example methods, wherein a destination identifier of the second wireless device is the same as a destination identifier of the third wireless device.

One or more of the above example methods, wherein a higher priority value indicates a lower priority.

One or more of the above example methods, wherein a lower priority value indicates a higher priority.

What is claimed is:

1. A method comprising:
determining, by a first wireless device, a resource conflict based on a first sidelink control information (SCI) and a second SCI;
determining a channel access priority class (CAPC) value, for a transmission of a conflict information indicating the resource conflict, based on one of the first SCI and the second SCI; and
transmitting the conflict information, via a feedback channel, using the CAPC value.

2. The method of claim 1, further comprising receiving, by the first wireless device:
the first SCI from a second wireless device; and
the second SCI from a third wireless device.

3. The method of claim 1, further comprising transmitting the conflict information to a second wireless device based on the first wireless device being an intended receiver of the second wireless device for a first reserved resource indicated by the first SCI.

4. The method of claim 1, further comprising determining the CAPC value based on an indication by one of the first SCI or the second SCI.

5. The method of claim 1, further comprising determining the CAPC value to be equal to a second CAPC value indicated by the second SCI.

6. The method of claim 5, wherein the determining the CAPC value to be equal to the second CAPC value is based on the second SCI indicating a second priority value that is smaller than or equal to a first priority value indicated by the first SCI.

7. The method of claim 5, wherein the determining the CAPC value to be equal to the second CAPC value is based on the second CAPC value being lower than or equal to a first CAPC value indicated by the first SCI.

8. The method of claim 5, wherein the determining the CAPC value to be equal to the second CAPC value is based on a second reference signal received power (RSRP) of the second SCI being greater than a RSRP threshold.

9. The method of claim 5, wherein the determining the CAPC value to be equal to the second CAPC value is based on the first wireless device being a destination wireless device of a second transport block (TB) to be transmitted by a second wireless device in a second reserved resource indicated by the second SCI.

10. The method of claim 1, further comprising transmitting the feedback channel with the conflict information based on a listen before talk (LBT) procedure using the CAPC value.

11. A first wireless device comprising:
one or more processors; and
memory storing instructions that, when executed by the one or more processors, causes the first wireless device to:
determine a resource conflict based on a first sidelink control information (SCI) and a second SCI;
determine a channel access priority class (CAPC) value, for a transmission of a conflict information indicating the resource conflict, based on one of the first SCI and the second SCI; and
transmit the conflict information, via a feedback channel, using the CAPC value.

12. The first wireless device of claim 11, wherein the instructions further cause the first wireless device to receive:
the first SCI from a second wireless device; and
the second SCI from a third wireless device.

13. The first wireless device of claim 11, wherein the instructions further cause the first wireless device to transmit the conflict information to a second wireless device based on the first wireless device being an intended receiver of the second wireless device for a first reserved resource indicated by the first SCI.

14. The first wireless device of claim 11, wherein the instructions further cause the first wireless device to determine the CAPC value based on an indication by one of the first SCI or the second SCI.

15. The first wireless device of claim 11, wherein the instructions further cause the first wireless device to determine the CAPC value to be equal to a second CAPC value indicated by the second SCI.

16. The first wireless device of claim 15, wherein the instructions further cause the first wireless device to determine the CAPC value to be equal to the second CAPC value based on the second SCI indicating a second priority value that is smaller than or equal to a first priority value indicated by the first SCI.

17. The first wireless device of claim 15, wherein the instructions further cause the first wireless device to determine the CAPC value to be equal to the second CAPC value based on the second CAPC value being lower than or equal to a first CAPC value indicated by the first SCI.

18. The first wireless device of claim 15, wherein the instructions further cause the first wireless device to determine the CAPC value to be equal to the second CAPC value based on a second reference signal received power (RSRP) of the second SCI being greater than a RSRP threshold.

19. The first wireless device of claim 15, wherein the instructions further cause the first wireless device to determine the CAPC value to be equal to the second CAPC value based on the first wireless device being a destination wireless device of a second transport block (TB) to be transmitted by a second wireless device in a second reserved resource indicated by the second SCI.

20. A non-transitory computer-readable medium comprising instructions that, when executed by one or more processors of a first wireless device, cause the first wireless device to:
determine a resource conflict based on a first sidelink control information (SCI) and a second SCI;
determine a channel access priority class (CAPC) value, for a transmission of a conflict information indicating the resource conflict, based on one of the first SCI and the second SCI; and
transmit the conflict information, via a feedback channel, using the CAPC value.
